(19) United States
(12) Patent Application Publication
(10) Pub. No.: US 2005/0183143 A1
(43) Pub. Date: Aug. 18, 2005

(54) Methods and systems for monitoring user, application or device activity

(76) Inventors: Eric John Anderholm, La Crosse, WI (US); David Ronald Losen, La Crosse, WI (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/779,535

(22) Filed: Feb. 13, 2004

(51) Int. Cl. G06F 11/30

(52) U.S. Cl. 726/22

(57) ABSTRACT

Methods and systems are provided for capturing usage data from a user computer, processing a subset of such data to form output, and offering access to selective views of such output, such as to assist a company's management in monitoring computer usage in a work environment. The output may be processed and viewed according to software application, device, or specified user. The output, or a report generated therefrom, may be accessible in differing degrees to individuals having appropriate levels of permission.

### BACKGROUND

1. Field of the Invention

This invention relates to the field of monitoring system usage, and more particularly to the field of using software to monitor user, application and device behavior and events.

2. Description of the Related Art

With the widespread adoption of computer technology in the workplace, employees have access to vast resources, both internal to a company and through the Internet. While computer applications have created many opportunities to improve productivity, the prevalence of such computer applications has made it increasingly difficult to monitor employee behavior. Historically, a manager could monitor productivity, as well as compliance with policies and rules, through direct observation of work being performed. Physical observation is no longer effective, however, because, for example, many employees work from home or from remote locations. Even where employees are physically present, it is not convenient for a manager to monitor an employee's computer usage at all times. As a result, an employee may covertly surf the Internet, chat in Internet chat rooms, play computer games, or, in worse cases, access forbidden files, violate company policies, or even commit crimes.

Although technology exists to permit remote, clandestine monitoring of computer usage behavior, it generally suffers from several shortcomings. Certain existing technology permits real time access to view, at all times, screen output of a selected user. Such monitoring systems tend to require a very large commitment of resources dedicated to monitoring users, thus leading to great inefficiency. Even if a subset of such screen information is selected it is not easily aggregated and analyzed, as it requires a human to view the screen in order to understand the apparent meaning.

Mere collection of screen data does not promote processing and analysis of compiled data. In some cases, managers and system administrators would benefit from the ability to compile statistical data regarding application or machine usage, as well as user behavioral patterns. With information about average user time spent on an Internet web-browser application, a manager may be able to identify opportunities for productivity improvement. With information about extent of computer usage, a manager may be able to optimize equipment maintenance and upgrade paths. With information about peak times for user activity, a manager may be able to optimize situational factors by matching availability of support or resources to times and duration of actual usage. Information could be used to track license compliance and technology rollouts, and to assist administrators in help desk remediation efforts. A need exists to track and report on user behavior, policy compliance and user activity, both at the individual user level and macroscopically.

Existing technology provides information relative to specific users that may offend notions of privacy or decency. A need exists to permit automatic collection of usage data that may be statistically compiled or de-identified (stripped of data that identifies the user) to ensure that privacy is maintained to the extent practicable. For example, it may be reasonable to permit senior management to access personal usage patterns, but preferable to limit the scope of information accessible to administrators or information technology personnel. A need exists to provide selective access within an organization, permitting only aggregate data, or de-identified data, to be accessed by certain classes or groups, and to provide fuller access at higher levels or as required to satisfy a specific need, such as auditing or criminal investigation.

### SUMMARY

The present invention relates to the use of systems to monitor user, application and device behavior and events, including, without limitation, to monitor productivity and to monitor compliance with workplace policies and regulations. In embodiments, the systems may be used to capture usage data from a user computer, process such data to form, and offer access to, selective views of such output, such as to assist a company's management in monitoring computer usage in a work environment. In embodiments, the output may be processed and viewed according to software application, device, or specified user. The output, or a report generated from the output, may be accessible in differing degrees to individuals having appropriate levels of permission.

The present invention includes methods and systems to monitor user, application and device behavior and events. In embodiments, the methods and system may be used to capture usage data from a user computer, process such data to form, and offer selective views of, the output, such as to assist a company's management in monitoring computer usage in a work environment. The output may be processed and viewed according to software application, device, or specified user. The output, or a report generated from the output, may be accessible in differing degrees to individuals having appropriate levels of permission.

According to one exemplary embodiment disclosed herein, the methods and systems provide for capturing event data from a user device, such as a computer. The event data may relate to a software application, a keystroke, mouse input, a smart pen, a touch of a screen, input from a device such as a joystick, an identifier of the user, or other such events, inputs or devices. Usage data may be collected according to selected time intervals, such as every five seconds or another convenient time period. In embodiments, a portion of the event data may be discarded. The usage data may be processed to form output, which may be organized by user or across multiple users according to software application or relevant device.

In another exemplary embodiment, the method or system may provide discreet levels of access based on a predetermined level of authority of the individual seeking access. For example, a manager may have increased access to usage data relative to an administrator.

In another aspect, the usage data may be collected from a variety of different sources or devices, such as a keyboard, mouse, touch screen, smart pen, intellipoint, trackball, screen, data buffer, processor, sensor, port, storage medium, network interface, or others. In embodiments an operating system of a computer may include a facility to capture the usage data.

In another aspect, the user may be unaware of the implementation of the monitoring systems and methods, and operation of the methods and systems may not be visible to the user. In embodiments, the user may be an individual with responsibility that may be monitored for the benefit of the enterprise or institution, such as a stock broker operating securities trading software, a teller or cashier handling company funds, or an administrator handling patient records. The user may also be a system administrator with the ability to view personal information of users on a network.

In another aspect, event data may include keystroke data (such as letters typed on a keyboard), active window data (such as the software application currently being used), port activity data (such as information being transmitted through the Internet), power state data (such as whether a particular device is on or off), or process execution data (such as the duration of time during which an Internet browser is active on a user's desktop). Event data may also relate to usage of a word processor or software integrated development environment, or entry of a password.

In another embodiment, the characters captured may be compared with a predetermined list of words, such as “bomb” or “arson”, to identify a potential security violation. In another aspect, access to, or the manner of use of, various applications may be monitored. For example, access to or changes to patient data may be monitored in order to comply with HIPAA requirements; and access to or revisions of personal finance records may be monitored in order to comply with Gramm-Leach-Bliley or similar strictures. Within a corporate environment, management may monitor finance applications, human resource applications, regulatory reporting applications, or any other infrastructural resource.

In another aspect, password entry, or failed password attempts may be monitored, to determine what users are accessing secure applications or data and what users are attempting to do so.

In other embodiments, data may be collected regarding various content exploited by a user. For example, access to games, sports, gambling websites, pornography, criminal matters, personal information, medical records, trade secret information, or job-seeking websites such as Monster.com may be monitored.

In another aspect, usage data may be captured through a sequence of devices, including PDAs or email devices that may be connected to a user computer. Usage data may also be encrypted through a variety of encryption algorithms so as to ensure an additional layer of security.

In one preferred embodiment, a software agent is installed within the user's computer to perform the service of capturing usage data and organizing such data. Data organizing may include binning, clustering, application of statistical regression techniques or another methodology. The software agent may include a buffer to hold data. The agent may also be linked through a network to a secure server or another device for purposes of storing the usage data.

In another embodiment, data that is collected from a software agent may be stored within a database located on the user computer or elsewhere. Usage data may also be stored in server database tables within a data vault. Access to the data vault may be restricted based on the level of authority of an individual seeking the data.

In another aspect, an agent may be capable of discovering devices connected to a network. Thus, if a new device were added to a network in which an agent were installed, the agent would detect it and could begin monitoring operations.

In another embodiment, data may be sampled after designated time intervals, and for a specified period. In a preferred embodiment, the duration of sampling occurs for approximately five seconds, several times per minute.

In another aspect, usage data collected may be processed. The output of the processing operation may include a subset of data collected. Processing may also consist of various operations such as hashing (or otherwise transforming data, such as into a shorter string of characters that represent the original data), translation, extraction, classification, combination, transformation, or analysis. The output may be analyzed to identify patterns, trends, tendencies, averages or other situations. Data may also be aggregated across multiple users.

In another embodiment, output of the method or process may identify various security events, such as a system file change, creation of a system directory, application installation or setup, addition of a new user to a system, identity of inactive user(s), detection of a file download, operating system event log status, agent status, backdoor activity detection, known exploit port activity, addition of a new computer to a system, detection of new device added to computer, inactive computer(s), packet sniffer detection, modem usage/network properties, virus, trojan horse, worm or denial of service attack detection, administrative/root logon, or copying of a specified file.

In another embodiment, output of the method or process may identify various policy events, such as use of an inappropriate program, use of a program at an inappropriate time, use of a windows registry/policy editor program, status of the enterprise logon and logoff policy, detection of unregistered user(s) from the logon server, detection of inappropriate content, Internet time usage policy, concurrent application licensing status, or software installation.

In another aspect, information collected may be used to indicate the location from which a device is accessed, or rates or methods for transmitting data.

In another embodiment, the system or method may be used to track access to sensitive information. For example, information technology administrators may have access to personal user information. If any of those administrators were to avail themselves of the access for illicit purposes, a trail could be established.

In another aspect, various attributes of user behavior could be monitored. For example, the system may identify unauthorized access, packet sniffing, disablement of functionality, time of access, manner of access, manner in which usage data or output is utilized, frequency of access, duration of access, indication of tampering with usage data or output, indication of modification of usage data or output, indication of interference with usage data or output, or indication of deletion of usage data or output.

In another aspect, the output may yield information regarding the status of the user device, such as indication of periods of inactivity, or improper function. The output could also provide measurements of efficiency, temperature, position, speed, acceleration, perturbation, motion, shock, or various other measurable parameters.

In another aspect, output generated from the process may be used to monitor user productivity, performance, behavior, or compliance.

In another aspect the output or underlying usage data may be retained for a specified period of time or upon reaching a specified data capacity, and it may be automatically disposed of. Output or underlying usage data may also be classified to facilitate selective disposal. For example, certain types of output, or the output of a specific user or class of users, may be retained for extended periods of time.

In another embodiment, specified output may trigger an alert. An alert may be transmitted to a third party to indicate, in real time, the occurrence of a security or policy event.

In another aspect, a report may be generated from the output. The report may be customized, and may reflect the results of various data mining operations performed on the data. The report may also be searchable, and may include a summary of the data, or statistical, temporal or frequency information. The report may omit occasional or low-frequency items. The report may indicate levels of productivity of a specified user. The report may also cover a specified period of time, such as a week or a month. Information in the report may be analyzed, processed, compiled or organized. In addition, data contained in the report may be de-identified to provide anonymity.

In another aspect, a report may also aggregate information with respect to classes of users, devices or software applications. A report could also disclose a chain of custody over information within a system.

In another aspect, access to information may be provided for a specified period of time, such as to facilitate an audit or an enforcement proceeding. Selective access to information may be granted in a manner to allow multiple tiers of access in which both the levels of access and the individuals to whom access is granted are definable.

In another aspect, views may indicate occurrence, non-occurrence and disablement of featured events, and may be specific to a selected device, application or user. As an example of non-occurrence, if a user is required to take some action, such as to check in with a supervisor within a certain period of time, the system can register the absence of that event as an event in itself Many other types of non-occurrence can be captured, such as failure to initiate an application when required, failure to enter a password, failure to include required disclaimers in an email, failure to copy a required person on an email, or others.

In another embodiment, the usage data may be transmitted to a server, a computer workstation, or another facility in real time or in batches. In a preferred embodiment, the usage data would be transmitted in a manner designed to ameliorate network disruption.

Methods and systems are provided herein for improving security of an enterprise or institution. The methods and systems may include capturing event data from a user device, the event data relating to at least one of an application used by a user, a keystroke entered by a user, a mouse event executed by a user, a device used by a user, and an identifier of a user. Capturing usage data may include collecting the usage data according to selected time intervals. Capturing usage data may also include discarding a portion of event data not related to at least one of the application, the keystroke, the mouse event, the device and the identifier. The methods and systems may include processing such usage data to form output, and offering access to selective views of such output, wherein the selective views are organized according to at least one of an application, a device and a user.

In embodiments, methods and systems may include limiting access to the selective views based on a predetermined level of authority of the party seeking access. In embodiments the user device is a computer device. In embodiments usage data is collected from a keyboard, a mouse, an intellipoint, a trackball, a cursor pointing facility, a screen, a screen buffer, a processor, a software buffer, a mechanical sensor, an electrical sensor, an other sensor, a disk drive, a port, a removable a storage media, a network interface, a touchpad, a digitizing a tablet, a touchscreen, a joystick, a light pen, a voice recognition facility, a biometric facility, a global positioning system, a satellite means, a measurement device, and/or volatile or non-volatile computer memory.

In embodiments capturing event data from a user device uses an event capture facility of the operating system of a device. In embodiments the user is selected from the group consisting of an employee, a consultant, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward and/or a non-authorized user.

In embodiments the user is unaware of the implementation of the methods and systems used herein. In embodiments the method is not visible to the user.

In embodiments the user is a broker and the event data relates to the use of a securities trading application. In embodiments the user is a patient and the event data relates to medical treatment. In embodiments the user is a banker, financial officer, cashier, teller, comptroller, trustee, and/or accountant and the event data relates to the management of funds or property. In embodiments the user is an employee and the event data is utilized to assist a company's management in monitoring computer usage in a work environment. In embodiments the user is a clerk and the event data relates to the management of goods. In embodiments the user is a vendor and the event data relates to the provision of goods or services. In embodiments the user is a steward or guardian and the event data relates to the care of a ward. In embodiments the user is a student or teacher and the event data relates to the provision of education. In embodiments the user is a teacher and the event data relates to the provision of education. In embodiments the user is system administrator and the event data relates to access to user-specific information.

In embodiments the event data captured from a user device is keystroke data, active window data, port activity data, power state data, user login data, or process execution data. In embodiments the event data relates to usage of a network application. In embodiments the network application is Internet Explorer, NetScape Navigator, a browser, an Internet mail program, an Internet portal program, a web application, and/or a web service. In embodiments the event data relates to the usage of a word processing application such as Microsoft Word, WordPerfect, WordStar, MultiMate, Sprint, Emacs, or XyWrite. In embodiments the event data relates to the usage of an integrated development application. In embodiments the event data relates to the entry of characters that represent a security code. In embodiments the characters captured by the event capture facility are compared to a list of words to identify a potential security violation. In embodiments the event data relates to the use of a system administration application. In embodiments the event data relates to the use of a secure application. In embodiments the secure application is a financial application, a gaming application, a banking application, a securities application, a finance application, a trading application, a compliance application, a human resources application, a procurement application, an enterprise resource management application, a customer relationship management application, a supply chain management application, an organizational management application, a performance management application, an inventory management application, a regulatory reporting application, a sponsored research application, a legal application, a compensation application, an industrial design application, an engineering application, a medical application, a health-related application, a patient records application, and/or a contracts administration application.

In embodiments the data relates to a failed password attempt. In embodiments the data relates to content viewed or accessed by the user. In embodiments the content is chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and/or trading information.

In embodiments the usage data is encrypted. In embodiments encryption employs Data Encryption Standard, any RSA algorithm, the International Data Encryption Algorithm, RC2 and/or RC4. In embodiments event data is captured from a device linked to one or a plurality of additional devices from which data is obtained. In embodiments event data is recorded within the user device. In embodiments an agent is installed within the user device, the agent capturing usage data and performing a data organizing operation. In embodiments the data organizing operation is selected from the group consisting of binning, clustering, or application of regression techniques. In embodiments the user device includes a database of usage data collected from an agent. In embodiments the usage data is stored in tables within the agent database. In embodiments the agent includes a buffer to hold usage data prior to transmission. In embodiments the agent is linked through a network to a second device for the purpose of storing the usage data in a data vault. The second device may be a secure server. In embodiments the usage data is stored in the data vault in server database tables. In embodiments access to the data vault is restricted based on the authority of the party seeking a report from the data vault. In embodiments the data vault is situated on the second device. The network may be a local area network, wide area network, virtual private network, and/or wireless network. In embodiments an agent is integrated into an operating system. In embodiments an agent is capable of performing self-discovery of devices connected to a network to which the device on which the agent is installed is connected (such as using conventional network discovery tools, such as those that allow a system to ping, scan and/or view devices connected to a network). In embodiments usage data is recorded on a remote facility. In embodiments an agent is installed remote facility, the agent capturing usage data and performing a binning operation.

The user device may be a computer, a computer workstation, a computer server, a direct attached storage device, a network attached storage device, a storage area network device, a dongle device, a cellular telephone, an instant messenger device, an SMS device, a paging device, an electronic mail device, a wireless device, and/or a personal organizer device. In embodiments the user device has a network address that is fixed. In embodiments the user device has a network address is leased through DHCP or another means. In embodiments the user device resides on a network. In embodiments the network is protected by a firewall. In embodiments the data is processed to form output that is identical to the usage data. In embodiments the data is processed to form output consisting of a subset of the usage data. In embodiments the data processing consists of hashing of the usage data. In embodiments the data processing consists of translation of the usage data. In embodiments the data processing consists of extraction of the usage data. In embodiments the data processing consists of analysis of the usage data. In embodiments the data processing consists of classification of the usage data. In embodiments the data processing consists of combining components of the usage data.

In embodiments the data processing consists of transformation of the usage data. In embodiments the data processing consists of tokenization of the usage data (such as where an input data file is converted into a sequence of preprocessing tokens). In embodiments the data processing consists of application of artificial intelligence techniques. In embodiments the data processing consists of analytic or informatic processing of the output. In embodiments the data processing consists of performing operations on usage data collected from a plurality of users. In embodiments the data processing consists of sampling of usage data after time intervals. In embodiments the time intervals are specified. In embodiments the time intervals are approximately five seconds long. In embodiments the time intervals are random. In embodiments the sampling occurs for a specified duration. In embodiments the duration is approximately five seconds. In embodiments the output identifies or includes a specific event or a plurality of specific events.

In embodiments of the methods and systems described herein, events may be security events or policy events. In embodiments a security event may be a system file change, system directory creation, application installation or setup, new user added to system, inactive user(s), detection of a file download, operating system event log status, agent status, backdoor activity detection, known exploit port activity, new computer added to system, detection of new device added to computer, inactive computer(s), packet sniffer detection, modem usage/network properties, virus, trojan horse, worm or denial of service attack detection, administrative/root logon, and/or copying of or access to specified file. In embodiments policy events may be use of an inappropriate program, use of a program at an inappropriate time, use of a windows registry/policy editor program, status of the enterprise logon and logoff policy, detection of unregistered user(s) from the logon server, detection of inappropriate content, attributes of Internet time usage policy, concurrent application licensing status, and/or software installation. In embodiments the output identifies the location from which a device is accessed. In embodiments the output includes information regarding transmission rates or transmission means. In embodiments the output includes information regarding access to usage data or output. In embodiments such information is selected from the group consisting of unauthorized access, packet sniffing, disablement of functionality, identification of user seeking access, identification of device from which access is sought, identification of usage data or output accessed, time of access, manner of access, manner in which usage data or output is utilized, frequency of access, duration of access, indication of tampering with usage data or output, indication of modification of usage data or output, indication of interference with usage data or output, indication of deletion of usage data or output, or attempts with respect to any of the foregoing.

In embodiments the output includes information regarding the status of the user device. In embodiments the information indicates inactivity or non-use. In embodiments the output includes proper or improper function of the device or one or a plurality of a components thereof. In embodiments the output includes measurement of temperature, efficiency, position, speed, acceleration, motion, perturbation, shock, inactivity, disablement, time, or other parameters.

In embodiments the output is used to monitor productivity of a user. In embodiments the output is used to monitor performance of a user. In embodiments the output is used to reward performance of a user. In embodiments the output is used to penalize a user. In embodiments the output is used to monitor behavior of a user. In embodiments the output is used to monitor compliance with of a policy or procedure. In embodiments the output is used to monitor user compliance with a law, rule, restriction or regulation. In embodiments the output is used to monitor compliance with a licensing or leasing restriction. In embodiments the output or underlying usage data is retained for a specified period of time. In embodiments the output or underlying usage data is automatically disposed of after a specified period of time. In embodiments the output or underlying usage data is automatically disposed of after a specified quantity of data is collected. In embodiments the output or underlying usage data is classified to facilitate selective disposal. In embodiments the output or underlying usage data includes or triggers an alert. In embodiments the alert is transmitted to a third party. In embodiments the output data triggers a reward.

In embodiments, one or a plurality of reports is generated from the output. In embodiments the report may be customized. In embodiments the report reflects the results of data mining operations performed on the output. In embodiments the report may be searched. In embodiments the report includes a summary of aspects of the output. In embodiments the report includes statistical information relative to the output. In embodiments the report includes temporal information relative to the output. In embodiments the report includes frequency information relative to the output. In embodiments the report indicates levels of productivity. In embodiments the report excludes, segregates or filters out incidents of low frequency. In embodiments the report covers a specified period of time. In embodiments the period of time is a day, week, month, fiscal quarter, calendar quarter, fiscal year, or calendar year. In embodiments the information included in the report has been aggregated, analyzed, processed, compiled, or organized. In embodiments the information in the report has been de-identified. In embodiments the information in the report has been selectively de-identified. In embodiments the information presented in the report suggests or identifies trends or patterns. In embodiments the information presented in the report reflects selective application of rules to classes of users, devices, or applications. In embodiments the information presented in the report indicates a chain of custody. In embodiments the chain of custody includes the identity of individuals accessing data. In embodiments the chain of custody includes information regarding use or manipulation of data. In embodiments the chain of custody includes temporal information regarding access to, use of, or manipulation of data. In embodiments the output is aggregated amongst a plurality of users, devices or applications.

In embodiments access to the output is conducted through a web browser. In embodiments the web browser provides access to a web server. In embodiments access to output through a web browser is conducted through a secured connection facility. In embodiments access to the output is conducted through a dedicated client facility. In embodiments access to the output may be selectively initiated. In embodiments access to output consisting of user-specific or private data is selectively provided. In embodiments access to output is restricted through use of a password or a plurality of passwords. In embodiments the selective access is granted through voice recognition or any other biometric recognition facility. In embodiments the output may be accessed in substantially real time. In embodiments the access is selectively provided through a means selected from the group consisting of restricted network access, restricted device access or another means of restricted access. In embodiments access is provided for a defined period of time. In embodiments the period of time is selected to provide limited access to data for auditing or enforcement purposes, or in accordance with record retention controls. In embodiments the access is granted through a routing facility designed to selectively route information. In embodiments the facility is selected from a group consisting of email, Internet access, intranet access, SMS, instant messaging, telephonic communication, and similar means. In embodiments the selective access comprehends a plurality of discrete levels. In embodiments the number of discrete levels may be selected and revised. In embodiments the extent of access applicable to each level may be selected and revised. In embodiments the combination of features accessible at each level may be selected and revised. In embodiments access is selectively provided in a business environment such that an administrator has a reduced level of access relative to a manager. In embodiments access is selectively provided in a business environment such that the human resources organization has an enhanced level of access. In embodiments access is selectively provided in a business environment such that the in-house legal organization has an enhanced level of access. In embodiments access is selectively provided in a non-business environment such that an administrator has a reduced level of access relative to an individual with more senior status. In embodiments the access is selectively provided in a manner that provides greater access to individuals with greater authority or seniority within an organization. In embodiments an increased level of access is provided to facilitate an auditing function. In embodiments an increased level of access is provided to facilitate forensic analysis. In embodiments access is provided to facilitate troubleshooting of one or a plurality of devices or applications. In embodiments access is provided to facilitate portability into an alternative format. In embodiments views are categorized into event occurrence, event non-occurrence, and event disablement. In embodiments application views provide information selected from the group consisting of frequency of access, duration of time accessed, time accessed, manner of access, manner of use, identity of user gaining access, and/or identity of machine on which accessed.

In embodiments device views provide information about frequency of access, duration of time accessed, time accessed, manner of access, manner of use, identity of applications executed thereon, or identity of user gaining access.

User views may provide information about frequency of access to an application or device, duration of time accessed, time accessed, manner of access, and/or manner of use.

Embodiments of the methods and systems disclosed herein may further include installation of software within a single network node, which software dynamically detects one or a plurality of additional nodes of the network. Embodiments may also include a secondary method to transmit usage data to an output facility through the secondary method ensures transmission of usage data upon failure or disablement of the primary means. In embodiments usage data is transmitted to an output facility in real time. In embodiments usage data is transmitted to an output facility through batch processing. In embodiments usage data is transmitted to an output facility in a manner designed to ameliorate disruption to functions or activities conducted over, or reduce load to, transmission facilities. In embodiments transmission of usage data is delayed during intervals of increased traffic over transmission facilities. In embodiments usage data is transmitted to an output facility through a network using a network protocol. In embodiments the network protocol is TCP/IP, UDP, IPX, SPX, NetBEUI, IPv6, Apple Talk, or a similar network protocol.

In embodiments the network is an Ethernet facility, switched Ethernet facility, wireless facility, Token Ring facility, Arcnet facility, the Internet, an Intranet, or a similar facility. The network topology may be a ring topology, mesh topology, star topology, bus topology, tree topology, or other topology.

In embodiments usage data is transmitted to an output facility through a secured connection. The methods and systems may also use a collection facility that records the output. In embodiments the collection facility is a computer. In embodiments the collection facility incorporates storage media. In embodiments the storage media may be volatile or non-volatile computer memory such as RAM, PROM, EPROM, flash memory, and EEPROM, floppy disks, compact disks, optical disks, digital versatile discs, zip disks, and/or magnetic tape.

Methods and systems disclosed herein may further include a collection facility that stores metadata derived from the output. Methods and systems may include encryption of the output. Encryption may be Data Encryption Standard, any RSA algorithm, the International Data Encryption Algorithm, RC2 and/or RC4.

Methods and systems disclosed herein include those for managing security in a business enterprise and may include detecting at periodic intervals events that correspond to user interactions with computers connected to a network of the enterprise; storing such events in a data facility; organizing the events by user, by computer and by event type; and presenting a summary of the events in a graphical-format report, wherein a viewer of the report may select the organization of the report.

Methods and systems may further include managing compliance with policies of a business enterprise and may further include detecting at periodic intervals events that correspond to user interactions with computers connected to a network of the enterprise; storing such events in a data facility; organizing the events by user, by computer and by event type; and presenting a summary of the events in a graphical-format report, wherein a viewer of the report may select the organization of Methods and systems disclosed herein may include managing productivity of individuals operating within a business enterprise and may include detecting at periodic intervals events that correspond to user interactions with computers connected to a network of the enterprise; storing such events in a data facility; organizing the events by user, by computer and by event type; and presenting a summary of the events in a graphical-format report, wherein a viewer of the report may select the organization of the report.

The methods and systems used herein can be used to administer a test in an institutional environment, such as a classroom, law enforcement setting, license registration setting or the like, such as to ensure that each user only uses the computer application for the test, rather than searching for other sources of information.

In embodiments, the agent may adjust the interval used for binning data based on system requirements, data already collected, hard disk status, the level of a detected security or policy event, or other factors.

In embodiments certain events, such as opening a trade secret database and compose an email to an outside person, may trigger closer scrutiny and capturing of events.

Methods and systems disclosed herein further include a methods and systems for managing security in an enterprise, including detecting at periodic intervals events that correspond to user interactions with computers connected to a network of the enterprise; storing such events in a data facility; organizing the events by user, by computer and by event type; permitting access by an individual to the stored events; and logging events that indicate the nature of the access by the individual to the stored events.

All patents, patent applications, specifications and other documents referenced herein are hereby incorporated by reference.

### BRIEF DESCRIPTION OF THE FIGURES

FIG. 1 is a schematic diagram showing the interrelationships among users connected via a network, with oversight by a manager and a system administrator.

FIG. 2 is a schematic diagram illustrating the architecture of devices and processes within a networked system.

FIG. 3 is a flow diagram of an embodiment of a rule engine.

FIG. 4 is a flow diagram representing the stream of events from addition of users and devices through collection, processing and reporting of data.

FIG. 5 illustrates the structure of data flow within a computer network.

FIG. 6 depicts a user interfacing with a computer to produce usage data.

FIG. 7 provides examples of means to collect usage data.

FIG. 8 illustrates encryption of usage data.

FIG. 9 provides an example of a linked device from which data may be captured.

FIG. 10 graphically depicts the operations of a software agent.

FIG. 11 illustrates a data buffering operation.

FIG. 12 depicts an architecture wherein data is routed in a manner to mitigate network interference.

FIG. 13 shows the progress of data from a buffer into a data vault.

FIG. 14 illustrates detection by an agent of a device connected to a network.

FIG. 15 presents examples of types of devices from which usage data may be captured.

FIG. 16 provides an illustration of various data processing methodologies.

FIG. 17 depicts usage data being provided from a plurality of users.

FIG. 18 illustrates sampling of data following five second intervals.

FIG. 19 represents automatic disposal of data.

FIG. 20 illustrates an email alert being produced in response to user access to prohibited content.

FIG. 21 shows a graphical user interface whereby security events and policy events are catalogued and tracked.

FIG. 22 illustrates an embodiment of a graphical user interface depicting computer activity levels over a designated period.

FIG. 23 includes a graphical user interface in which an application may be selected.

FIG. 24 provides a graphical user interface in which user data or device data may be selected.

FIG. 25 depicts a graphical user interface providing temporal information with respect to specific Internet websites accessed.

FIG. 26 shows a graphical user interface in which reports and summaries may be selected.

FIG. 27 provides a graphical user interface in which complete or customized daily summaries may be selected.

FIG. 28 includes a graphical user interface summarizing security events, policy events and application activity.

FIG. 29 illustrates a graphical user interface providing drilldown data on a selected computer.

FIG. 30 shows a graphical user interface presenting application utilization data.

FIG. 31 is a graphical user interface providing usage information regarding a selected application.

FIG. 32 is a graphical user interface showing a breakdown by department of computer utilization.

FIG. 33 is a graphical user interface illustrating daily computer and user usage, as well as aggregate productivity across all computers within a network.

FIG. 34 is a graphical user interface listing attributes of the top ten applications used within a specified period.

FIG. 35 is a graphical user interface listing daily security events detected.

FIG. 36 is a graphical user interface listing daily policy events detected.

FIG. 37 is a graphical user interface depicting viewing options with respect to user data.

FIG. 38 is a graphical user interface providing viewing options with respect to computer data.

FIG. 39 presents an embodiment of the invention deployed in a hospital environment.

FIG. 40 presents an embodiment of the invention deployed in an accounting environment.

FIG. 41 presents an embodiment of the invention deployed in a human resources environment.

FIG. 42 presents an embodiment of the invention deployed in an educational environment.

FIG. 43 presents an embodiment of the invention deployed in a military environment.

FIG. 44 presents an embodiment of the invention deployed in an MIS environment.

FIG. 45 presents an embodiment of the invention deployed in a research and development environment.

FIG. 46 presents an embodiment of the invention deployed in a banking environment.

FIG. 47 presents an embodiment of the invention deployed in a supply chain management environment.

FIG. 48 presents an embodiment of the invention deployed in a trading environment.

### DETAILED DESCRIPTION

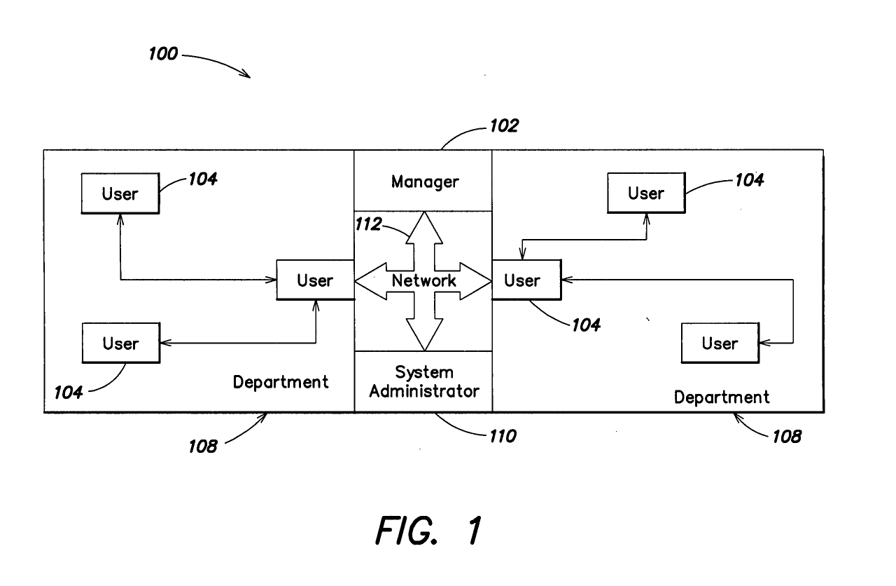

FIG. 1 is a schematic diagram depicting the interrelationships among various computer users of an enterprise connected through a computer network 112. Various users 104 use computer applications within the enterprise. The enterprise may include one or more managers 102, overseeing one or more departments 108, in which users 104 may be organized. The various users 104, departments 108 and managers 102 may be connected by a network 112, such as central corporate hub, a virtual private network, the Internet, a local area network, a wide area network, a Thin Client Network, or other network. Access to event data captured from users 104 disposed throughout the network 112 may be provided to one or a plurality of managers 102 for oversight of operations. The business may also have one or a plurality of information technology system administrators 110, such as for oversight of network and computer facilities. It should be understood that while FIG. 1 depicts an enterprise with a manager, departments, and users, those terms are intended to encompass any kind of enterprise with any form of organizational hierarchy and any type of computer users within the hierarchy, such as a school having principles, teachers and students, a military organization having officers, enlisted personnel and civilian administrative personnel, a medical environment having administrators, doctors, nurses, physicians, interns, residents, surgeons, physicians assistants, and administrative staff, a government entity having elected officials, appointed officials and staff, a professional firm having partners, members, consultants, counselors, associates and/or staff, a non-profit entity having officers and personnel, or other form of entity. Thus, the terms “enterprise,” “business enterprise,” “manager,” “administrator,” and “user” throughout this disclosure should be understood to encompass various other persons operating in different kinds of enterprises.

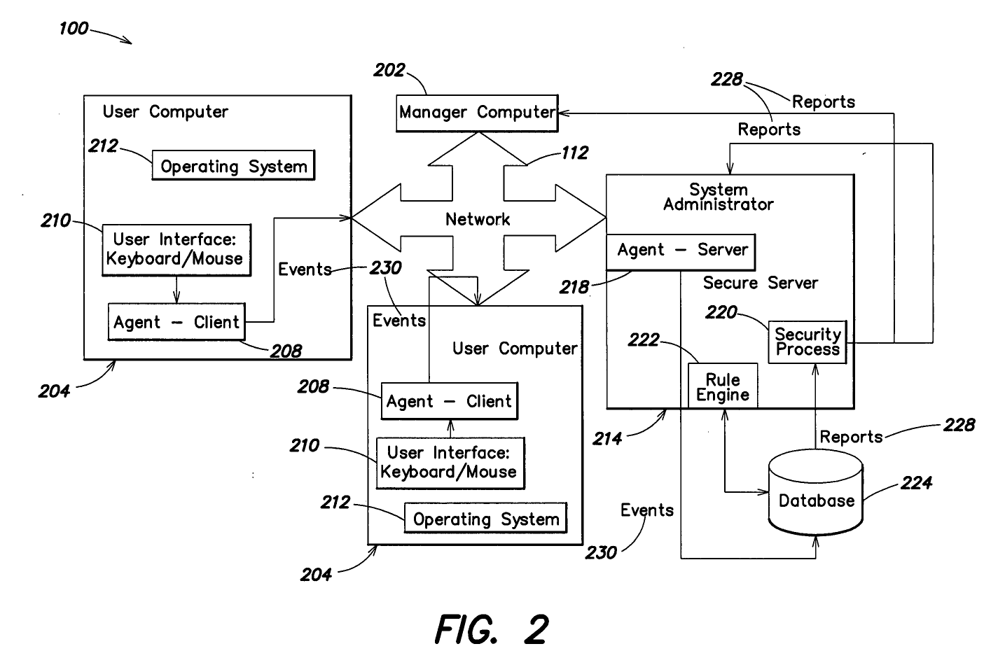

As illustrated in FIG. 2, in a system 100 a plurality of user computers 204 may be related through the network 112. Each user computer 204 constitutes a client on the network 112 and may include, among other things, an operating system 212 such as Microsoft Windows, Novell, Macintosh OS, Linux, Free BSD, Net BSD, Open BSD, Solaris, AS400, Unix, HP-UX, IBM-AIX, Citrix®, Microsoft® Terminal Services. Each user computer 204 may also include a user interface 210, such as a keyboard and mouse combination, a trackball, an intellipoint, a mousepad, a touch screen, a smart pen or other interface 210. The user computer 204 may include a software agent 208 resident within the operating system 212 or installed elsewhere on the user computer 204.

Certain components are depicted in FIG. 2 for certain preferred embodiments of the methods and systems disclosed herein. In a preferred embodiment, as depicted in FIG. 2, event data or events 230 may be captured that reflects the use of a user interface 210. The agent 208 can capture the events 230 and transmit the events 230 through the network 112 to a server, which may be a secure server 214. A software agent 218 may be installed within the server 214 to facilitate application of a rule engine 222 to identify events, such as security events or policy events. The rule engine 222 may interface with a data facility 224, such as a database in which captured event data has been compiled and stored. Events 230 may be aggregated and processed, and reports 228 may be generated from the data facility 224, such as by conventional database reporting facilities. In embodiments, through use of a security process 220, such as installed on the secure server 214 or another server or machine that provides access to the data facility 224, various reports 228 in various configurations may be selectively accessed by individuals of varying status. For example, a manager 102 may have visibility of events 230 solely within his or her department 108, while an information technology administrator 114 may have access to data procured from across the network 112. Alternatively, an executive of an organization may be privy to information of a personal nature input from users while an administrator may be provided access to only selective portion, or to aggregated statistical data, or to data for which personal identifiers have been obscured or discarded.

In embodiments, all activity by any person (such as an executive, manager, or system administrator) who logs on to the system to view events may also be viewed, including by others logging on to the system. The system can permit viewing of the actions taken by the individual using the system, which permits peer reviewing of the use of the system to discourage abuse.

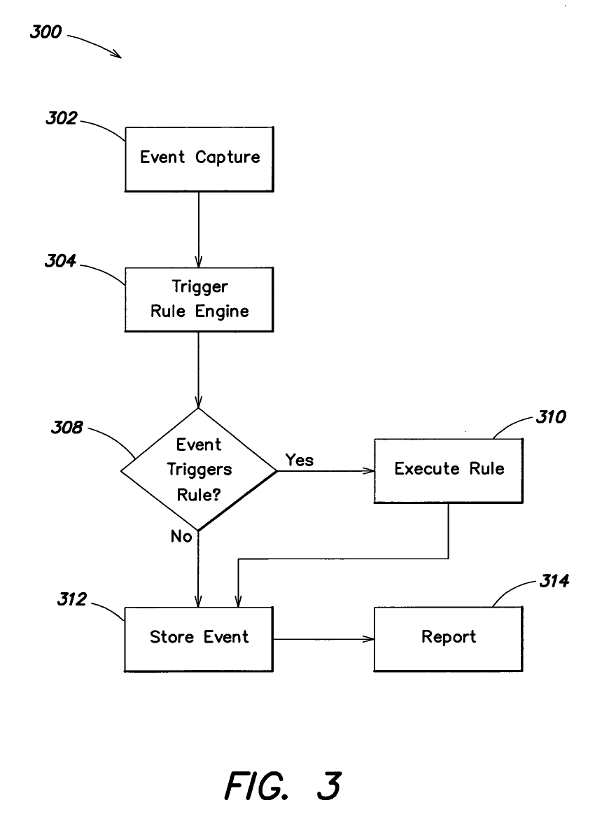

High-level steps for capturing and reporting on events are depicted in the flow diagram 300 of FIG. 3. At a step 302, an event, such as a user accessing an Internet chat room, may be detected. Capturing the event 302 can trigger a rule engine at a step 304, such as when the event is sent by the agent 208 to the server 314 for operation by the rule engine 222. The rule engine 222 can store rules for operating on events of various types. At a step 308 the rule engine 222 can determine whether a particular event triggers a rule of the rule engine 222. If at the step 308 it is determined that an event triggers a rule, then the rule is executed at a step 310. For example, if the event has been previously defined as an unauthorized activity within a rule engine, then evidence of the event, and related temporal, user, and device information may be sent with an alert, such as an email message, such as to the manager 102 or system administrator 114. If at the step 308 the event does not trigger an alert rule, then the event may be stored at a step 312, such as in the data facility 224. Then, at a step 314 the system may report the event, either on its own or as part of an aggregated report, such as a report of all users who have accessed a particular Internet site, or other similar report. Thus, in addition to a report, an alert, proffered through electronic mail, a paging device, telephone auto-dialing, an SMS message or otherwise, may be generated and transmitted. Alternatively or in addition to sending an alert, the event data may be retained within a data facility 224 for subsequent data mining or processing.

With the rule engine 222 at the step 308, many other implementations are feasible. For example, if a system file change is detected, a network administrator may be alerted. If unauthorized access is detected, additional layers of firewall protection may be erected, or portions of a system may be locked down. If illicit material is downloaded or viewed via the Internet, incremental demerits may be logged for the relevant user. If a prohibited application, such as a game, is executed, then a supervisor may be alerted. Access to an unauthorized application providing personal user information, such as human resource data, compensation data, patient data, financial data, or competitive information, may cause that application to be immediately terminated either at the site of the device, on the server from which it is accessed, or across a network. Detection of excessive application use, such use by children of an Internet web browser beyond a proscribed amount, may trigger an alert to parents or terminate the application. Discovery of the use of a “security word”, such as the name of a suspected terrorist, could route advisory information to law enforcement authorities in real time. Use of vulgarity by students within a computer lab classroom setting may activate an auditory alert to draw attention to the illicit behavior. Use of inappropriate programs, such as programs for network hacking or password retrieval, can be detected in real-time and used to alert security personal.

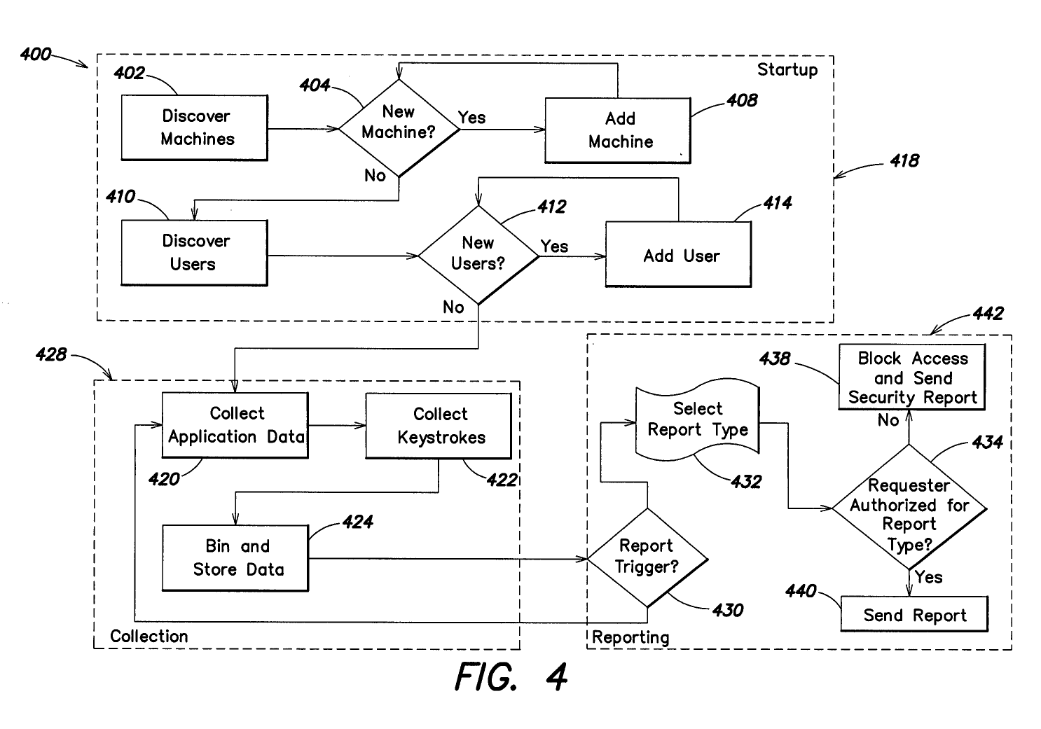

FIG. 4 provides a high-level flow diagram 400 showing steps accomplished by the methods and systems disclosed herein. First, a set of startup steps 418 can take place, such as when the system is turned on, or when a user or device is added to the network 100. At a step 402 the system may audit computers and users on a network and, if at a step 404 it is determined that a computer or user is unrecognized, the system may detect and report that event, adding the machine at a step 408 to the system. The steps 404 and 408 may be repeated until all new machines are detected, reported, and added to the system (or excluded from the system in certain embodiments of the invention). At a step 410, the system can determine what users are logged on to the system. If at a step 412 it is determined that there are new users, the system can add the new users 414 (or reject them in alternative embodiments), returning to the step 412 until all new users are added to the system, completing the startup steps 418 that ensure that all machines and users are known to the system.

Next, a series of collection steps 428 can take place, at which the system collects data. At a step 420 the system collects application data, such as the execution or use of various software programs, times of use, the identity of the user 104 of the device 204 on which the application is running, and the identity of the device 204 on which the program is run. At a step 422, the system can collect keystroke, mouse, mousepad, touch screen, intellipoint or other data input from a user. In embodiments all such data may be binned and stored as events. Referring again to FIG. 3, if any of the data captured triggers a rule defined by a rule engine, then an alert, report, or other action (such as denial of access) may be generated. Authorization levels may be defined so that the action may be taken only by an authorized user. Referring again to FIG. 4, the application data and event data can be binned and stored at a step 424, such as in bins that are associated with time intervals. For example, a bin may indicate what applications were running and what keystrokes were entered during a five second interval, such as the first five seconds of a given minute.

Once the startup steps 418 and the collection steps 428 are complete, the system may complete certain reporting steps 442. At a step 430 the system can determine whether a particular event triggers a report. Alternatively, a report may be triggered by an external event, such as a timed event from the system (such as for an hourly, daily, weekly, monthly or other periodic report) or a request for a report from a user, such as a manager or a system administrator. Once a report is triggered at a step 430, a user may be prompted to select a type of report at a step 432, such as through a user interface for a reporting facility, such as a graphical user interface in which various menu options represent different kinds of reports. If a user selects a particular report at the step 432, the system can determine at a step 434 whether that user is authorized to receive the particular type of report. If not, then the user is denied access at a step 438, in which case the system can optionally send an alert that an attempt has been made to access a report by an unauthorized user. If the user is authorized to receive the report at the step 434, then the system can provide the report at the step 440. In embodiments, multiple authorization levels may also be defined for accessing reports, so that a report may only be accessed by users with a defined permission grade. If a user requests unauthorized information, the user may be denied access to the unauthorized information and/or an ad hoc security report may be generated. Many kinds of reports can be generated, showing usage by computer, by application, and by user, as well as showing entry of specific types of data, such as pre-identified keystroke sequences. For example, a report can show hours of Internet usage by members of the accounting department during business hours for a given week, or it could show what particular users accessed a given application during a given workday, or it could show what users changed data in a given database on a given day.

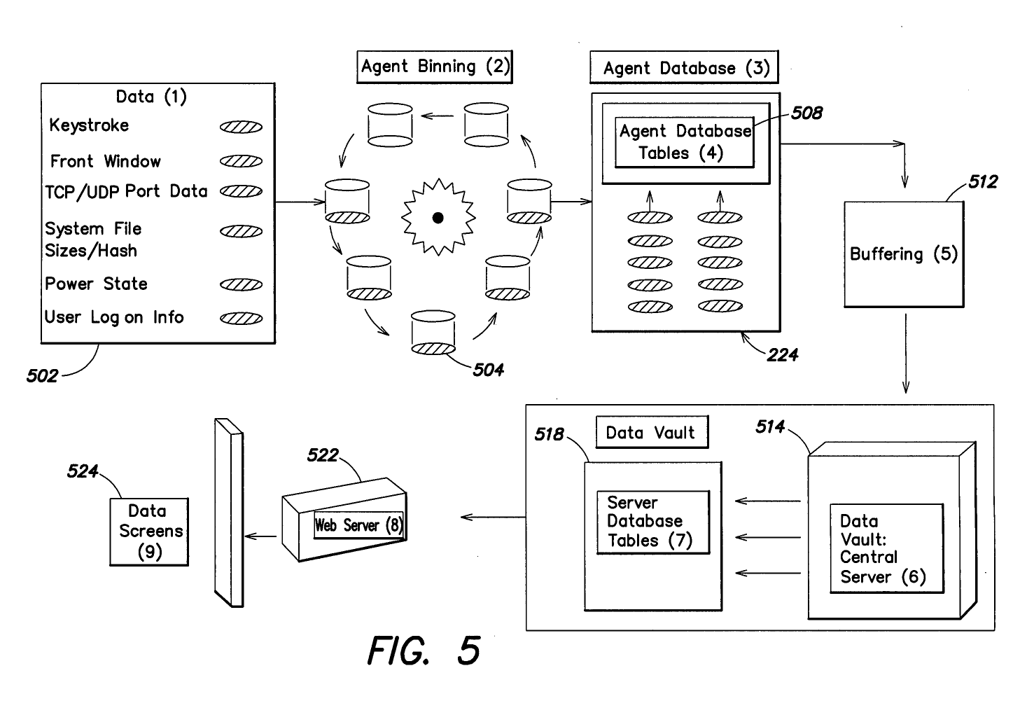

As illustrated in FIG. 5, various sources of data 502, such as keystroke data, front application window data, TCP/UDP port data, system file size or hash data, power state data or user login data, may be collected and binned at a step 504, such as by the agent 208, 218. The binning process aggregates user input into manageable data that is grouped within a temporal window. This binning process may be started when user input is detected. This input may be keystrokes, mouse movements, voice activation, or other external input facilities or sensors that indicate an action by a user. By triggering based on user action or input, data is collected regarding the user-machine interaction and not just machine behavior. This has a desired effect of reducing the processing burden required to monitor and report on user behavior. The trigger delineates the start of a bin window. This window is temporal in nature and aggregates all user actions within that window. This window defines the smallest granulation of datum that the server database handles, receives, manipulates or reports on. In embodiments, a window size of five seconds provides a very favorable tradeoff between data manageability and timeliness of the event. The agent 208 may be resident on a user computer or on a secondary or networked remote device. In an embodiment, the agent 208 may sample data at five second intervals or any other interval, and may aggregate binned data, such as within tables 508. In embodiments, such data may be stored in a buffer at a step 512 and transmitted to a server 214 at a step 514, in which it will be retained in the data facility 224 at a step 518. Reports generated from the data may be accessed via the server 214 or by another server, such as a web server, at a step 522 (optionally only if the user is authorized to receive the reports), and the reports can be displayed on a data screen of an authorized user at a step 524.

In embodiments of the invention, user input data, such as keystroke data, is archived by user, and date. The archive may be kept on the server 214 in a secure location, such as the data facility 224, such as a hard disk, so that access to the data is limited by access of a second password, such as one distributed only by a trusted third party, such as a security, compliance officer, legal counsel, or a member of a human resources department. The archived user input data, such as keystroke data, can be searched for word or word combinations. The data may be printed or downloaded. Archiving can thus be used for forensic auditing purposes in a variety of contexts.

The password given out by the trusted third party can exist forever, or for a predetermined amount of time. The password can expire, so that further access to user input data is blocked. The user input data can be stored for any amount of time, from a predetermined number of minutes, days or hours, to an unlimited amount of time. In embodiments the system administrator sets the time limit, such as at system installation. If the time limit is set at zero days of storage, the user input data is analyzed for reporting and event triggers and then immediately thrown away. If the storage time is set at infinity, the user input data is never deleted. If the storage time is set at an intermediate amount, such as 30 days, the data is kept on the server 214 for that amount of time and then thrown away.

In embodiments the user input data and archived reports might fill up the data storage facility 224, such as the hard disk, on the server 214. A calculation can be performed, such as at midnight, to determine whether the average rate of storage of user input data will fill the hard disk soon. The system can send a message notifying that there is a need to archive or remove data. In embodiments the system can automatically remove data before the hard disk is full, such as at the point where there is only thirty days of storage room left.

In embodiments all actions that involve reviewing archived data can also be stored and reviewed in accordance with the methods and systems disclosed herein.

Event data, or output generated through processing of event data, may be collected and recorded through a facility capable of recording the information, which may be part of a computer client, server or other device. Such facility may incorporate storage media, including volatile or non-volatile computer memory such as RAM, ROM, DRAM, PROM, EPROM, flash memory, and EEPROM, floppy disks, compact disks, optical disks, jump drives, USB disk drives, digital versatile discs, zip disks, or magnetic tape. Meta data may be stored in conjunction with, or coupled with, the information.

In a preferred embodiment, event data may be captured from a computer or other device. The event data may relate to an application used by a user, a keystroke entered by a user, a mouse event executed by a user (such as a mouse movement, keypad touch, touch screen touch, intellipoint movement, joystick movement, or button selection), a device used by a user, or an identifier of a user. Usage data may be collected according to selected time intervals, and portions of the data may be discarded, to the extent not relevant to the application, keystroke, touch screen event, smart pen event, mouse event, device or identifier. The usage data may then be processed to form output, and selective views of the output may be offered based on an application, device or a user. For example, a report may be generated providing statistical information regarding use of an Internet web browser by employees within a corporate environment or a selected department, or a report may confirm that employees have visited an intranet site on which a new corporate policy has been posted. The extent of information available within a report, or the availability of a report in general, may be designated in advance, and discreet tiers of authority may be assigned.

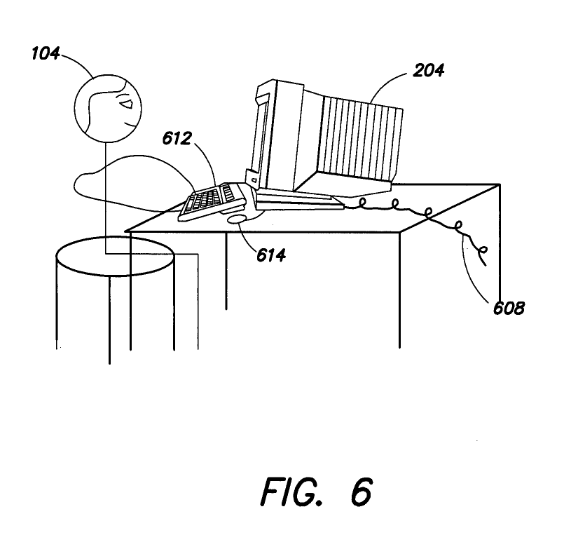

As illustrated in FIG. 6, an employee or other user 104, situated at a user computer 204, may generate usage data through typing on a keyboard 612, through use of a mouse or other cursor pointing device 614, or otherwise. The computer 204 may be connected by a network cable 608 or similar facility to a network 100, including to a server 214 also residing on the network 100, such as a server 214 of the business enterprise of the user 104. The user 104 may be, for example and without limitation, an employee, a consultant, a student, a government official, a patient, a volunteer, an attendant, a team member, a system administrator, a contractor, a vendor, a therapist, a medical technician, a nurse, a physician's assistant, a dentist, a dental assistant, a doctor, a clerk, a cashier, a teller, a comptroller, an accountant, an attorney, a financial officer, a principal, an administrator, a human resources employee, a broker, a gaming employee, an engineer, a scientist, a laboratory assistant, a guard, a banker, a trustee, a guardian, a steward, a government official, or any individual whose computer or device usage may be monitored for the benefit of an enterprise of institution.

For example, in an embodiment, the user may be a broker, and the data collected may relate to the use of a securities trading application. In such an example, a manager of the brokerage firm would have the ability to monitor appropriate usage and receive an alert, in real time, of any illicit activities, such as inappropriate activation of a trading application, or entry of a prohibited word (such as a word embodying inside information) while using a particular application, such as an electronic mail application. For example, a manager could be notified if any broker types the NYSE or NASDAQ symbols of a particular company while working in an email program, such as if the broker were prohibited from communicating about that company. In embodiments, the user may be unaware that any monitoring is occurring.

In another embodiment, the user may be an employee and the data may be used to assist a company's management in monitoring computer usage, and compiling statistics, within a work environment. In such an example, times of computer and application access may be discretely monitored, to ensure that an employee is working an appropriate quantity of hours, and to ensure that time logged in is actually spent in relevant commercial applications.

In another embodiment, the user may be a clerk, and the data may relate to management of goods or items available for sale. Reports could be generated to ensure compliance with store policies, efficiency, and other metrics. In addition, inventory matters could be assessed, and theft may be identifiable in real-time or rapidly thereafter.

In another embodiment, the user may be a steward or guardian, and the data may relate to the care of a charge or a ward. The system could be implemented in a manner to ensure enhanced quality of care for children or elders, wherein solicitation of inappropriate computer content could be observed; medication schedules may be enforced; and limits may be imposed on computer usage time. A parent may remotely track, through the Internet, the extent of time that a child is engaged in homework in contrast to games, Internet exploration, Internet chat rooms, or other activities. A parent may monitor for exploitation of minors in Internet chat rooms, or for any other unwanted or indecent exposure.

In another embodiment, usage of school computers may be actively monitored by faculty and school staff. Access to adult-rated websites or games, use of chat rooms, and other forbidden activity may be assessed and may be rapidly addressed. Statistics relevant to computer usage may also be compiled into reports that could be instrumental in campaigning for increases in funding for additional resources.

In embodiments, the system may be used to assess user access to, and use of, wide ranges of content including, for example, chat room activity, insider trading or conveyance of insider information, securities transactions or trading, gaming, pornography, vulgarity, prurience, illegal or criminal behavior, gambling, entertainment, videogames, trade secrets, proprietary information, engineering or design information, drugs, health information, medical records, patient records, financial records, accounts, educational content, sexual or other forms of harassment, policy or regulatory non-compliance, identification of a competitive entity, identification of an adverse entity, identification of a specific individual, transcript information, or access to an employment-oriented website. A system may be configured with a rule that triggers an alert when a competitor's name is used, in order to ferret traitorous activities, or when the word(s) “resume”, “CV”, or “curriculum vitae” are typed or used as a file name, in order to anticipate employee defection or disloyalty.

In another embodiment, access by a system administrator to user-specific data or personal data may be monitored by management within an organization. It may be necessary to provide comprehensive access to a system administrator, so that he or she may contend with system issues and problems; however, viewing of personal information may be restricted to a “need-to-know” and “as needed” basis. It may be advantageous to the organization to curtail viewing of personal data in excess of that required to perform system maintenance. The system may also be used to monitor those individuals performing monitoring or auditing function to ensure integrity of internal processes and controls; and this oversight may be iterated over multiple stages of authority.

Various administrators may have access to credit card information, social security numbers, financial information, health information, and other information of a personal nature. It may be beneficial to a business with access to such information to be able to ensure its customers or patrons that security and privacy will be maintained. Moreover, with the advent of data privacy laws in the United States and elsewhere, severe financial penalties may be imposed for unauthorized use of or access to personal information. In the health care industry, HIPAA requires health care information to be maintained under strict controls and, within financial institutions, the Gramm-Leach-Bliley act and the Basel II capital accord may require a similar level of vigilance. Several states have begun implementing various forms of privacy legislation, and outside of the United States, myriad privacy regulations abound. Recent legislation regarding a nationwide “do-not-call” list has borne out the emphasis being placed on unauthorized privacy intrusions. In an embodiment, the system may be implemented to monitor compliance with privacy policies and regulations, which could enhance customer confidence, assist corporations with legal compliance, and reduce fees and penalties assessed for privacy intrusion.

In an embodiment, the user being monitored may be unaware that a system is in place, and operation of the system may be invisible to the user. This may be beneficial because it would preclude attempted disablement or avoidance, and capture unwanted behavior by those with such a proclivity. In addition, a user may feel uneasy about being monitored and this anxiety could impair productivity and creativity; accordingly, covert use of the system may be preferable. Covert monitoring can be accomplished by embedding the system on a user device without telling the user.

In various embodiments, event data may relate to the use of any secure application, such as financial application, a gaming application, a banking application, a securities application, a finance application, a trading application, a compliance application, a human resources application, a procurement application, an enterprise resource management application, a customer relationship management application, a supply chain management application, an organizational management application, a performance management application, an inventory management application, a regulatory reporting application, a sponsored research application, a legal application, a compensation application, an industrial design application, an engineering application, a medical application, a health-related application, a patient records application, or a contracts administration application.

In an embodiment, use of a network application, such as Internet Explorer, NetScape Navigator, a browser, an Internet mail program, an Internet portal program, a web application, and a web service, may be closely observed and tracked. The amount of time dedicated by a user to surfing the Internet as well as the websites visited and amount of time spent on each may be recorded and may also be compared to that of other users or compiled into aggregate statistics.

In another embodiment, the extent of time spent using a utility application, such as a word processor, including Microsoft Word, WordPerfect, WordStar, MultiMate, Sprint, Emacs, and XyWrite, among others, may be examined. If use of a word processor occurs after normal business hours, a manager may drill down to determine whether use is being made for business versus personal purposes. Similarly, use of an integrated development application may be monitored to observe, for example, whether intellectual property of a company is being compromised, or whether software design and invention is occurring outside of a company's control and vigilance.

In an embodiment, the system may be used to capture entry of a password of a security code, to ensure that password theft has not occurred and that attempts at unauthorized entry are not being made. Primitive existing systems may disable a login facility after a specified number of attempts, but may reset the attempt number upon rebooting, or re-initiation of the application. Use of the system described herein may detect and may also inhibit and report on this type of security violation, or other security violations or attempts.

In general, usage data may be produced from a keyboard, a mouse, an intellipoint, a trackball, a smart pen, a mouse pad, a touch pad, a cursor pointing facility, a screen, a screen buffer, a processor, a software buffer, a mechanical sensor, an electrical sensor, a sound sensor, a touch sensor, a heat sensor, an IR sensor, any other kind of other sensor, a disk drive, a port, a removable a storage media, a network interface, a touchpad, a digitizing a tablet, a touchscreen, a joystick, a light pen, a voice recognition facility, a biometric facility, a global positioning system, a satellite means, a measurement device, and volatile or non-volatile computer memory.

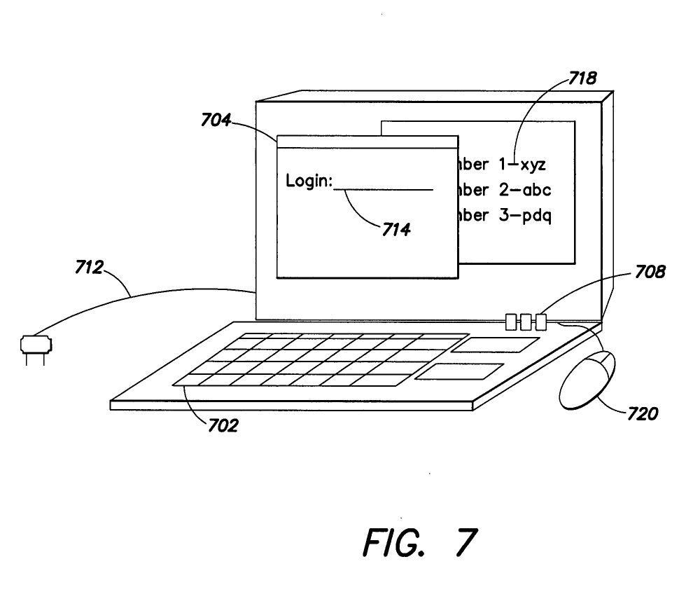

Usage events may be captured from an agent 208 or from another event capture facility, such as of the operating system of a computer. As depicted in FIG. 7, in a typical embodiment, event data may reflect input to a keyboard 702, power state 712, mouse activity 720, port activity 708, login information 714, active window data 704, or process execution data 718.

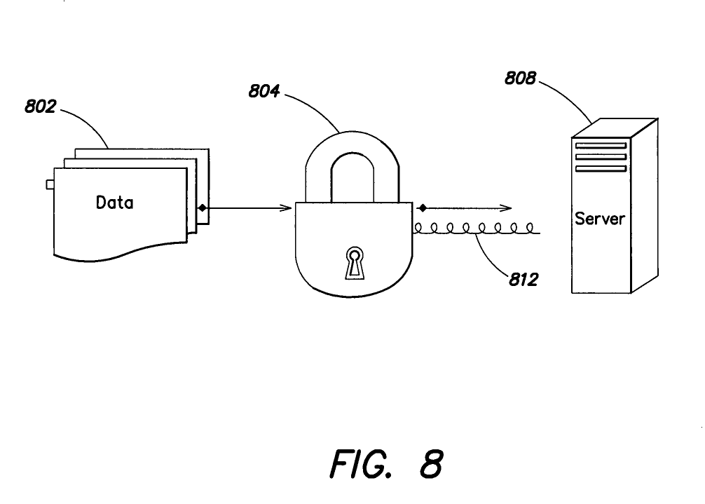

In a preferred embodiment, as depicted in FIG. 8, usage data 802 may be encrypted 804 using a standard such as Data Encryption Standard, any RSA algorithm, the International Data Encryption Algorithm, RC2, RC4, or any other standard available in the art, prior to transmission 812 to a server 808 or other network component. Output generated following processing of usage data may similarly be encrypted.

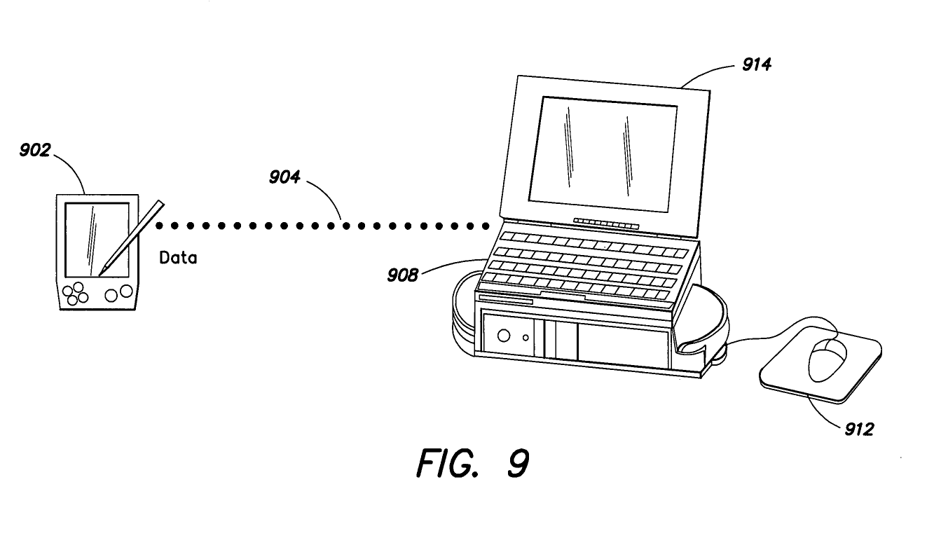

Event data may be recorded within a user device, such as a computer, or, as shown in FIG. 9, may be recorded through a PDA or other independent device 902 linked or networked 904 to a computer 914. Additional input may be recorded directly from the computer 914 via its keyboard 908, mouse 912, or otherwise.

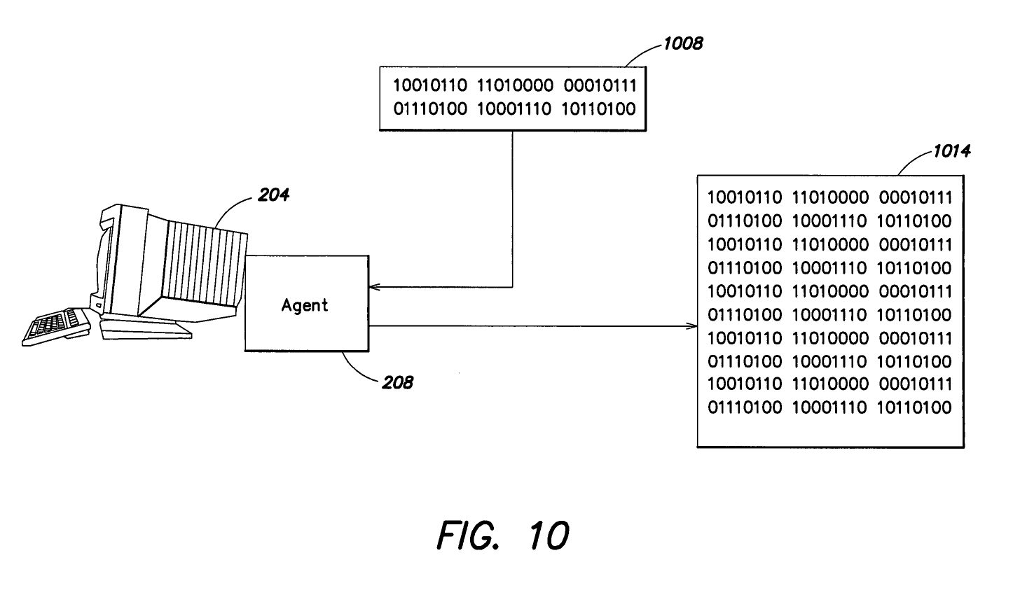

In a preferred embodiment, as represented by FIG. 10, a software agent 208 may be installed on a user computer 204. Such agent 208 may collect usage data 1008 from a user computer 204 and route such data, or a portion or aggregation thereof 1014, through a computer network 100. The agent 208 may perform various data organizing operations on the data including binning, clustering, application of regression or other statistical techniques, or any other method of cataloging, organizing, or efficiently storing or transmitting the data. Data collected by an agent may be stored within database tables or otherwise within a database such as the data facility 224 associated with the server 214 or optionally on user computers. In embodiments the agent 208, or a portion thereof, may reside on multiple user machines 204, and a portion of the agent 218 may reside on a server 214 or other device connected to the network 100.

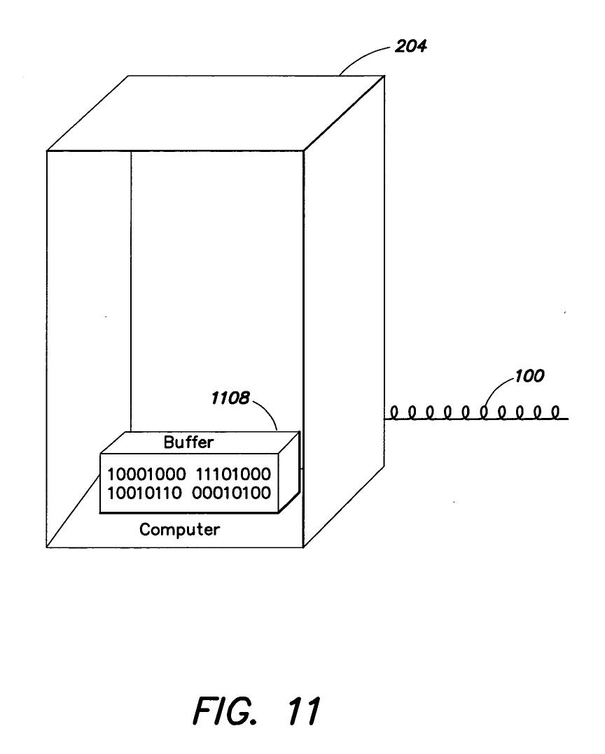

FIG. 11 illustrates the storage of user data within a buffer 1108, resident in a user computer 204. The computer may be connected to a network 100, which may be a local area network, wide area network, wireless network, 802.11 network, Bluetooth network, virtual private network, wireless network, or other network apparatus. The network 100 may be structured as a secured connection. A secondary or backup means may be employed to transmit data upon failure or disablement of a primary means.

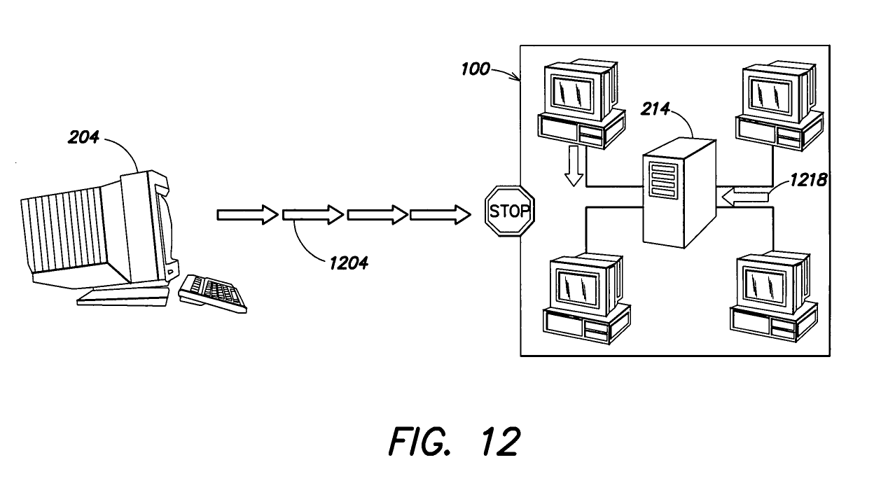

Data generated from a computer may be transmitted in real time, through batch processing, or in a manner designed to ameliorate disruption to functions or activities conducted over, or reduce load to, transmission lines. For example, as shown in FIG. 12, data generated through use of a computer 204 may be transmitted through a network 100 at intervals 1204 designed to minimize interference with signals 1218 transmitted that are unrelated to implementation of the present invention. In embodiments, transmission of data may be intentionally delayed during periods of increased traffic or activity over network lines, in order to minimize network delays.

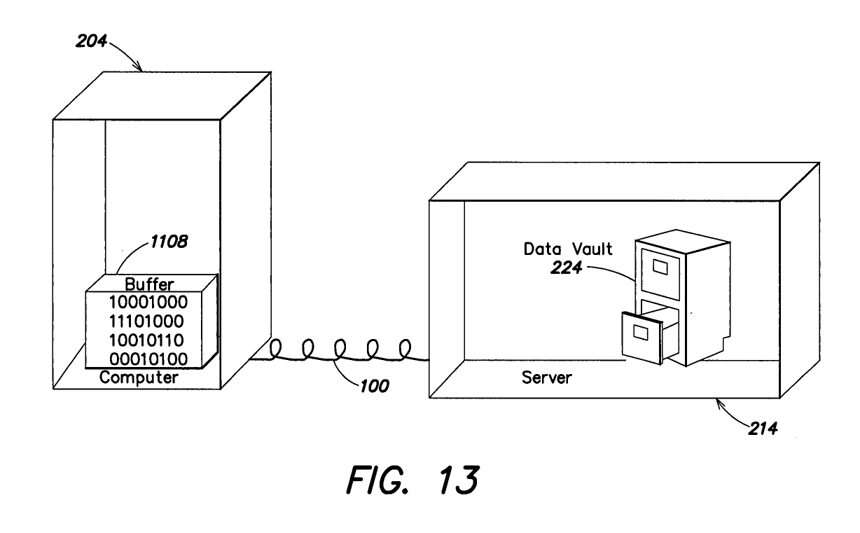

FIG. 13 demonstrates an embodiment in which data stored within a buffer 1108 resident in a computer 204 may be transmitted over a network 100 to a server 214 in which a data facility 224, such as a data vault, houses data collected from a plurality of users. The data vault may temporarily or permanently house or store data collected from one or a plurality of software agents installed throughout a system network. In order to preserve the integrity of data collected, and to defend against unauthorized observation, it may be advantageous for the data to reside within database tables of a data vault installed within a secure server. A firewall or other protective measure may isolate the secure server. In an embodiment, access to data maintained within the data vault may be restricted based on the level of authority of a particular party. The data vault may also be housed within a separate device, such as a dedicated server or offsite facility; or a backup copy of the data may be made and preserved either onsite or offsite. Reports may be selectively generated from data maintained in the data vault based upon access of the requester.

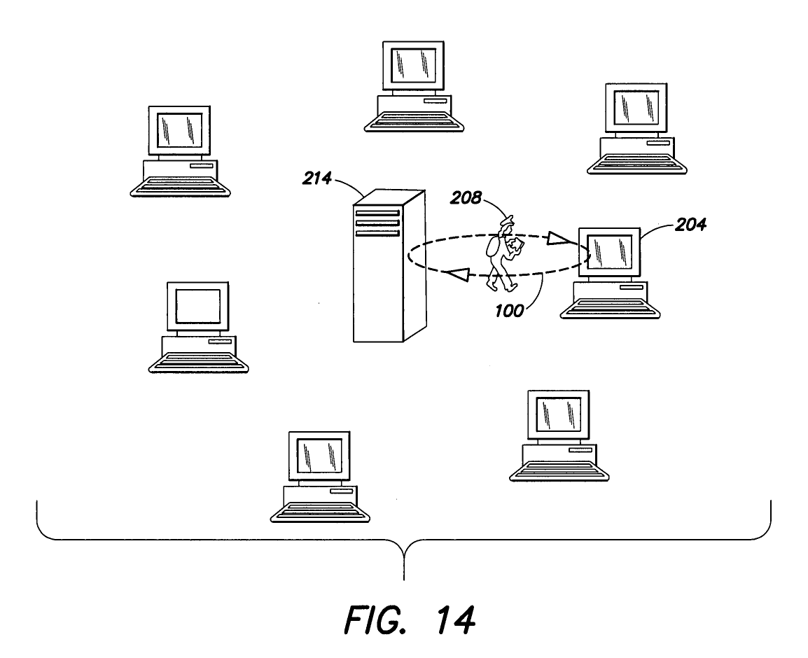

In another embodiment, as illustrated in FIG. 14, a software agent 208 resident on a network server 214 may automatically detect devices 204 or a new user on the system, and may either report such information to an authorized individual or may activate a set of processes or controls applicable to new users or devices. Software may be installed within a single network node, and may then dynamically detect additional network nodes added to the network.

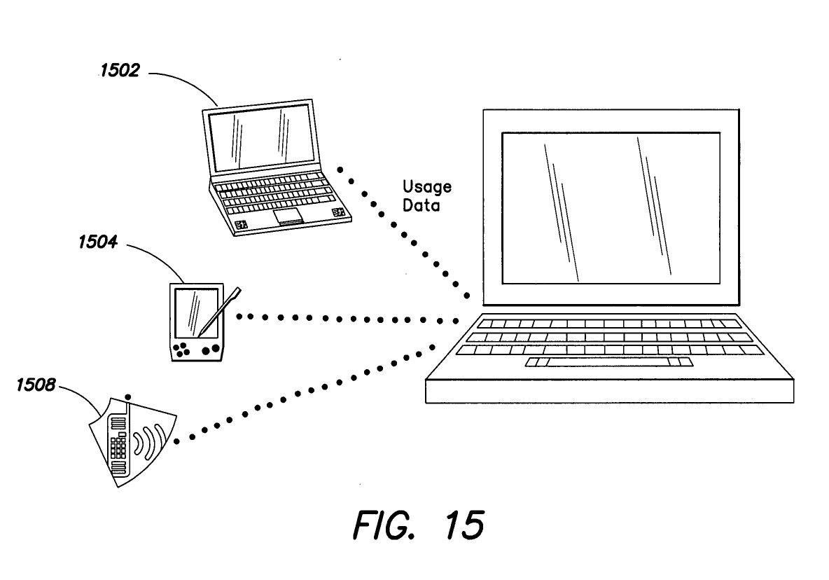

As shown in FIG. 15, in various embodiments, usage data may be collected from a variety of sources, either alone or in tandem with one or more additional devices, including a computer 1502, a computer workstation, a computer server, a direct attached storage device, a network attached storage device, a storage area network device, a dongle device (or other mechanism for ensuring that only authorized users can copy or use a specific software application), a cellular telephone 1508, an instant messenger device, an SMS device, a paging device, an electronic mail device, a wireless device, a personal organizer device 1504, or any other device. Devices through which user data is captured may utilize any operating system, such as Windows, Novell, Macintosh OS, Linux, Free BSD, Ned BSD, Open BSD, Solaris, AS400, Unix, HP-UX, IBM-AIX or any other operating system known in the art.

In an embodiment, usage data may be transmitted to an output facility through a network using a network protocol such as TCP/IP, UDP, IPX, SPX, NetBEUI, IPv6, Apple Talk or any other network protocol. Such a network may be an Ethernet facility, switched Ethernet facility, wireless facility, Token Ring facility, Arcnet facility, the Internet, an Intranet, or an alternative facility. The network topology may be a ring topology, mesh topology, star topology, bus topology, tree topology, or any other configuration. A user device may have a network addressed that is fixed, or leased, purchased or otherwise acquired through DHCP or other available means. The network, and any device resident on the network, may be protected by a firewall or other security apparatus.

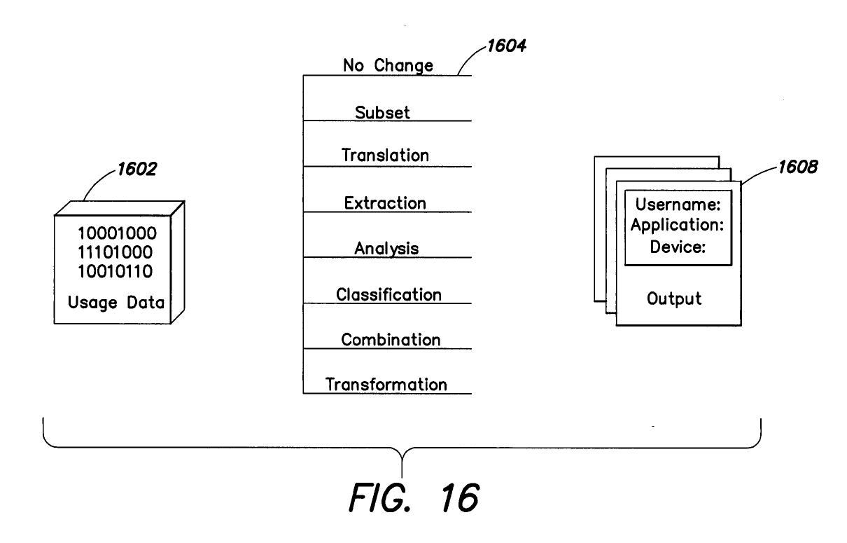

As shown in FIG. 16, in an embodiment, usage data 1602 collected may be processed at a processing step 1604 in a variety of ways. The output 1608 generated from any such processing routine may be identical to the data, or it may be a subset of the data. Processing may also include hashing, translation, extraction, analysis, classification, combination, transformation, transmogrification, application of artificial intelligence techniques, or any other operation or set of operations, whether related or discrete, including implementation of analytic or informatic processing.

Continuing with the aforementioned embodiment, data may be reduced and process to yield results relevant to a specified inquiry. For example, a system administrator may be interested in determining the incidence of failed login attempts. Data unrelated to that inquiry may be disposed of, segregated, or stored in a native or remote facility.

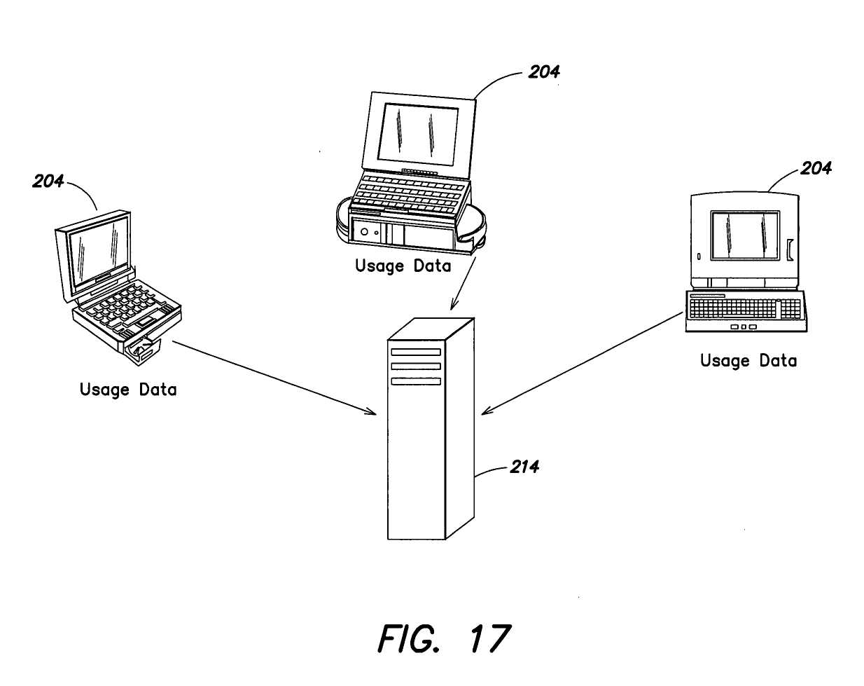

FIG. 17 depicts the collection of usage data from a plurality of users operating on independent computers 204, all of which are connected to a remote server 214 through a network. Accordingly, data analysis may reflect a compilation of data from users and devices throughout a network, and relevant statistics may be compiled. A report may be generated indicating the percentage of computers being used at times of peak activity; the number of computers on which a specific licensed application is being executed, for licensing or leasing restriction compliance initiatives; the number of devices used relative to the number of users logging in; the distribution of application usage throughout a network; and any other information to provide visibility into usage behavior or patterns in the aggregate.

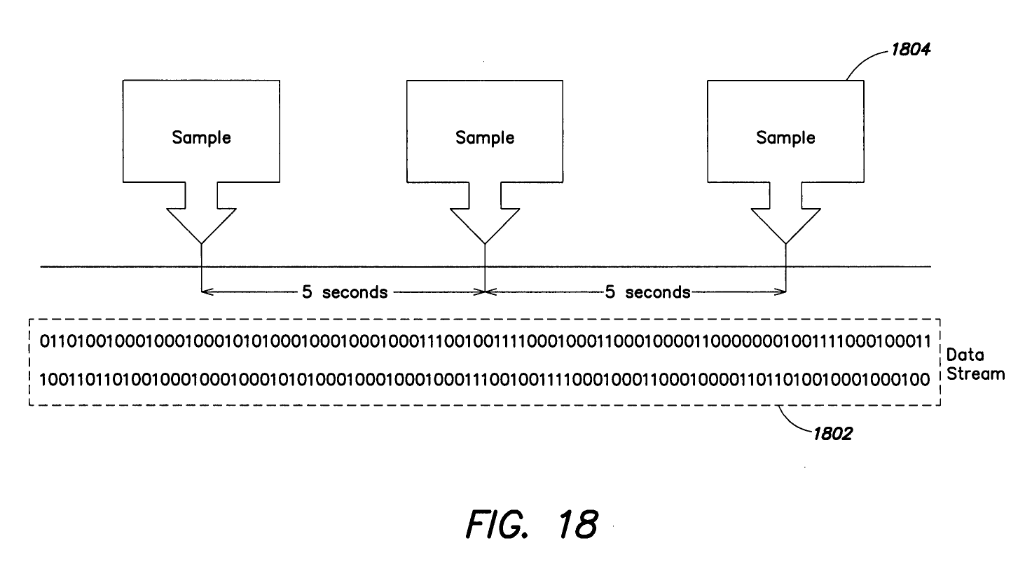

One problem with existing facilities for monitoring computer use, such as event logs that catalog all events that take place on a network, is that the stream of data is very large and includes far more data than is possible for a human user to analyze and understand within a reasonable time frame. Accordingly, an advantage of the present invention is that it facilitates the collection of a relevant set of data, rather than all data, and it permits the convenient aggregation of data for reporting in formats that are easy to use. FIG. 18 illustrates an embodiment in which data processing consists of sampling 1804 of a stream of usage data 1802 after designated time intervals, such as five seconds or any other time interval. In embodiments, the intervals may be fixed or variable. In embodiments, intervals may commence (or be varied) only upon predetermined user events (such as initiating a particular application). In embodiments the system only collects data when the user is using a computer. Intervals may also be randomly generated. Sampling may occur for a specified duration, which may also be fixed, variable, or random. Duration may also be tempered by exogenous variables, such as detection of possible policy or security events. For example, if a security or policy event occurs, as recognized by the agent 208 or the rule engine 222 of the server 214, then the sampling frequency can be increased for the user or machine by which the event occurred, to capture more data with respect to that user and machine. Duration of sampling, and intervals between samples, may also be adjustable based on user, device, suspected activity, or hardware or software constraints such as available memory, network traffic level, and the like.

Usage data may be processed in a manner designed to detect a specific security or policy event. Security events may include a system file change, creation of a system directory creation, application installation or setup, addition of a new user to a system, inactive user(s), a file download, operating system event log status, agent status, backdoor activity, known exploit port activity, addition of a new computer to a system, detection of a new device added to a computer, inactive computer(s), packet sniffing, modem usage/network properties, a virus, trojan horse, worm, denial of service attack or other malicious code, administrative/root logon, or copying or access to of specified file. Policy events may include use of an inappropriate program, use of a program at an inappropriate time, use of a windows registry/policy editor program, status of the enterprise logon and logoff policy, detection of unregistered user(s) from the logon server, detection of inappropriate content, attributes of Internet time usage policy, concurrent application licensing status, or software installation.

Output generated from an embodiment of the system may also identify the location from which a computer or other usage device is accessed, provide information regarding methods and rates of signal transmission, or access to the output itself. For example, reports may be generated or alerts may be triggered in response to unauthorized access, packet sniffing, disablement of functionality, identification of a user seeking access, identification of device from which access is sought, identification of usage data or output accessed, time of access, manner of access, manner in which usage data or output is utilized, frequency of access, duration of access, indication of tampering with usage data or output, indication of modification of usage data or output, indication of interference with usage data or output, indication of deletion of usage data or output, or attempts with respect to any of the foregoing. Output may also provide useful information regarding status of a device, such as inactivity or non-use, or proper or improper function of the device or any component thereof. Output could also detail measurement of temperature, efficiency, position, speed, acceleration, motion, shock, inactivity, disablement, time, or any other parameters.

The output may be used for a variety of purposes, such as to monitor productivity, performance, or behavior of a user, to gauge or enforce compliance with a policy, procedure, law, rule, restriction or regulation, or to ensure compliance with a software licensing restriction or equipment leasing restriction.

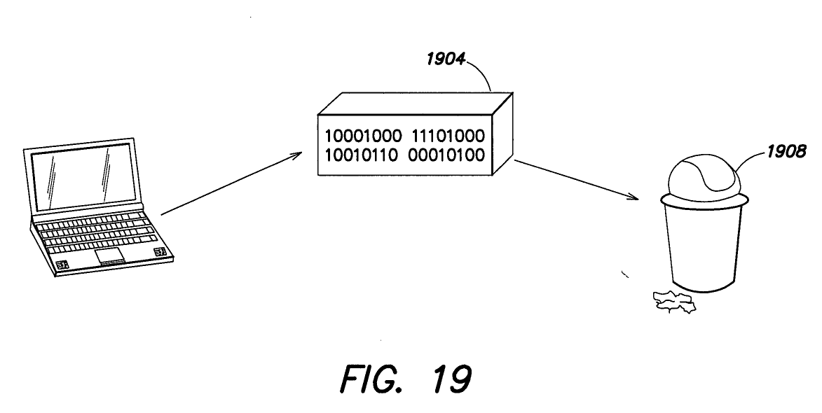

In embodiments, as depicted in FIG. 19, usage data, or output generated from processing usage data 1904, may be retained for a specified period of time, automatically disposed of 1908 after a specified period of time, or automatically disposed of after a specified quantity of data is collected or other limits are exceeded. Usage data, or output generated from processing usage data, may also be classified to facilitate selective disposal. For example, data relating to a defined policy or security event may be selectively retained. Use of fuzzy logic or other methods of artificial intelligence may be applied to retain data that is or may be relevant, and the applicable rules may evolve based on user feedback.

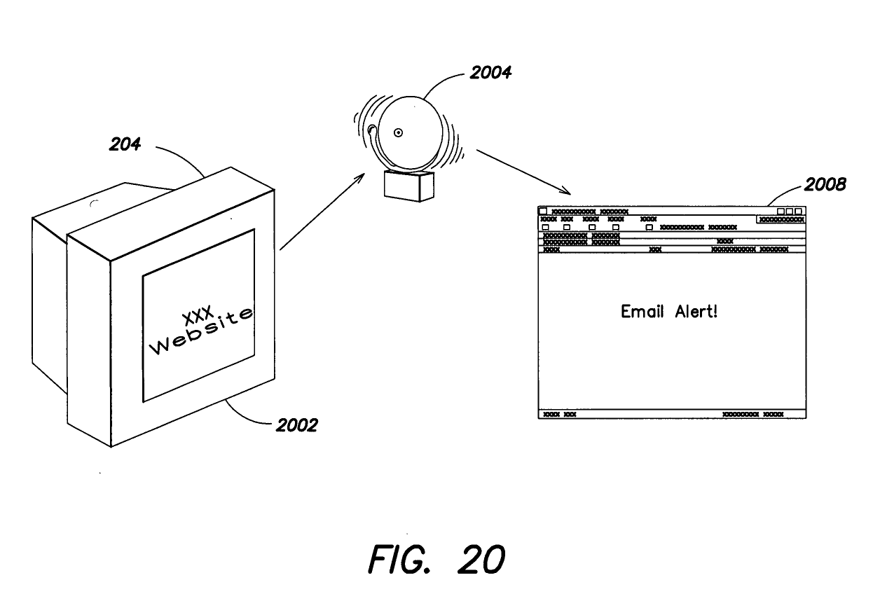

As illustrated in FIG. 20, in embodiments, if a user accesses prohibited content, such as images or text in an X-rated website 2002 may trigger an alert 2004 and produce an email message 2008 transmitted to a manager, system administrator, third party, or any other signal transmitted to a pager, telephone, SMS device or otherwise.

In embodiments, output may be conducted through a secured connection facility, such as a secured web browser application, that provides access to a web server. Output may alternatively be conducted through a dedicated client facility or through other means known in the art. Output may be automatically supplied or volitionally initiated, and the degree of access to output may vary based on permissions previously granted. Permissions may be enforced through one or a plurality of passwords or other means of secure identification, such as voice recognition or any other biometric recognition facility. Permissions may also be applied through restricted network access, restricted computer or other device access, or through other means of restricted access known in the art.

A recipient may obtain access in real time, in substantially real time (that is, after a short delay), periodically, or when, if and as requested. Access may also be provided for a limited period of time, to facilitate an audit or enforcement, or in accordance with record retention controls. Access may also be provided through software or another facility designed to selectively route information to designated servers, computers, workstations or devices. Other methods may be used to segregate and route information, such as email, Internet access, intranet access, SMS, instant messaging, telephonic communication, and similar means. In an embodiment, either a single layer of omnipotent access may be devised, or a plurality of discrete levels, applicable senior management, department management, Human Resources, and Help-Desk personnel, etcetera, may be defined. Discrete levels may entail access to different types of information, or it may comprehend access to subsets of data available to others. Any Venn configuration with respect to a data set is conceivable. Access levels (including the number of levels, the degree of access attributed to each, and the combination of features available for inspection) may be defined, selected and revised.

For example, in a business environment, an administrator may have a reduced level of access relative to a manager or human resources personnel or members of an in-house legal group may have an enhanced degree of access. Within a non-commercial environment, such as a non-profit organization, government (including municipal) entity, or school, an administrator may generally have a reduced level of access relative to an individual with more senior status. In any such cases, access may be selectively provided to individuals with greater authority or seniority within an organization.

Increased access may also be granted to facilitate an auditing function, forensic analysis, troubleshooting of devices such as malfunctioning computers on a network, troubleshooting of applications or assistance with use of applications, or to facilitate portability of data or events from one format to another.

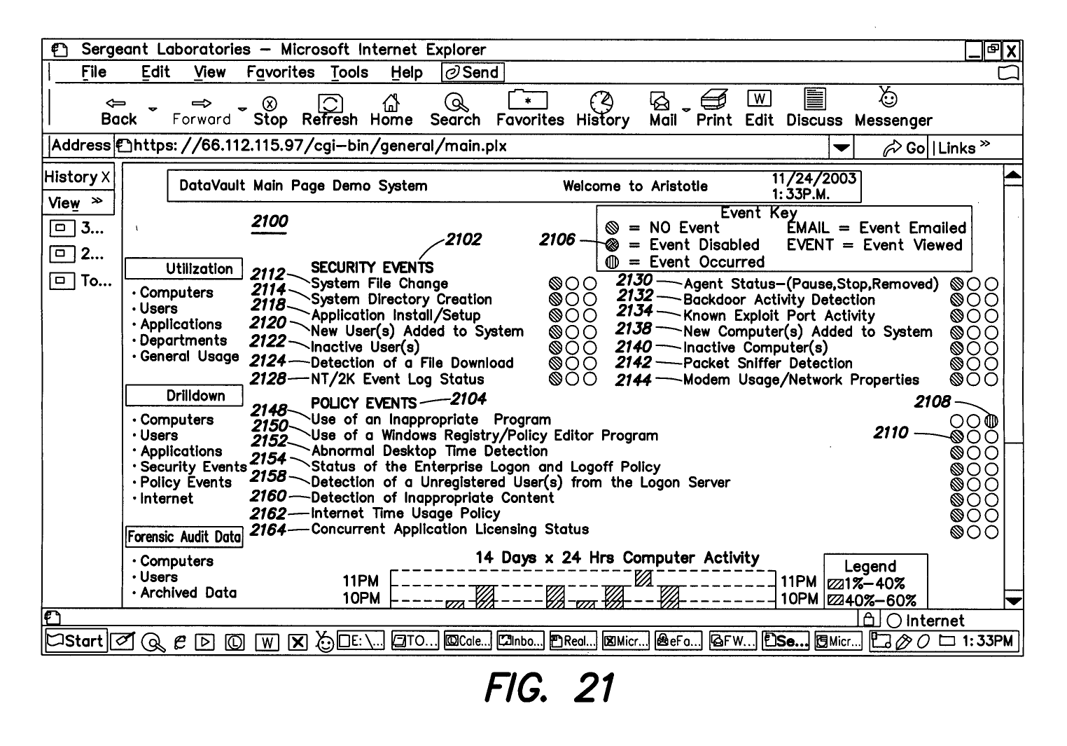

Reports or selective views of output may be generated and categorized. For example, as depicted in the graphical user interface 2100 shown FIG. 21, security events 2102 and policy events 2104 may be monitored and displayed for occurrence (“Event Occurred”) 2108, non-occurrence (“NO Event”) 2110, or event disablement (“Event Disabled”) 2106. A report may also indicate whether notation of the event has been viewed or emailed 2106. Color coding in the graphical user interface 2100 can help the viewer, such as a manager 102, quickly assess what security events may have occurred, so that attention can be paid to those events, rather than paying attention to a host of data that does not reflect any problem. A wide range of security events 2102 and policy events 2104 can be displayed for a manager 102 to review. For example, among security events 2102, the system may detect a system file change 2112, creation of a system director 2114, installation or setup of an application 2118, addition of a new user 2120, presence of an inactive user on the network 2122, detection of the downloading of a file 2124, status of an event log 2128, change in the status of the agent 2130, detection of backdoor activity 2132, detection of known exploit port activity 2134, adding a new computer to the system 2138, presence of an inactive computer on the system 2140, packet sniffer detection 2142, or modem usage or network properties 2144. Various policy events 2104 can also be detected, such as use of an inappropriate program 2148, use of a windows editor or policy editor program 2150, detection of abnormal desktop time 2152, detection of the status of the enterprise logon or logoff policies 2154, detection of unregistered users from the logon server 2158, detection of inappropriate content 2160, violation of Internet time usage policies 2162, or violation of concurrent licensing usage policies 2164. Each of the security events listed above can be reflected with a status indicator in a graphical user interface, such as to show that an event occurred 2108, such as by displaying a red circle or similar symbol next to a listing of the security event in the graphical user interface. If no security event 2102 or policy event 2104 has occurred of a given type, then a green symbol 2110 or similar symbol can indicate that no such event occurred. A different symbol can indicate that detection of a particular type of event has been disabled.

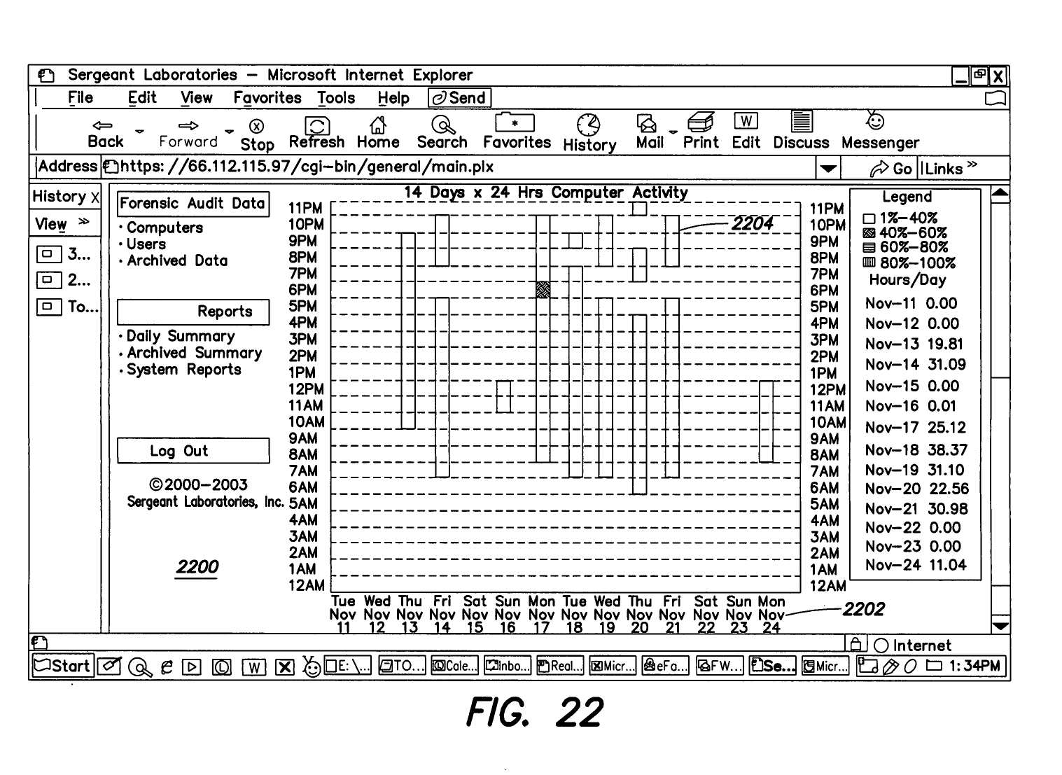

FIG. 22 includes an embodiment of a graphical user interface 2200 depicting computer activity levels over a designated period. Computer usage activity 2204 may be viewed in a histograph with respect to a specified computer, such as, for example, during the twenty-four hour periods from November 11^{th} through November 24^{th} or another date range 2202.

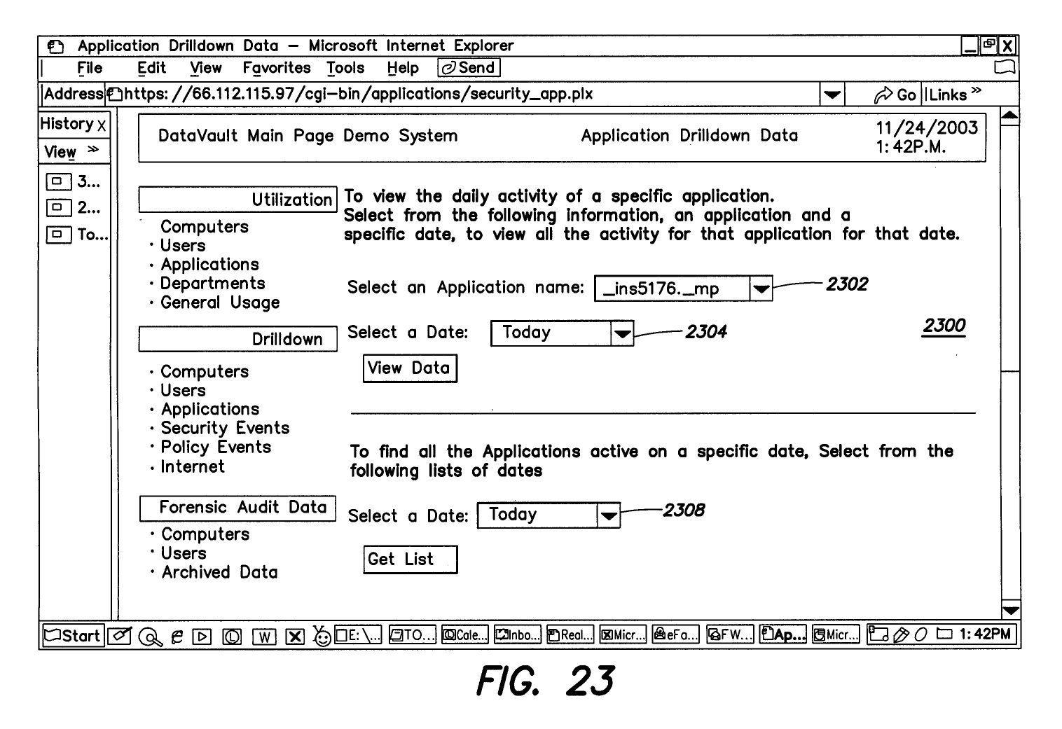

FIG. 23 includes a graphical user interface 2300 that allows a viewer, such as a manager 102, to drill down and obtain more data about usage of a particular application. In the user interface 2300, the manager 102 can, for example, select an application using a menu 2302 and choose a date using a menu 2304. Alternatively, all applications active on a selected date 2306 may be displayed by the viewer. Thus, the user interface 2300 allows the viewer to determine application usage according to time periods.

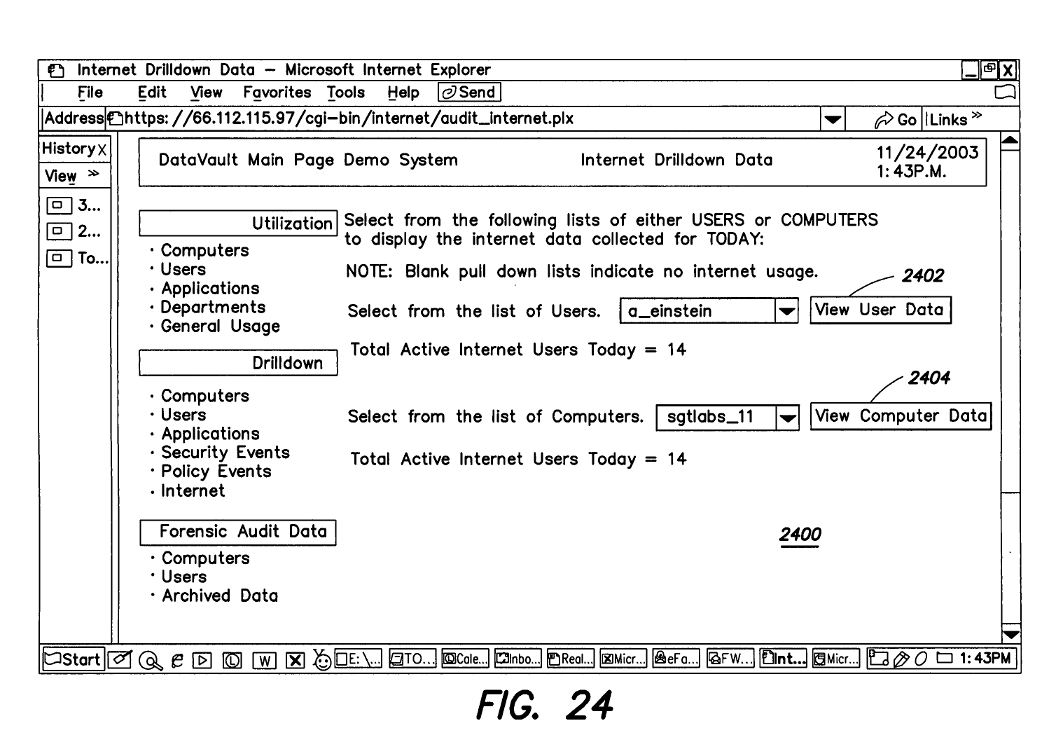

FIG. 24 shows an embodiment of a graphical user interface 2400 wherein a viewer can request a report from a data facility 224, such as a report on events related to a particular user by selecting a user from a menu 2402 or a report on events related to a particular networked computer, such as by selecting a computer with the menu 2404. Data aggregated with respect to such user or computer may then be displayed.

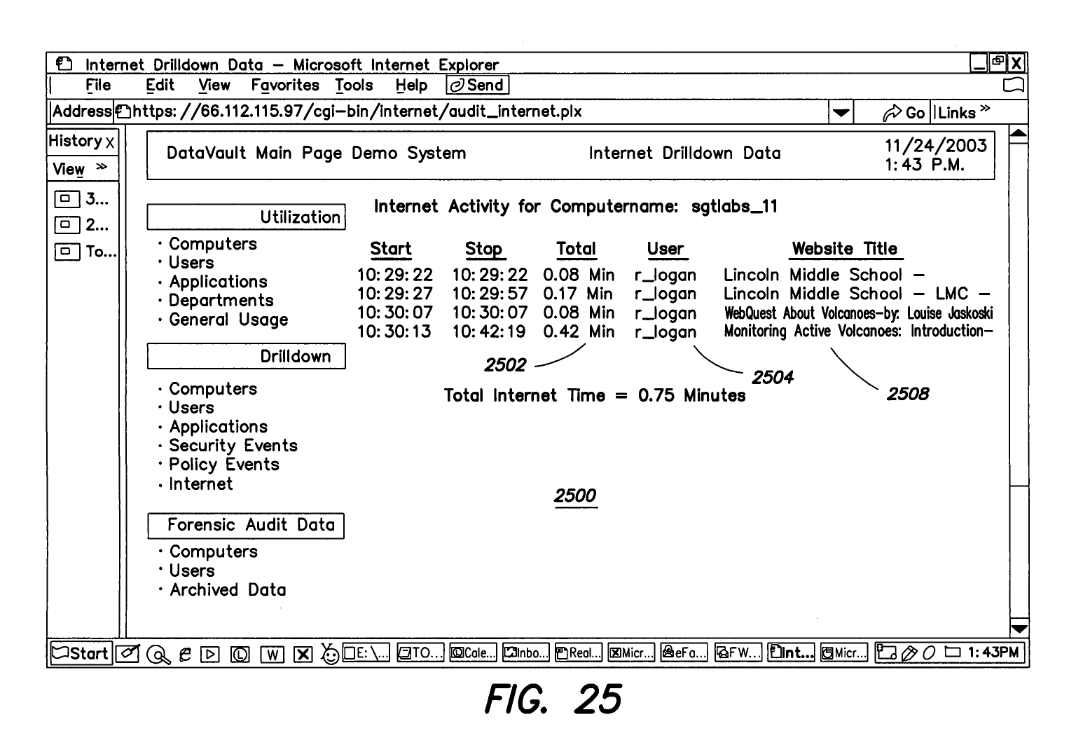

FIG. 25 depicts a graphical user interface 2500 that appears when a viewer selects a particular user in the menu 2402 of FIG. 24. The interface 2500 shows temporal information 2502 with respect to specific Internet websites 2508 accessed by a designated user 2504. Thus, a manager can determine what Internet sites a user is using at what times.

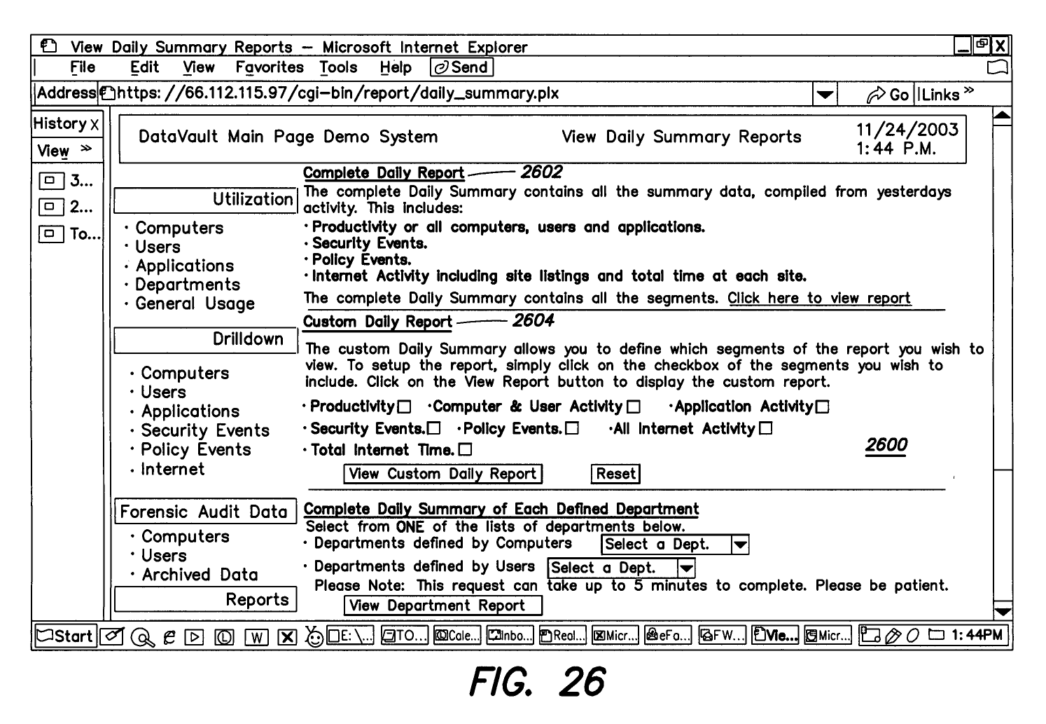

FIG. 26 shows a graphical user interface 2600 in which various reports and summaries may be selected by a viewer. For example, a complete daily report 2602 may be selected, providing a report of productivity of all computers, users and applications; security events; policy events; and Internet activity including site listings and duration of time at each site. A custom daily report 2604 may also be generated, which may include, for example, any, or any combination, of the following: productivity, computer and user activity, application activity, security events, policy events, all Internet activity, and total Internet time.

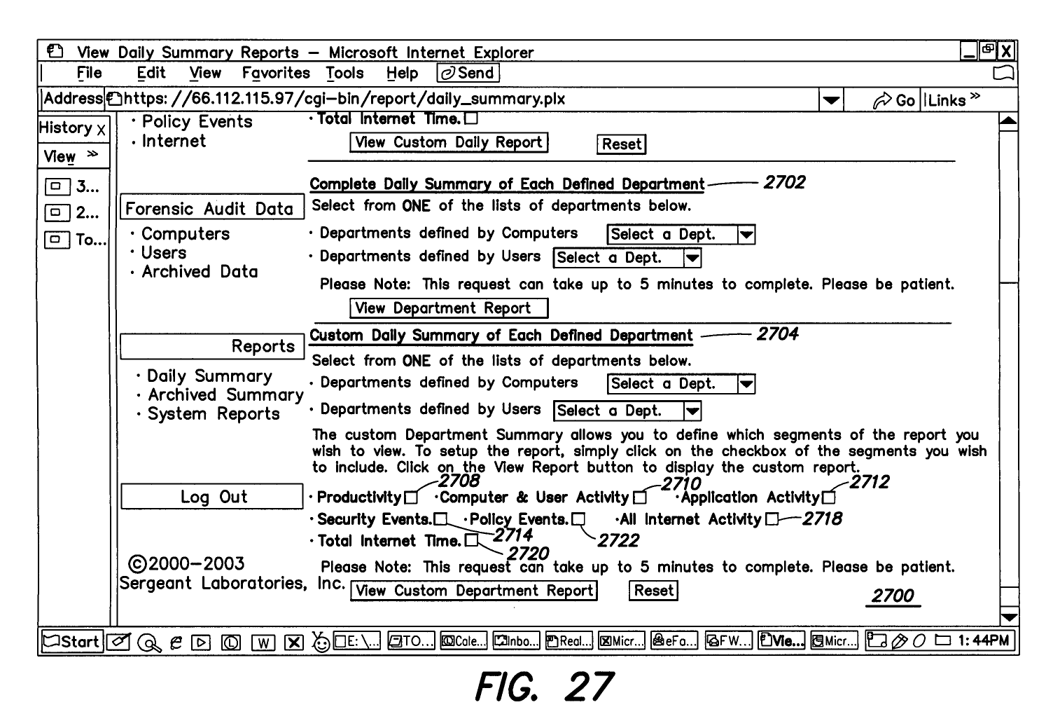

As illustrated by FIG. 27, using a graphical user interface 2700, in embodiments reports may also be tailored for a specified department 2702, wherein departments may be defined either by computers or users therein. A custom daily report 2704 for a defined department may be generated, which may include, for example, any, or any combination, of the following data items: productivity, computer and user activity, application activity, security events, policy events, all Internet activity, and total Internet time, in each case by selecting an appropriate checkbox, such as a field in an HTML form presented to the user in the graphical user interface 2700. For example, a user can select a checkbox 2708 to view productivity. To view computer or user activity, the user can select a checkbox 2710. To view application activity, the user can select a checkbox 2712. To view security events, the user can use a checkbox 2714. To view policy events, the user can use a checkbox 2722. To view all Internet activity, the user can select a checkbox 2718. To view total Internet time, the user can use a checkbox 2720. Thus, through a simple user interface, such as a web interface, a user such as a manager or administrator can develop a customized report that allows the user to selectively view policy events, security events and productivity events that are associated with computer usage by employees or others that are using computers connected to a network. Such custom reporting is facilitated by the organization of event data that is collected in accordance with the principles described herein, such as organization of keyboard and mouse events by user, by application, by computer, and by time.

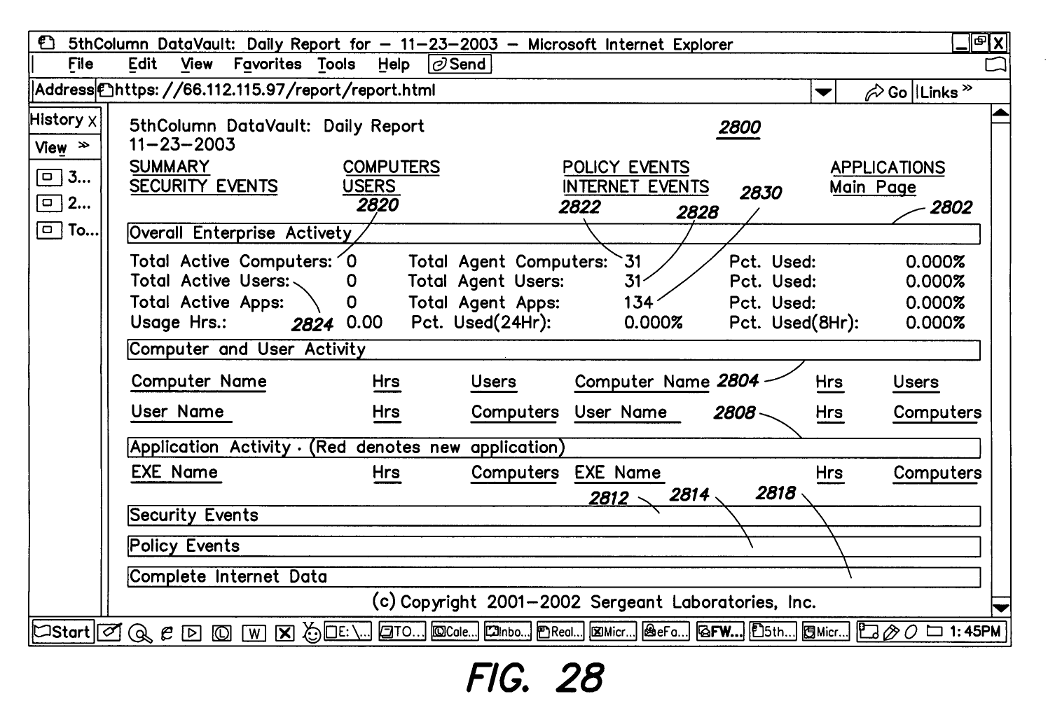

FIG. 28 depicts a graphical user interface 2800 with an embodiment of a daily report, which might be a standard daily report for a manager in an enterprise (such as a business, government entity, school, hospital, non-profit institution or other enterprise), or might be a custom daily report for a manager who has selected the particular items summarized on FIG. 28 using the checkbox interface 2700 described in connection with FIG. 27. The report could be a daily report, as indicated in FIG. 28, or it could be a report for some other desired unit of time, such as hourly, weekly, monthly, quarterly, semi-annually, annually, or other desired time period. The daily report in the interface 2800 conveniently summarizes security events, policy events and application activity, based on overall enterprise activity 2802, computer and user activity 2804, application activity, including new applications 2808, security events 2812, policy events 2814 and Internet usage data 2818. For example, a field for showing enterprise activity 2802 shows the number of total active computers for the day 2820, as well as computers on which the agent is running at a field 2822. The field 2802 for enterprise activity can also show active users 2824 and users for which the agent is active 2828. The field for enterprise activity can show applications for which the agent is active 2830. Thus, the field 2802 provides the manager with a very convenient summary of computer, user and application activity for the enterprise.

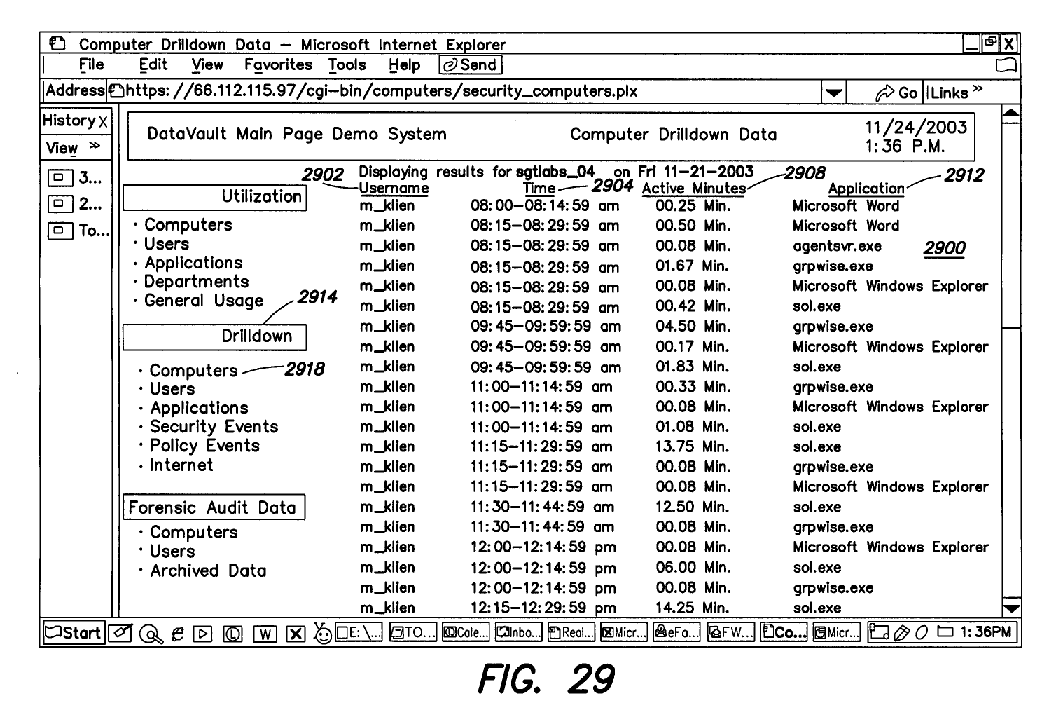

FIG. 29 illustrates an embodiment of a graphical user interface 2900 providing drilldown data on activity associated with a selected computer, such as would appear if a manager elected to see a report on that particular computer, such as by using the drilldown navigation bar 2914 and selected the computer link 2918 in the interface 2900. The drill down report in the interface 2900 shows the username 2902 of the user who is using the computer, the time of initiation of a particular computer application 2904, the duration of application usage 2908 and the identity of the application 2912. With this report, a manager could see, for example, if a user was using a given application, such as Internet Explorer, for a longer duration than expected. Because the methods and systems disclosed herein allow the capture of usage events (such as keystrokes and mouse movements), rather than just the fact that an application is running, the report can show the applications with which the user is actually interacting. Thus, a report can distinguish between a user who has Internet Explorer open for most of the day, but is working on other items, and a user who is actively using the Internet for much of the day.

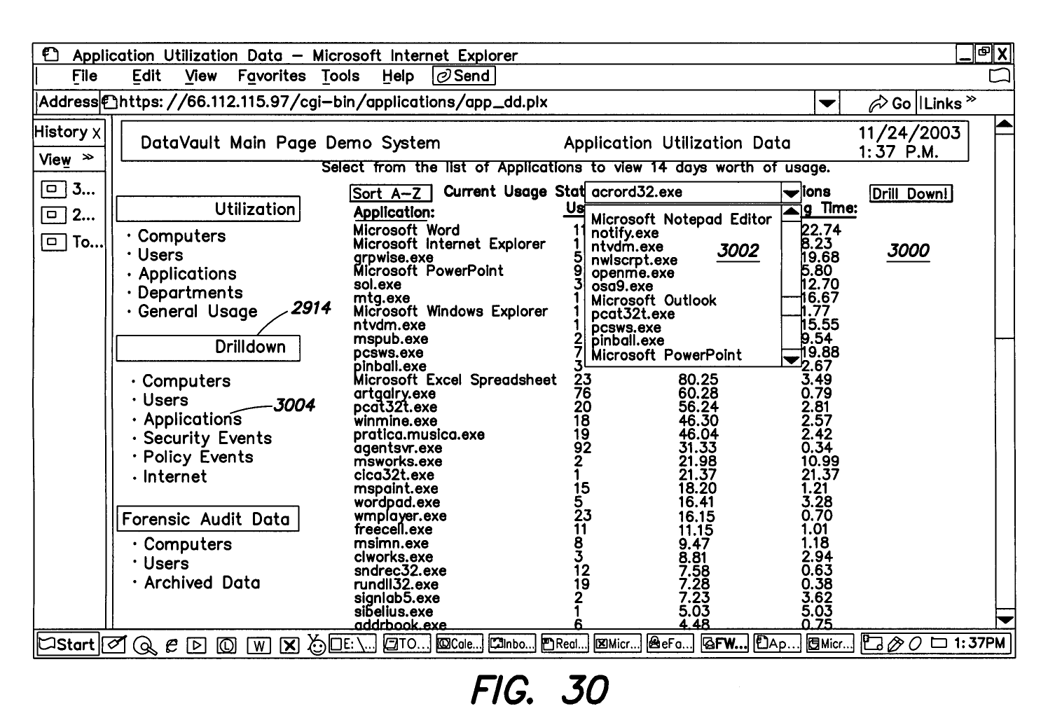

FIG. 30 shows an embodiment of a graphical user interface 3000 that presents application utilization data. The interface 3000 may appear if the user elects to drill down using the drill down navigation bar 2914 and selects the application link 3004. In the embodiment of FIG. 30, 14 days of activity may be viewed for a particular application, such as an application selected with a menu 3002. In embodiments the duration and timing of the activity shown could vary from a number of minutes to, for example, an entire year. The interface can show the number of users and the total usage time for the application. Among other things, the report facilitates managing compliance with policies, such as Internet usage policies and concurrent licensing policies, that relate to total usage of a given application across a group of users.

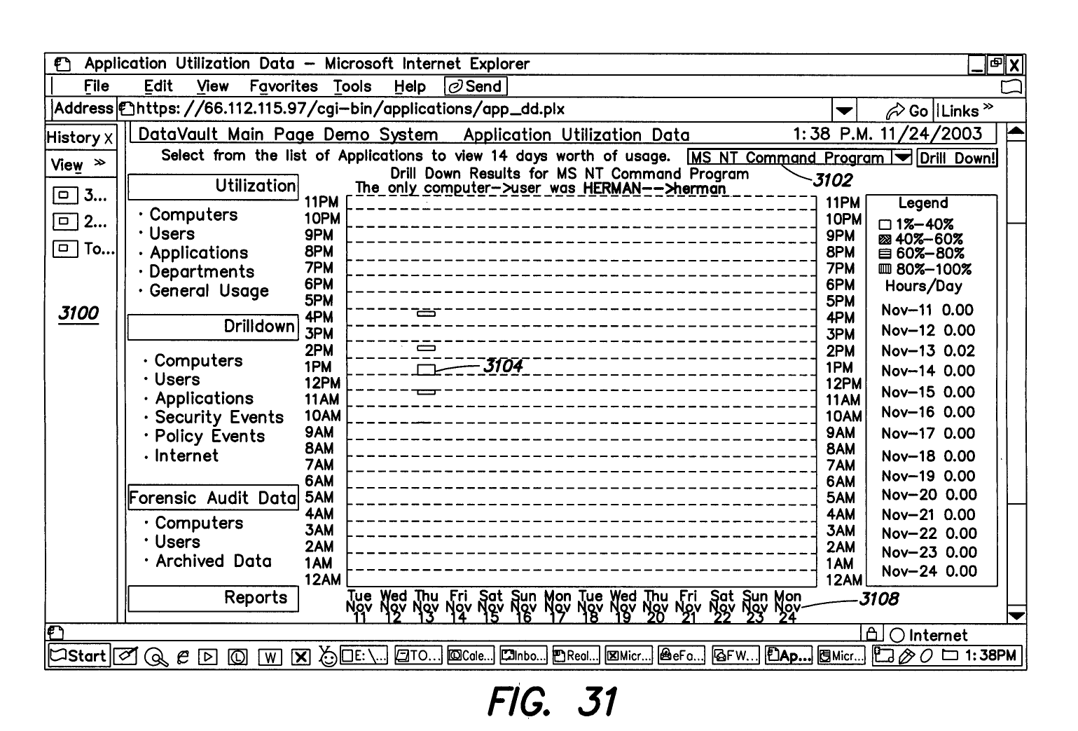

FIG. 31 is a graphical user interface 3100 providing usage information 3104 regarding a selected application 3102 (such as one selected using the menu 3002 of FIG. 30) for the duration specified 3108. The user interface displays a histogram that shows the time period of use of the application, in this case a single user.

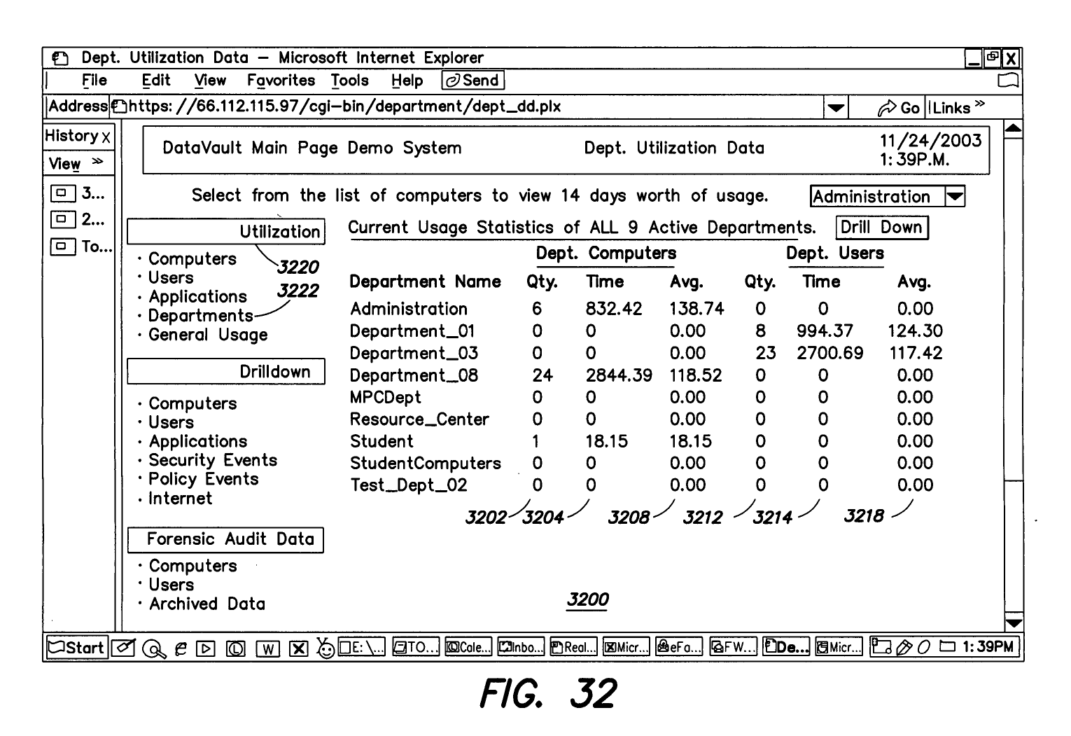

FIG. 32 shows an embodiment of a graphical user interface 3200, including a breakdown by department of computer utilization, such as one that could appear if the user selected the utilization navigation bar 3220 on one of the various user interfaces described herein and then selected the departments link 3222. The utilization data shows a number of fields, including number of computer units in each department 3202, amount of time during which such computers were used 3204, average usage per machine 3208, number of users in each department 3212, amount of time during which such users were active 3214, and average usage per user 3218. With such an interface 3200, a high-level administrator or manager can quickly assess the extent to which computers are being used by various departments, such as to assist in various management decisions. For example, the manager could forecast what departments are likely to require new computer resources soon, determine how to allocate bandwidth, such as server and database access, among departments (including by hour of the day), and determine whether computer resources are efficiently deployed across the enterprise.

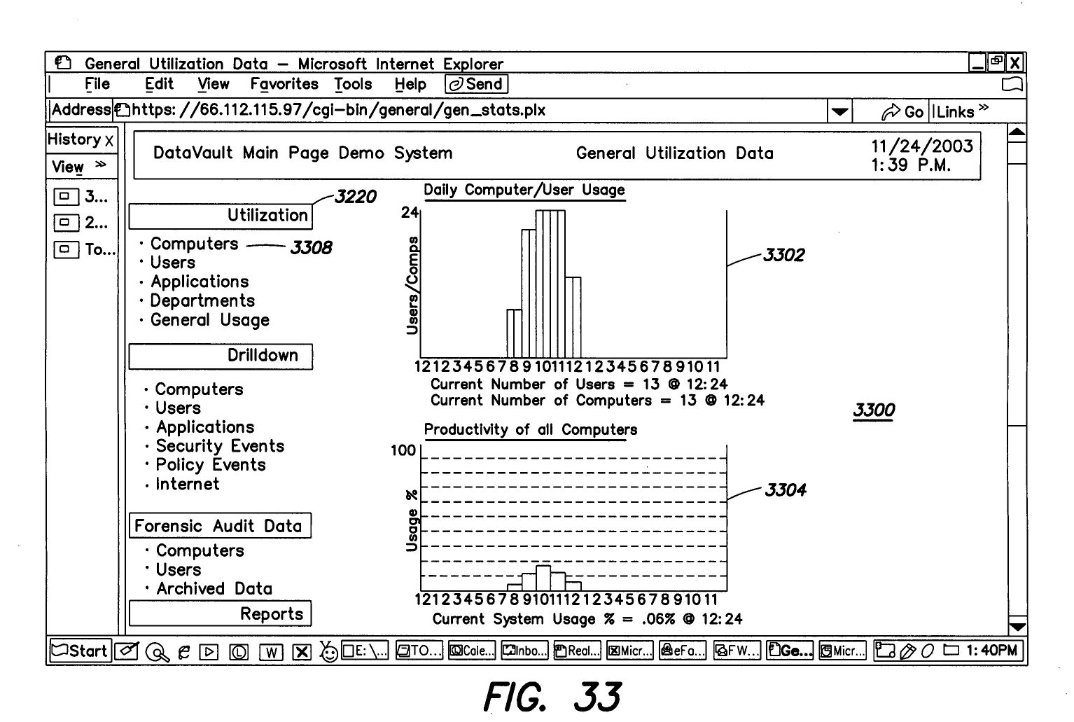

Referring to FIG. 33, if a user of the methods and systems disclosed herein selects computers link 3308 under the utilization navigation bar 3220 in one of the various graphical interfaces described herein, the user can be presented with a graphical user interface 3300 illustrating a histogram 3302 of daily computer and user usage, as well as a histogram 3304 showing aggregate productivity across all computers within a network by percentage of usage of available time. The daily computer and user usage histogram 3302 provides a very convenient mechanism for determining what users/computers are most active within an enterprise. The aggregate usage histogram 3304 provides a manager with a very good assessment of the extent to which specific resources are used to the greatest extent possible within the enterprise.

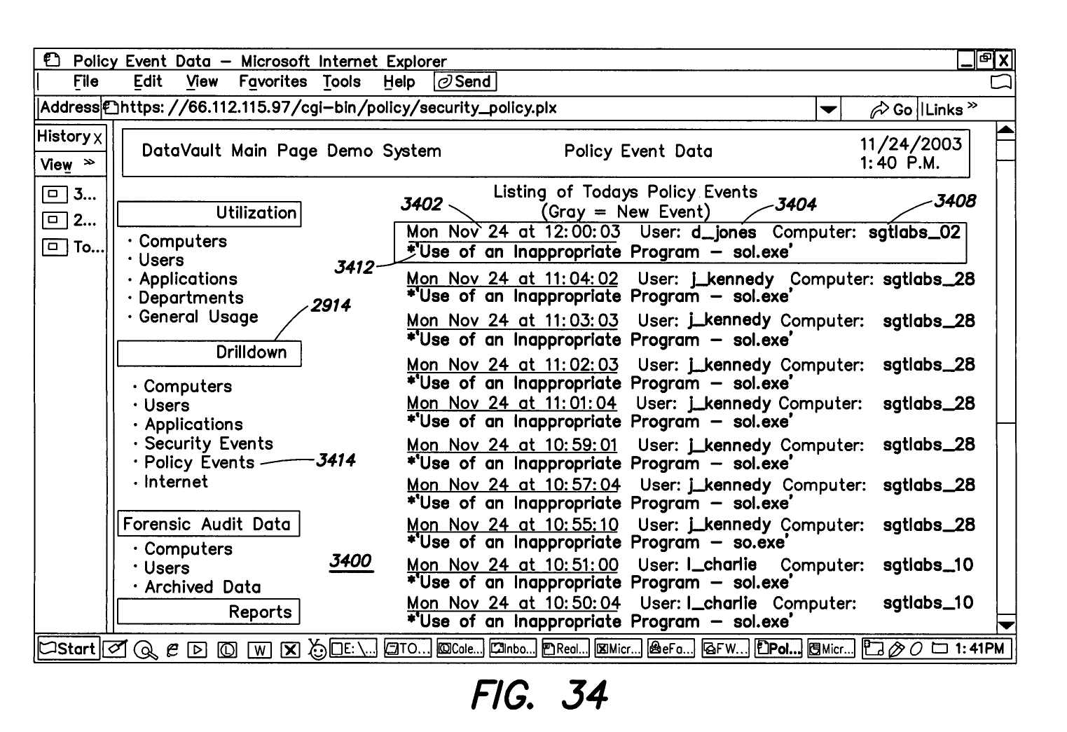

Referring to FIG. 34, if a user selects the policy events link 3414 under the drilldown navigation bar 2914 in a user interface of the methods and systems described herein, then a user interface 3400 can appear, which lists daily policy events detected, indicating date and time 3402, identity of user 3404, identity of computer 3408, and security event 3412. As described herein, the policy events may be any events defined by the enterprise, such as events that relate to use of prohibited applications, access to prohibited content on Internet sites, attempts to access applications without appropriate security, excessive use of permitted applications, misuse of applications, or any others defined by the enterprise.

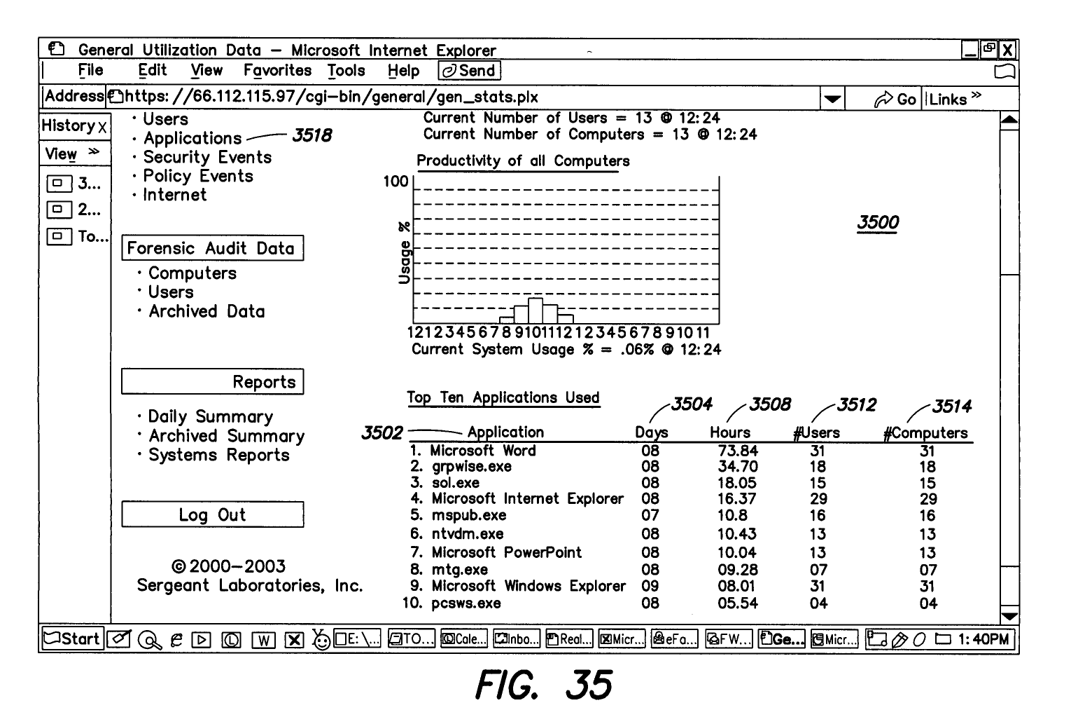

Referring to FIG. 35, if a user selects an applications link 3518, such as under the drilldown navigation bar 2914 depicted in connection with FIG. 29 and other subsequent figures, then the user can be presented with drilldown information about the usage of particular applications. For example, a user interface 3500 can list data regarding the top ten applications used within a specified period, including identity of each application 3502, the number of days in a selected period during which each application was used 3504, aggregate time during which each application was used 3508, total number of users executing each application during the period 3512, and total number of computers on which each application was executed or accessed 3514. As with other reports described herein, this report offers a manager or administrator of an enterprise a very convenient and effective view of the enterprise's computer application usage, to facilitate rapid, accurate decision-making. For example, an administrator can instantly determine whether the enterprise is approaching a concurrent-user limit for an application, so that additional licenses can be purchased before the company is in breach of a contract. A manager can decide what applications should be upgraded to newer, more efficient versions, based on what applications are most heavily used. An information technology manager can determine what package of applications should be deployed as a standard package for the entire enterprise, what applications should be deployed as packages for specific departments, and what applications should be deployed only on an ad hoc basis. Again, the collection and binning of usage information (including not only whether an application is running, but also whether a user is actually interacting with it), and the organization and reporting of that usage information according to user, computer and application, allows a manager to make effective decisions that depend on such information, without requiring administrators to pore over and aggregate event logs that capture all network events.

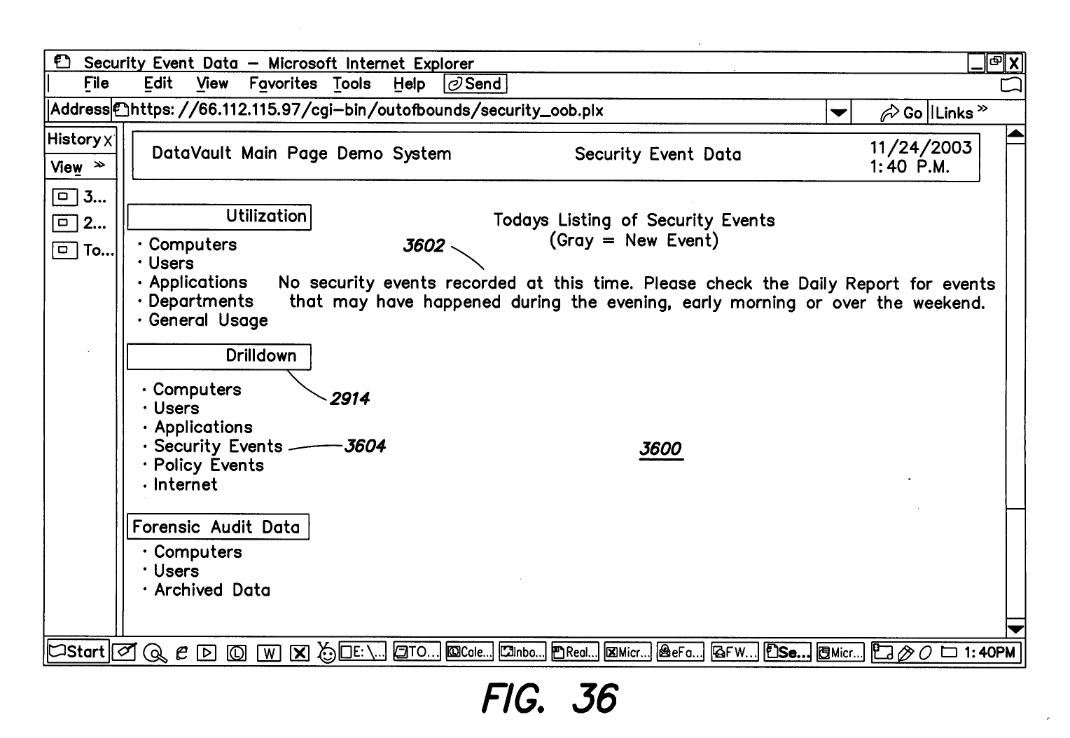

Referring to FIG. 36, by selecting the security events link 3604 under the drilldown navigation bar 2914, a user can initiate a user interface 3600 to view security events that have taken place during a selected period, such as daily, weekly, monthly, quarterly or annually. The security events 3602 can include any of a wide range of security events, such as improper application usage, access to prohibited Internet sites, typing of certain words that are on a prohibited word list, attempts to access prohibited data, or the like.

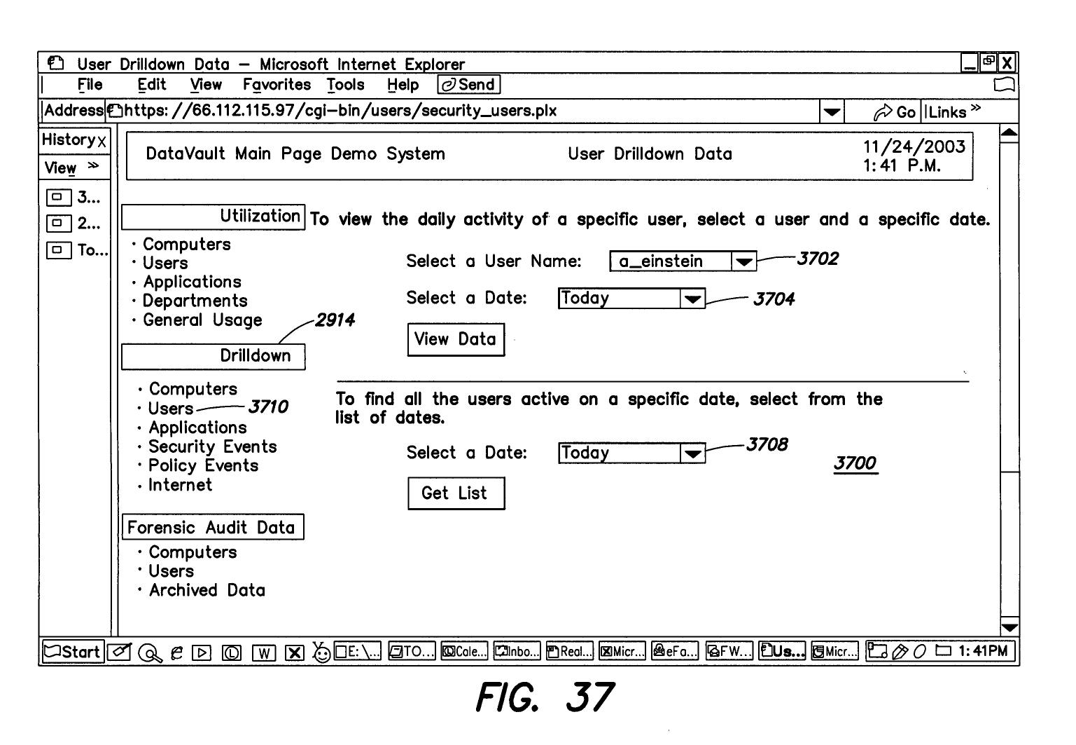

Referring to FIG. 37, if a user selects the users link 3710 under the drilldown navigation bar 2914, then the user can be presented with a user interface 3700 for viewing options with respect to user data, including views by user 3702 and date 3704, and all users active on a specified date 3708.

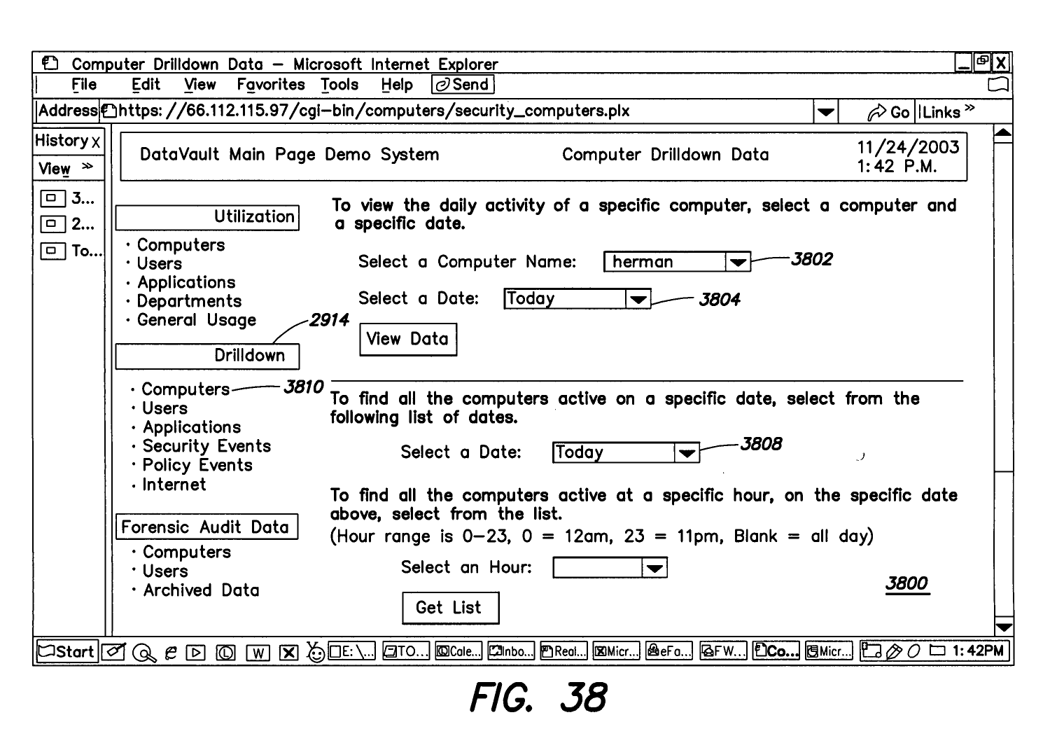

Referring to FIG. 38, if the user selects the computers link 3810 under the drilldown navigation bar 2914, then the user can be presented with a graphical user interface 3800 for displaying detailed information regarding computer usage. In the representative embodiment of the graphical user interface 3800, a viewer sees options with respect to computer data, including views by computer 3802 and date 3804, and all computers active on a specified date 3808. Again, rather than requiring a human administrator to pore over event logs to sort out usage by a particular computer, the methods and systems described herein allow the user to determine usage by computer of applications, such as applications relevant to policy and security events.

In general, in embodiments of the methods and systems described herein, application views may provide information, including that regarding frequency of access, duration of time accessed, time accessed, manner of access, manner of use, identity of the user gaining access, or identity of the machine accessed. In other embodiments, device views may provide information, including that regarding frequency of access, duration of time accessed, time accessed, manner of access, manner of use, identity of applications executed thereon, or identity of user gaining access. In further embodiments, user views may provide information regarding frequency of access to an application or device, duration of time accessed, time accessed, manner of access, or manner of use.

In embodiments, one or a plurality of reports may be generated, which may be customized. Reports may reflect the results of data mining operations, and may be searchable. Information may be presented either in comprehensive or summarized fashion, and may include statistical information, temporal information, and frequency information. Reports may indicate levels of activity or productivity, and may exclude, segregate or filter incidence of low frequency if desired. Reports may relate to a specified period of time, such as a day, week, month, fiscal quarter, calendar quarter, fiscal year, calendar year, or customized duration. Reports may suggest or identify trends or patterns, and may be used to predict future behavior and propensities.

In additional embodiments, information presented in a report may be aggregated across multiple users, devices or applications. Information in a report may also reflect selective application of rules to classes of users, devices, or application, and may be analyzed, processed, compiled, or organized. Data in a report may also be de-identified to preserve anonymity of users. In an embodiment, the system may also be used to selectively de-identify data so that personal information is accessible to only those users of suitable authority or for a particular purpose.

In further embodiments, information reported may indicate a chain of custody, which may include identity of individuals accessing data (including times, duration of time, frequency, and device from which accessed) and information regarding use or manipulation of data.

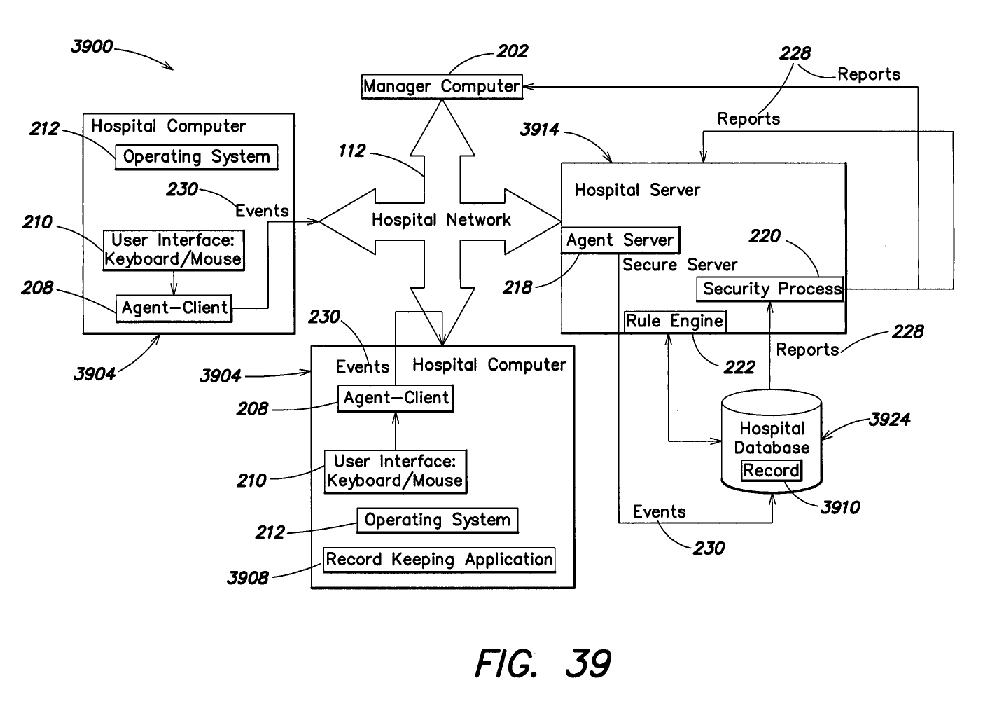

Referring to FIG. 39, in certain embodiments of the present invention, a system similar to the system 100 may be deployed in a hospital environment 3900. In embodiments, a hospital may include a hospital computer system 3914 with conventional elements, such as a network (or multiple networks) 112, one or more servers 3914, and various client devices 3904. The hospital environment 3900 and computer system may support one or more applications, including conventional applications such as financial or word processing applications, as well as applications specific to health care. For example, a patient record keeping application 3908 may be deployed on the hospital system, such as on a client device of a user, such as a doctor, nurse or administrator and on the server 3914. The record keeping application may operate on patient records 3910, which may be stored in a hospital database 3924. In such a situation, the hospital system 100 can be used to determine what users interacted with the patient record keeping application 3908 at what times using what machines 3904. In addition, the system 100 can capture keystroke data to determine what characters were entered when a user interacted with the patient record keeping application 3908, such as to record when a user on a particular machine entered a particular patient's name. The agent 208 of the system 100 captures, bins, and stores the usage data according to the principles of the invention described above, so that the system 100 can report, such as to the hospital administrator, what users interacted with a given patient record at what time. With such a report, an administrator can determine, for example, if attempts have been made to access a record from an unauthorized machine or by an unauthorized user.

Besides forensic analysis of particular patient record transactions, the hospital can utilize the system 100 to monitor and enforce compliance with internal policies which may be subject to federal or state regulation in connection with the protection of confidential patient information collected and stored by the hospital system. Because of the system 100's ability to monitor behavior by capturing data over regular time intervals, an administrator can determine whether particular users are adhering to the hospital's policies or external regulations (e.g. HIPAA), either of which may be captured as rules or policies within the system 100.

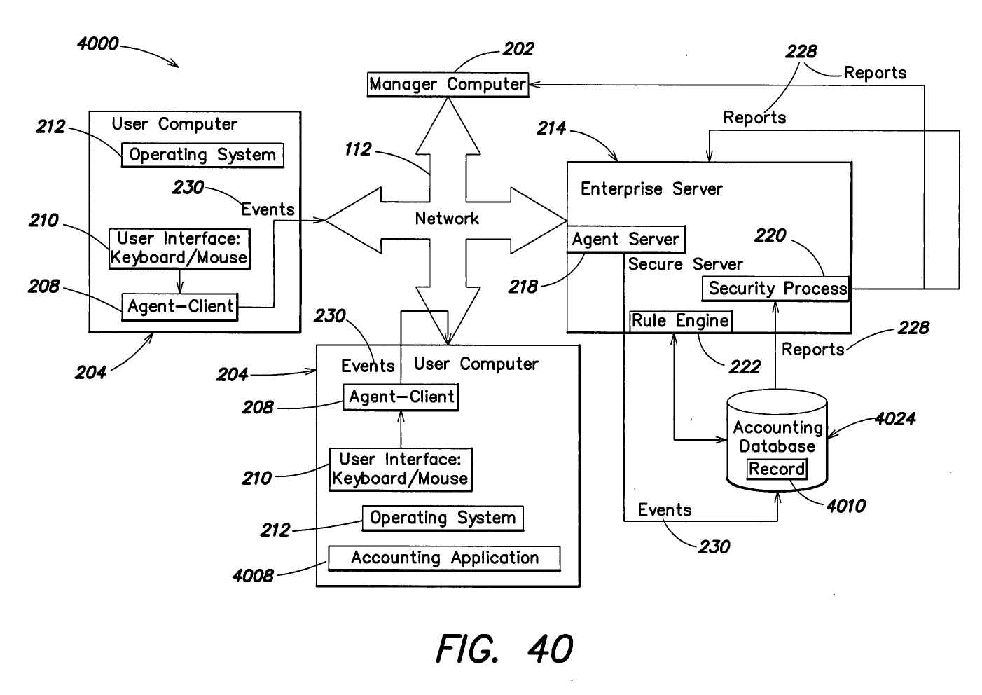

Referring to FIG. 40, in certain embodiments of the invention, it may be desirable to deploy a system such as the system 100 in an accounting environment 4000, such as the accounting department or outside accounting organization of a business enterprise, hospital, professional services firm, government entity, military entity, non-profit entity, school, law firm, escrow agent, bank, trust, corporation, or any other kind of enterprise. In embodiments, such accounting environments may depend on hardware that is part of the firm or corporation's computer system 100 which would include conventional elements, such as a network 112, one or more servers 214, and various client devices, such as user machines 204. The system 100 may support one or more applications, including conventional applications such as word processing applications, as well as accounting applications 4008 specific to the accounting department, such as ones that run on user computers 204 or on the servers 214. The accounting applications may interact with an accounting database 4024. By way of example, an application for handling client billing, invoices and accounts receivable may be deployed on the system 100 of the accounting environment 4000. In such a situation, the system 100 can be used to determine what users interacted with the client billing application at what times using what machines. In addition, the system 100 can capture keystroke data to determine what characters were entered when a user interacted with the client billing application, such as to record when a user on a particular machine entered a particular client billing code, and what keystrokes accompanied enty of the particular code. The agent 208 of the system 100 captures, bins, and stores the usage data according to the principles of the invention described above, so that the system 100 can report (to the firm administrator, for example), whether an unauthorized user interacted with confidential client billing records or invoices and at what time. With such a report, an administrator can determine, for example, if attempts have been made to access confidential client billing records for improper purposes. An administrator could also determine if a user had accessed core processing financial systems, such as for improper or unauthorized purposes. Also, by capturing character strings, the system may be able to determine what user on what computer at what time entered a particular string, such as a number, such as to determine what user entered a particular invoice. Such as system could be used to monitor and control data entry, such as by determining what users have committed errors in data entry most frequently.

User interaction with many types of accounting applications 4008 may be monitored using the methods and systems disclosed herein in an accounting environment 4000, including, for example and without limitation, QuickBooks, QuickBooks Pro, SAP accounting packages, Oracle accounting packages, Microsoft Money and other Microsoft accounting packages, Peachtree accounting packages, Peoplesoft accounting packages, as well as many other commercially available accounting packages and proprietary accounting software developed by or for particular institutions, such as legacy accounting systems used at banks, trusts, and other financial institutions, such as for global trust and custody accounting, international trade accounting, accounting software for securities, commodities, options, futures, and currency trading and exchanges, and many other kinds of accounting software.

In addition, companies can utilize the system 100 to monitor and enforce compliance with corporate accounting policies. For example, escrow agents may utilize software packages to monitor reconciliation of pooled trust accounts. Errors and negative balances, which are often blamed on software malfunction but in reality are often due to user abuse or user failure to follow regular reconciliation practices, can be analyzed using the system 100. For example, the system 100 can monitor user behavior in connection with a particular reconciliation software application and determine the manner, mode, and frequency of use for a particular user in connection with the particular accounting software application 4008. Because of the system 100's ability to monitor behavior by capturing data over regular time intervals, an administrator can determine whether particular users are adhering to the firm or company's reconciliation practices.

The methods and systems disclosed herein thus provide additional control over an enterprise's compliance with its own financial control policies and procedures, as well as compliance with external finance-related regulations. By recording and conveniently organizing and presenting data about what person used what computer application with what keystrokes at what time on what computer device an organization can use forensic accounting methods to determine the source of and to correct accounting errors, can ensure confidentiality of and limited access to financial records, and can assist with monitoring productivity of accountants working for the organization.

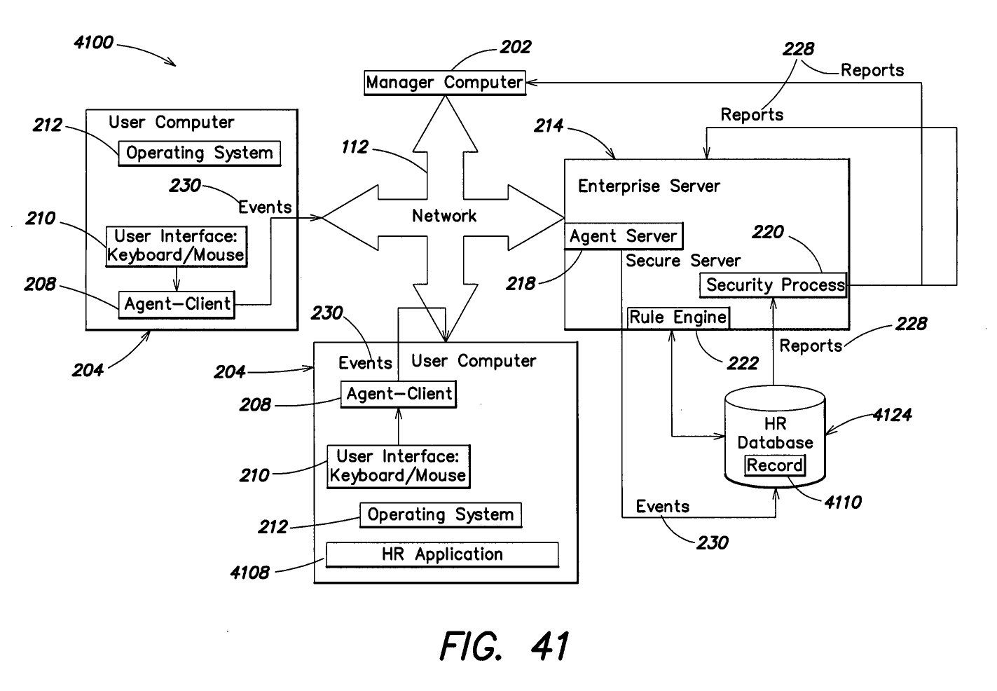

Referring to FIG. 41, a system 4100 similar to the system 100 can be deployed in an environment where one or more human resources functions takes place, such as the human resources department of a company, professional services firm, non-profit institution, government entity, hospital, clinic, school or other enterprise, or an outsourced human resources firm for any of the foregoing. In such cases, a human resource employee can use the system 4100 to monitor usage at both the departmental and individual user level across an enterprise's computer system, including but not limited to conventional elements, such as a network 112, one or more servers 214, and various client devices 204. The system may support one or more applications, including conventional applications such as financial or word processing applications, as well as applications specific to activities of a particular firm or corporation, including off-the-shelf and custom-developed human resources applications 4108, such as applications for managing employee benefit plans, employee compensation plans, payroll functions, employee stock option plans, incentive plans, employee promotions, employee bonus plans, shadow stock plans, employee tax and withholding matters, employment agreements, employee recruiting, hiring and intake functions, employee termination functions, regulatory compliance functions, corporate policy compliance functions, training and development functions, and other human resources functions of an enterprise. Such HR applications 4108 include commercial packages such as those offered by PeopleSoft, SAP, Oracle, Microsoft, Incentive Systems, Paychex, and many others.

In the human resource environment, the system 4100 will be deployed so that it can monitor behavior at a departmental level and at the individual user level. At the departmental level, the system 4100 can enable reporting in connection with usage of particular applications within the department. If departmental managers notice specific issues, such as excessive use of instant messaging or Internet browser applications, the department head may then decide to report the incidents to human resources and request the passwords of the individual users engaging in the particular behavior. Alternatively, human resources personnel can monitor such issues directly without requiring intervention or action by department managers. At the user level, a department may then use the system 4100 to analyze user behavior over time increments and at the keystroke level to analyze whether behavior represents isolated incidents which may have been due to inadvertent acts, or whether keystroke behavior reported to the system 4100 reflects repeated non-compliant behavior such as actual reading of illicit or pornographic content, repeated visits to or extended time spent visiting a particular website, etc. One advantage of the capability of the methods and systems disclosed herein is that they are capable of capturing not only what application was running on a user machine, but whether a user interacted with it, and in the case of keystroke data, what keystrokes the user entered when interacting with the application. Thus, a human resources manager or other manager can confirm whether user behavior is inappropriate in cases where it would otherwise be ambiguous.

In the system described, the system 4100 enables human resource departments to work with other corporate departments so that departmental usage patterns are analyzed first, and used to isolate individual user violations. In this manner, specific user information, which may contain confidential user information embodied in e-mail accounts, etc., is only accessed when departmental usage patterns indicate that an issue may exist. Thus, employee confidentiality may be maintained to the maximum extent possible while still maintaining compliance with employee policies and external regulations.

As in other embodiments, access to reports on user and department behavior may be permission-based, so that only human resources managers, or perhaps only high-ranking members of a human resources department, are allowed access to certain types of reports, such as reports that show individual user behavior, rather than aggregate behavior of a department.

A human resources manager can use the system 4100 to monitor and encourage positive behavior as well. For example, a promotion or incentive program may reward employees for working on specific projects, such as those using a particular computer application. The methods and systems disclosed herein allow the human resources manager to use the system 4100 to monitor what users are using the particular application for what duration of time, so that those users can be rewarded for contributing to the project.

A human resources manager can use the system 4100 to generate a report on an individual employee's computer usage over time, which can be made part of the employees file, such as to support promotions and compensation increases in cases where usage shows, for example, working long hours on important projects, or, in the alternative, to support demotions, disciplinary actions, or termination of employment, such as when usage patterns show low levels of work, high levels of computer usage unrelated to work, access to inappropriate content, efforts to violate security measures, or violation of internal or external regulations. The file can be stored as one or more employee records 4110, such as in a human resources database 4124 of the system 4100. Thus, the methods and systems disclosed herein have wide and powerful applicability in the human resources context.

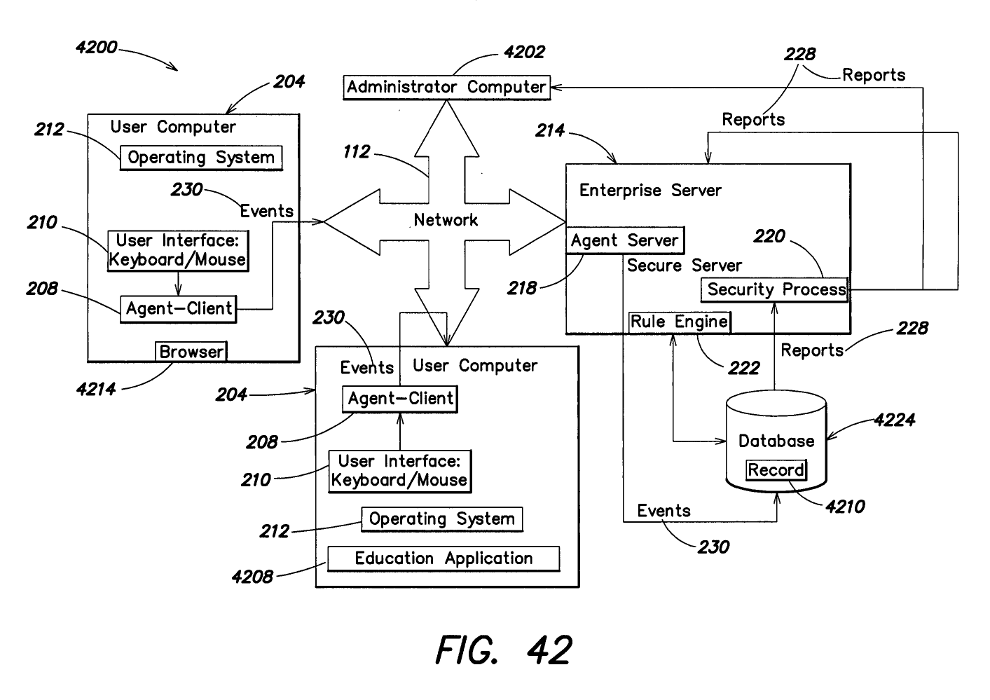

Referring to FIG. 42, in certain embodiments of the present invention, a system 4200 similar to the system 100 is deployed in a school or educational environment. In embodiments, a school or educational environment may include a computer system 4200 with conventional elements, such as a network 112, one or more servers 214, and various client devices 204. The system 4200 may support one or more applications, including conventional applications such as e-mail and word processing applications, as well as other conventional applications such as Internet browsers which are commonly used by both students and teachers for research and other educational projects. The system 4200 may include, deployed on the user machines 204, the servers 214, or both, one or more conventional or custom-developed educational applications 4208, such as applications for word processing, research, drawing, mathematical modeling, photography, making presentations, storing and manipulating data, storing and manipulating images, storing, playing and manipulating media, such as music, video, speech and sound, communications within and outside the environment, tracking student records, tracking student information, tracking health-related information, tracking family information, tracking information relating to testing, including standardized testing, tracking information relating to applications for admission, tracking information relating to honors, scholarships and awards, tracking information relating to participation in activities, tracking information relating to graduation and alumni, and many other applications. The system 4200 can allow an authority within the educational environment, such as a principal, dean, teacher, superintendent, administrator, professor, graduate student, librarian, scientist, department chairperson, or the any other such authority to monitor computer and application usage by individual users, by departments, or by the educational institution as a whole. For example, a standard Internet browser application 4214 may be deployed on the school system 4100. In such a situation, the system 4100 can be to analyze student usage and/or teacher usage over time increments and at the keystroke level to analyze whether behavior represented isolated incidents which may have been due to inadvertent acts or whether keystroke behavior reported to the system 4100 reflects repeated non-compliant behavior such as actual reading of illicit or pornographic content, repeated visits to or extended time spent visiting a website promoting school violence or terrorism, or the like.

In embodiments, the invention may be used in a school environment where the school needs proof about user activity, such as for CIPA 7 requirements of student appropriate computer use. The system can be set to store user input data for one year in the archive in the data storage facility 224. During the school year the data can be made available for analysis and reporting. After the school year the data can be automatically removed.

A system 4200 can be used to monitor and encourage positive behavior as well. For example, students working on a particular project may be monitored to confirm that they are using an application associated with the project for a sufficiently long duration.

In embodiments, the system 4200 can be used to administer computer-based tests, such as by confirming that a student has not used the application through which the test is administered for more than the permitted test time, and to confirm that the student has not launched any other application during that time, such as to look up answers.

As with other use cases described above, the system 4200 deployed in an educational environment would also enable system level analysis of computer use. This may be particularly useful for schools wishing to monitor computer hardware and software usage, at a school or departmental level, in order to justify budget allocations for new purchases, maintenance, and purchase of additional educational software.

As with other cases described herein, the system 4200 deployed in an educational environment may also be used to detect user access to applications 4208 or educational databases 4224, such as those that contain sensitive records 4210 or other information such as grades, disciplinary actions, health information, recommendations, and evaluations. As with other use cases, the agent 208 of the system 4200 captures, bins, and stores the usage data according to the principles of the inventions described herein, so that the system 4200 can report to the appropriate school administrator what users interacted with a given record 4210, such as a student or teacher record, at what time. With such a report 228, an administrator using an administrator computer 4202 can determine, for example, if attempts have been made to access a record from an unauthorized machine or by an unauthorized user such as a student or terminated teacher.

The system 4200's ability to track user behavior is particularly valuable in the educational environment in connection with student use of Internet browser applications and e-mail applications to initiate contact with third parties who may pose security or safety risks to the school and students. For example, the regular capture of keystroke data and application usage would enable educational institutions to identify repeat contacts with third party e-mail addresses, illicit chat rooms and to identify repeated use of word or terms which may signify that a student is in trouble or in need of psychological attention. Because of the system's focus on capturing such data in regular intervals, as with the cases described above, the system 4200 would allow the school administrator to focus on the most serious behavioral issues without focusing unnecessary attention on one-time contacts which may have been inadvertent or not indicative of high risk behavior.

However, though the system 4200 allows an administrator to conveniently focus on aggregate behavior rather than isolated incidents, the system 4200 can be utilized in a forensic manner to determine the nature of a particular incident. Depending on the sampling interval used to obtain keystroke and other event data, it is possible in embodiments of the invention to show exact user actions that took place while a given application was running, such as what URL was typed into an Internet browser, or what words were typed into an email. In embodiments, the sampling interval may be dynamically adjusted by the agent 208, such as by increasing the sampling rate, or decreasing the time between samples, when a user has begun interacting with a machine, when a suspicious action has taken place (such as typing of a suspicious word or suspect email or Internet address), or when a suspect application is launched. Thus, while normal behavior is sampled at longer intervals to reduce the amount of data that is aggregated, suspect behavior can trigger more rapid sampling, thus allowing forensic analysis of events that surround such behavior. Alternatively, all data may be archived, then searched for keystroke data, with portions of data discarded after predetermined time periods.

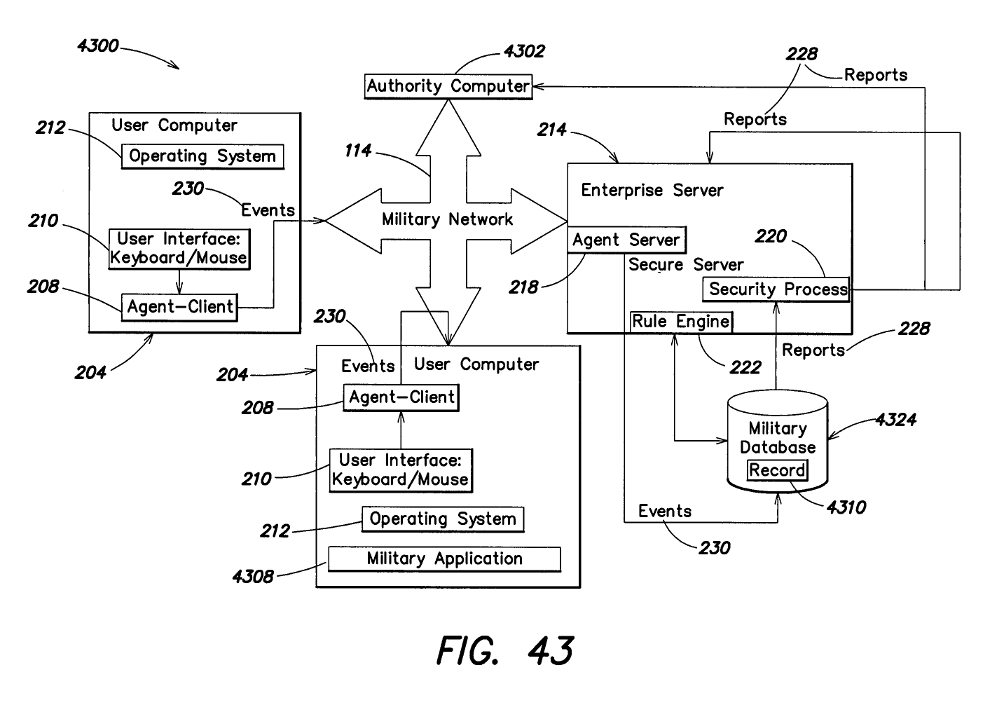

Referring to FIG. 43, in certain embodiments of the present invention, a system 4300 is deployed in a military or secure government environment. In embodiments, a military or secure government environment may include a computer system 4300 with conventional elements, such as a network (or multiple networks) 114, one or more servers 214, and various client devices or user computers 204. The system 4300 may support one or more applications, including conventional applications such as e-mail and word processing applications, database software, software for data capture and data mining, and middleware that integrates the various legacy systems, multi-agent systems, and other hardware and software that exist in the typical military environment. In particular, middleware (e.g. the Co-Abs Grid) may be deployed on the military system in order to integrate the operation of various networks, software, and hardware. The system 4300 may include one or more databases 4324, such as containing information, including records 4310 that relate to military applications. Because deployment of the system 4300 can occur by the agent 208, which can be deployed on the user computers 204, network 112 and servers 214, and because the system 4300 can collect keystroke data at the kernel level, it is particularly well suited to monitor security breaches on an integrated, multi-agent system. As with the use cases described above, the system 4300 can be used to analyze personnel usage over time increments and at the keystroke level to analyze whether behavior represented isolated incidents which may have been due to inadvertent acts or whether keystroke behavior reported to the system 4300 reflects repeated non-compliant behavior such as actual reading of restricted files or databases, repeated visits to or extended time spent visiting a restricted database, or subsequent keystroke behavior indicating contact with outside third parties, downloading of classified information, etc.

However, though the system 4300 focuses on behavior rather than isolated incidents, the system 4300 can be utilized in a forensic manner to determine the etiology of a particular incident. This is particularly useful in the military context where breaches may be specifically designed to be one-time, highly damaging, difficult-to-trace breaches, such as those resulting in transmission of significant confidential information.

The ability of the system 4300 to monitor activity at the kernel level as described herein, applicable in all of the use cases described here, is particularly useful in the military context where sophisticated breaches and intrusions designed to be minimally detectable can be traced deep into the operating system. The system 100's kernel level data monitoring enhances the forensic abilities described above.

Because the system 4300 records keystrokes at regular intervals, it may also be deployed in a military system to accomplish audit and compliance analysis of units or departments where security maintenance is dependent on the regular execution of sequences commands or checks. Binned, interval analysis of keystroke behavior would allow administrators to determine whether a particular security breach was made possible by a breakdown in security procedure (as opposed to only looking for an actual breach, as is often the case when conducting forensic analysis of a particular incident.).

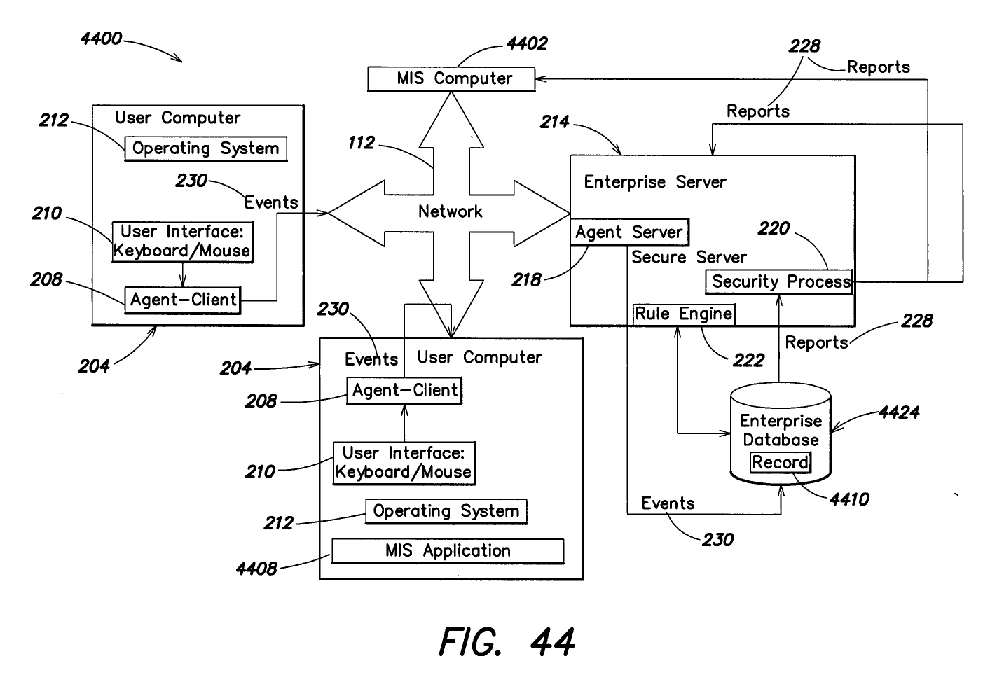

Because the system 4300 only monitors client devices when they are in use and bins data in intervals rather than continuously, the system 4300 is specifically suited to military systems where huge amounts of data are transmitted on a daily basis between and within networks. The system 4300 can effectively monitor and record user behavior without the kind of data overloading that can occur with systems which attempt to monitor continuously. As described in connection with other embodiments herein, the agent 208 can dynamically set sampling intervals, so that suspect instances, such as launching of suspect applications, entering of suspect words, visiting suspect URLs or using suspect email or Internet addresses leads to increased sampling by the agent 208, such as to support later forensic analysis or to trigger alerts based on the occurrence of policy or security events. Such dynamic sampling may be useful in this scenario and in connection with the other scenarios described herein. Referring to FIG. 44, in certain embodiments of the present invention, a system 4400 is deployed in an MIS environment. In such cases, management personnel can utilize the system 4400 to monitor usage of software and hardware at the departmental and employee level across a firm, company or other enterprise's computer system 4400, including but not limited to conventional elements, such as a network (or multiple networks) 112, one or more servers 214, and various client devices 204. The system 4400 may support one or more applications, including conventional applications such as financial or word processing applications, as well as applications specific to activities of a particular enterprise, including, for example, human resources applications such as described above, finance and accounting applications such as described above, supply chain management applications such as described below, database administration applications, spreadsheet applications, data integration applications, educational applications, communications applications, Internet and web applications, multimedia applications, and any other applications. The system 4400 may include one or more databases 4424, including records 4410, which may include confidential or proprietary information of the enterprise. In the MIS environment, the system 4400 can have the security breach and behavior monitoring capabilities described herein in connection with other scenarios. Such capabilities would of course allow management personnel to determine whether inappropriate levels of music or image downloads were occurring on the company system, whether concurrent use licenses were being breached, whether particular users or departments were running applications that unduly taxed system resources, whether particular users or computers were using applications that consumed excessive network bandwidth, and whether there were actual system breaches or violations, such as security events and policy events. However, regular binning of keystroke data at the client device 204 level would allow MIS to not just analyze whether there was non-compliant behavior, but also to analyze how particular software and hardware was being used based on a review and comparison of keystroke data with pre-set keystroke algorithms indicating effective usage of particular software or hardware. In this manner, management could use the system 4400 to determine whether a particular component was being used for its intended purpose and/or as contemplated by purchasing. As with other embodiments, the agent 208 can be adjusted dynamically if suspect events suggest that more rapid sampling of keystroke data is warranted at a given time for a particular computer and user.

Because the system 4400 is deployed at the kernel level, the system 4400 can provide particularly sensitive use data related to file access, file manipulation, file information/attributes, directory manipulation, program execution, device driver access, etc. Though such data can be used in a forensic manner to detect intrusions and breaches, it can also be used to gather extensive data on the optimal use of software and hardware in a company environment.

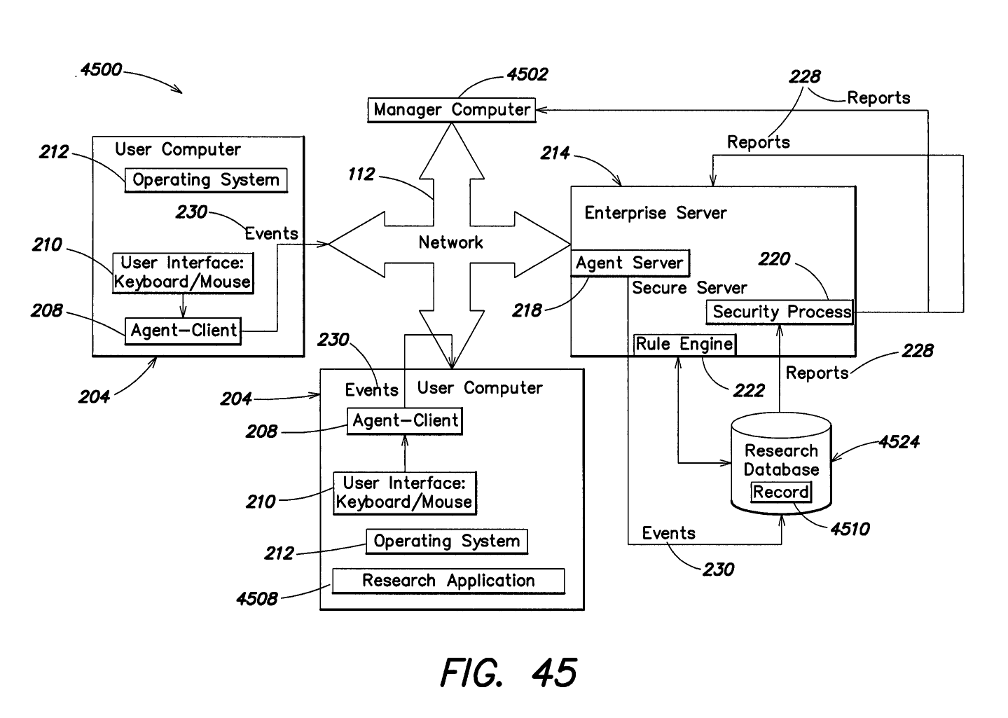

Referring to FIG. 45, in certain embodiments of the present invention, a system 4500 can be deployed in a research and development (“R&D”) environment. In such cases, the R&D department of an enterprise, such as a company or non-profit institution can utilize the system 4500 to monitor usage at both the team and individual researcher level across the R&D computer system 4500, including but not limited to conventional elements, such as a network (or multiple networks) 112, one or more servers 214, and various client devices 204. The system may support one or more applications, including conventional applications such as e-mail or word processing applications, as well as applications specific to research and development activities such as integrated or interactive development environments, rule engines, sequencers, simulators, collaborative research software, database applications, modeling applications, spreadsheet applications, in-circuit emulator applications, three-dimensional modeling applications, patent-related applications, trade secret-related applications, mathematical applications, multimedia applications and other applications that can be used in R&D activities. The R&D system may include research databases 4524, which may include records 4510 relevant to R&D, such as records embodying inventions, trade secrets, proprietary information, models, simulations, experimental results, clinical data, trial data, results of experimentation, and other records relevant to R&D. The ability to monitor intrusions, breaches, and transmissions, described herein, is particularly valuable in an R&D system 4500, both from the standpoint of monitoring user behavior through binned keystroke analysis and from the standpoint of forensic analysis to determine the etiology of particular events or incidents. As well, as described above in connection with the military environment, binning of keystrokes at regular intervals would enable comparisons with pre-determined keystroke algorithms to monitor adherence to departmental security protocol. Also, the agent 208 can be dynamically adjusted if security or policy events are suspected by a particular user or computer. For example, if a user simultaneously accesses a trade secret database and composes and email message to a person outside the company, the system 4500 can adjust the agent 208 to capture all keystrokes and mouse movements by that user and computer associated with the email (or simply all keystrokes and events executed by that user), so that an analysis can be made to determine whether a trade secret has been disclosed outside the enterprise.

The system 4500's use of binned, interval collection, which as mentioned reduces overall data flow and addresses overload problems common to other security monitoring software, is particularly well suited to R&D environments, where there may be large amounts of data passing between users or passing through the system as either inbound or outbound traffic.

In the R&D environment, a manager using a manager computer 4502 may wish to monitor R&D application 4508 usage for efficiency purposes, because many R&D applications 4508, such as large-scale modeling applications, gene sequencing applications, weather simulations and other R&D applications can require enormous server, network and database resources. Therefore, the manager can monitor when particular applications are used by department and by user, to suggest usage patterns that increase overall effectiveness of computer resources.

For many enterprises, R&D applications 4508 and research databases 4524 involve extremely valuable information, so that security events, such as unauthorized access, sending records 4510 outside the enterprise, unauthorized changing of records 4510 within a database 4524, or the like, are very important to detect. Thus, the methods and systems disclosed herein are of particular power for the R&D enterprise.

In R&D environments, it may also be important to demonstrate the integrity of research records 4510, such as to prove to the FDA that drug development research results have not been changed. Thus, consistent use of a system 4500 allows a manager 4502 of a research effort to show reports 228 on daily usage that demonstrate that only authorized users, and no unauthorized users, have interacted with applications 4508 that touch the database 4524 that stores critical research results.

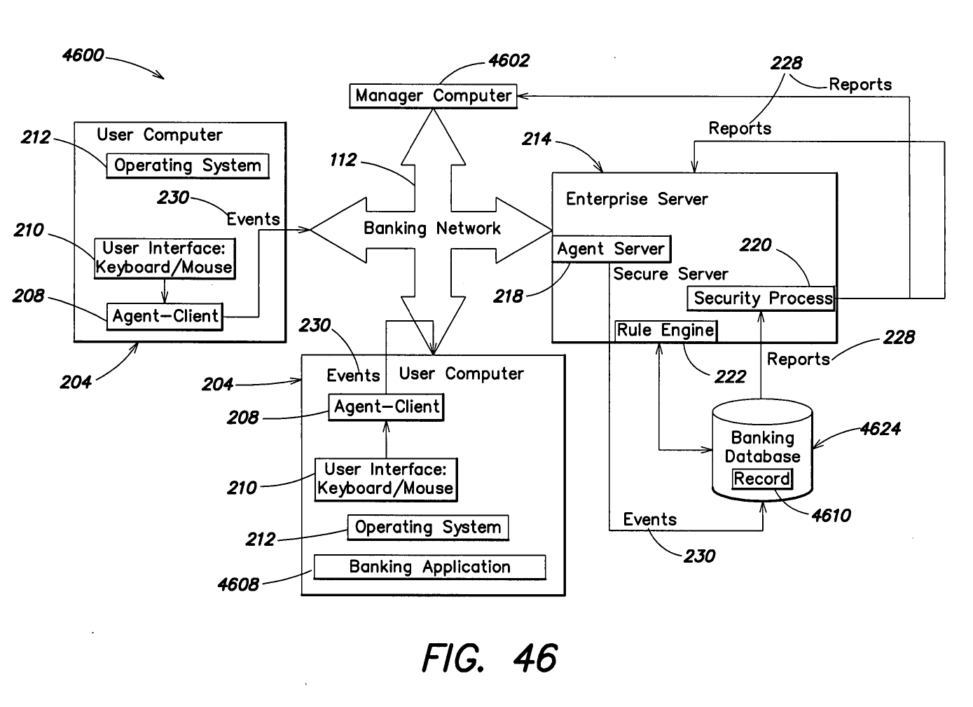

Referring to FIG. 46, in certain embodiments of the present invention, a system 4600 similar to the system 100 is deployed in a banking environment. In embodiments, such banking environments may depend on hardware that is part of the firm or corporation's computer system 4600, which would include conventional elements, such as a network 112, one or more servers 214, and various client devices 204. Consolidation and globalization in the banking industry have led many banking institutions to have enormous information technology infrastructures, with many servers 214 and many networks 112, including local area networks, wide area networks, wireless networks, virtual private networks, and the Internet supporting various aspects of a banking enterprise. The system may support one or more banking applications 4608, including conventional applications such as e-mail or word processing applications, as well as applications specific to the banking environment such as online consumer banking software, payroll administration software, software for handling online payments, software for accounts payable and accounts receivable, software for handling and reconciling trades, such as of securities, currency, commodities, options, futures, precious metals and the like, software for handling trust and custody management, software for handling currency transfers, such as wire transfers, software for handling deposits and withdrawals, software for signature recognition on checks and other instruments, software for handling filings relating to security interests and collateral, regulatory compliance software, software for handling insurance policies and claims, software for supporting mortgage lending, commercial lending, home equity lending, private lending, and other lending, software for handling transactions with other banks, including central banks, software for making interest calculations, currency exchange calculations, and other calculations, financial modeling software, customer records management software, customer relationship management software, and many other kinds of banking applications 4608. In the cases of many banks, banking applications 4608 are legacy systems that have been in place for many years, some running on computer system platforms that use disparate native data formats and communication protocols, such as IBM mainframe computer systems, VAX systems, and the like, while others are running on platforms more recently developed, such as UNIX, LINUX, or Microsoft Windows platforms, but often still on disparate platforms. In many cases the banking applications 4608 interface with one or more banking databases 4624, such as a wide range of account databases, customer databases, vendor databases, loan databases, trust and custody databases, securities databases, commodities databases, databases associated with branches and other banks, including central banks, and many others. In some cases, each such application may each have its own database, resulting in multiple customer data pools for the bank. For example, an online application for handling client checking and savings accounts may be deployed on the bank system, where such system is hosted by the bank, accessible internally by bank employees and externally, through web interface, by bank customers. In many cases banks thus have literally thousands of employees in hundreds of departments spread across global geographic boundaries. In such a situation, it can be critical to have a system such as the system 4600 that allows a manager using a manager computer 4602 to pull reports 228 from a banking database 4624 that provides a convenient summary of user behavior by computer, by department, by application and by time. Any attempt to develop such reports through looking at raw event logs would be nearly impossible to complete in a meaningful way. In embodiments, multiple agents 204 running on different servers 214, networks 112 and user computers 204 can collect, organize and report user, computer, and application activity, which can be stored in one or more databases 4624 of a banking enterprise for enabling reports 228 to various bank managers. The output of different agents 204 can be aggregated to provide an overall enterprise view, or different agents can be provided for different systems, such as legacy mainframe systems and current Linux systems, for example.

In the banking environment, a system 4600 can be used in many ways, such as to determine what users interacted with a banking application 4608 in connection with a specific account at what times using what machines. In addition, the system 4600 can capture keystroke data to determine what characters were entered when a user interacted with the application, such as to record when a user on a particular machine entered a particular client account number, and what keystrokes followed entry of the particular account number. As with the other embodiments described herein, the agent 208 of the system 4600 captures, bins, and stores the usage data according to the principles of the invention described herein, so that the system 4600 can report (to the bank manager, for example), whether an unauthorized user interacted with confidential account information and at what time. With such a report, an administrator can determine, for example, if attempts have been made to download, copy or transmit confidential client information, such as social security numbers, for improper purposes.

In addition, the banking system 4600 can help monitor and enforce compliance with internal banking policies that may be subject to federal or state regulation in connection with the protection of confidential client information collected and stored by the bank. Because of the system 4600's ability to monitor behavior by capturing data over regular time intervals, an administrator can determine whether particular users are adhering to the bank's policies, and/or applicable state/federal regulations. Keystroke algorithms can be designed to ensure compliance with banking regulations, and keystroke data can be compared periodically to ensure system-wide or departmental compliance with procedures governing such matters as the storage of customer data, etc.

The system 4600 can also be deployed in the IT departments of banks where programmers may be using a combination of internal development tools and third party development tools (for example, rule engines) to create proprietary bank applications, such as for interfacing with customers, vendors or other banks. In such scenarios, programmers, either employed by the bank or acting as third party consultants to the bank, may be responsible for writing programming code that interfaces with critical code handling core operations such as fund transfers, external wire transfers, etc. In this manner, a rogue programmer could easily deploy a few lines of fraudulent code resulting in periodic transfers of client funds or other bank funds to an anonymous third party account. In such a scenario, the system 4600 could also be deployed across the bank's IT systems where such product development may be taking place. With the forensic abilities already described, and with the ability to monitor behavior through the capture of keystrokes over regular intervals, the system 4600 may be used to monitor programming breaches aimed at embezzlement or use of confidential customer information.

IT departments may use the system 4600 in more conventional ways as well, such as to look at use patterns to determine what applications are consuming the most employee time, so that the legacy applications that have the greatest drag on overall efficiency can be replaced earliest. By capturing the user's interaction with applications 4608, rather than just the fact that the applications 4608 are running, the manager has a much better sense of what applications 4608 are demanding time than with conventional methods and systems that just record the times at which an application was started and stopped.

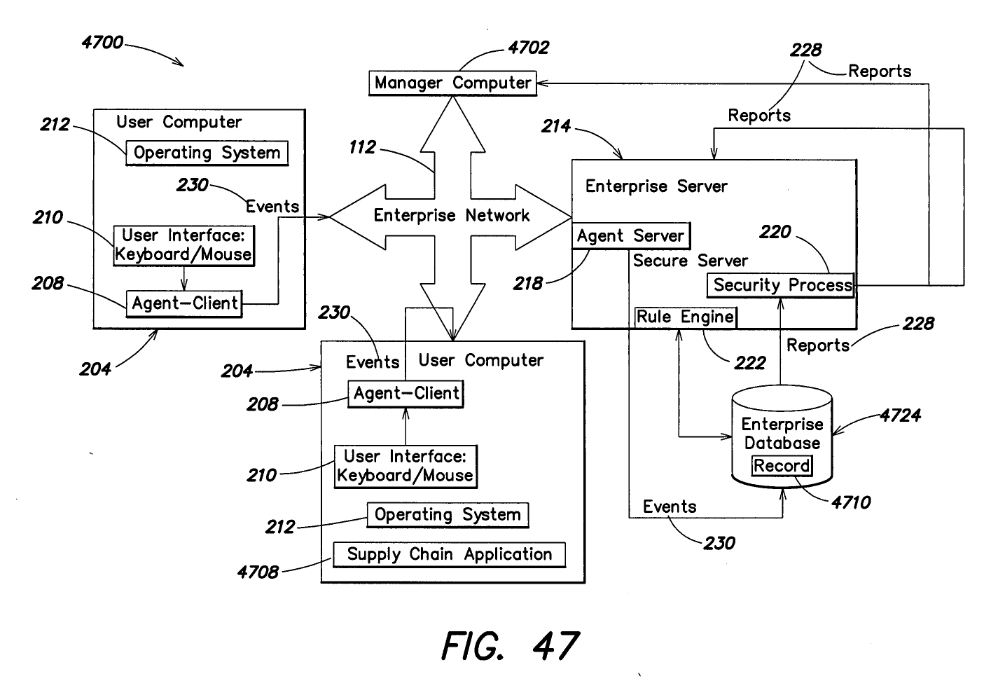

Referring to FIG. 47, in certain embodiments of the present invention, a system 4700 is deployed in a environment for managing the supply chain functions of an enterprise or a collection of enterprises. In embodiments, such supply chain management environments may depend on hardware that is part of an enterprise's computer system 4700, which would include conventional elements, such as a network (or multiple networks) 112, one or more servers 214, and various client devices or user machines 204. The system 4700 may support one or more supply chain management applications 4708, including conventional applications such as e-mail or word processing applications, as well as applications specific to the supply chain environment, such as supply chain management packages provided by Oracle, SAP, PeopleSoft, Microsoft and others, as well as custom-developed systems, as well as software to support various specific supply chain management functions, such as quality control software, testing and inspection software, software for tracking and estimating the bill of materials for particular goods, software for estimating shipping costs, software for tracking shipments, software for financial modeling of different supply scenarios, software for tracking and handling vendor information, software for tracking and handling product information, software for tracking and handling product lots, software for tracking and handling returns, software for tracking and handling insurance claims, software for tracking and handling repairs and rebuilding jobs, software for tracking and handling inventory levels, and software for tracking and handling inventory turnover. Typically, a supply chain management system 4700 may include integration of the enterprise's software and hardware with the software or hardware components of third parties who are responsible for executing particular segments of the supply chain. The system 4700 may also include various databases 4724, such as databases of vendor information, product information, product lot information, return, repair and rebuild information, testing and inspection data, quality control data, insurance information, customer data, shipping addresses, shipping and handling information, inventory information, warranty information, and other data relevant to supply chain management. An agent 208 can run on various elements of the system 4700, such as user computers 204, networks 112 and servers 214, to track usage of the elements of the supply chain management system 4700 by user, by machine, and by application for any selected time period. The manager can use a computer 4702 to pull reports 228 as to such behavior by user, by department or for the enterprise as a whole. For example, a manager can obtain a report 228 that indicates whether there have been unauthorized attempts to access sensitive information, such as information that calculates the company's bill of materials for a particular product.

In another example, the enterprise may utilize radio frequency identification tags (“RFID” tags ) and accompanying software for shipping its products. The tags can be utilized internally to track merchandise, and the tags may also be used by third parties responsible for shipping or distribution. Each RFID tag may contain sensitive customer information and other data correlated with a particular product. In such a situation, the RFID hardware interfaces with related software components and users at various stages of the movement of the product through the supply chain. In such a situation, the system 4700 can be used to determine what users interacted with the RFID hardware or applications at what times using what machines. For example, the system 4700 could enable a firm to set policies so that only approved scanners could access the tags in an approved manner at approved times. The system 100, because of its repetitive, regular binning of usage data, could track whether different entities in the supply chain were adhering with the scanning policies, tracking scanning behavior at either the user or departmental level as appropriate. The system 4700's ability to monitor behavior could also ensure (and provide evidence of through reports 228) the enterprise's and third party compliance with RFID and related mandates necessary to do business with large entities such as Wal-Mart and governmental entities such as the Departmental of Defense. The system 4700 can also be used in a forensic manner to determine the etiology of a particular incident. This can be particularly useful in the supply chain environment for tracking shrinkage and loss, as, for example, it can track what user using what computer entered data that indicated that a particular product was shipped, or passed inspection, or the like. The system 4700's use of binned, interval collection, which reduces overall dataflow and addresses overload problems common to other security monitoring software, is particularly well-suited to supply chain environments where there may be large amounts of inventory and customer data passing between users or passing through the system as either inbound or outbound traffic.

The supply chain environment also presents unique challenges for enforcement of security policies that the system 4700 can address. Because the system 4700's use of binned, interval collection of keystroke data enables tracking of behavior, a supply chain manager can ensure that remote entities (employees, consultants, or other third parties) are indeed complying with security update directives requiring installation of security patches and adhering to security protocols. More simply, in this and other embodiments described herein, a manager can review usage reports 228 to confirm that employees and consultants who are deployed around the globe, such as in this embodiment supply chain management personnel deployed to handle supply chain functions for an enterprise, are actually using their computer applications to do work, rather than spending paid time on non-work activities.

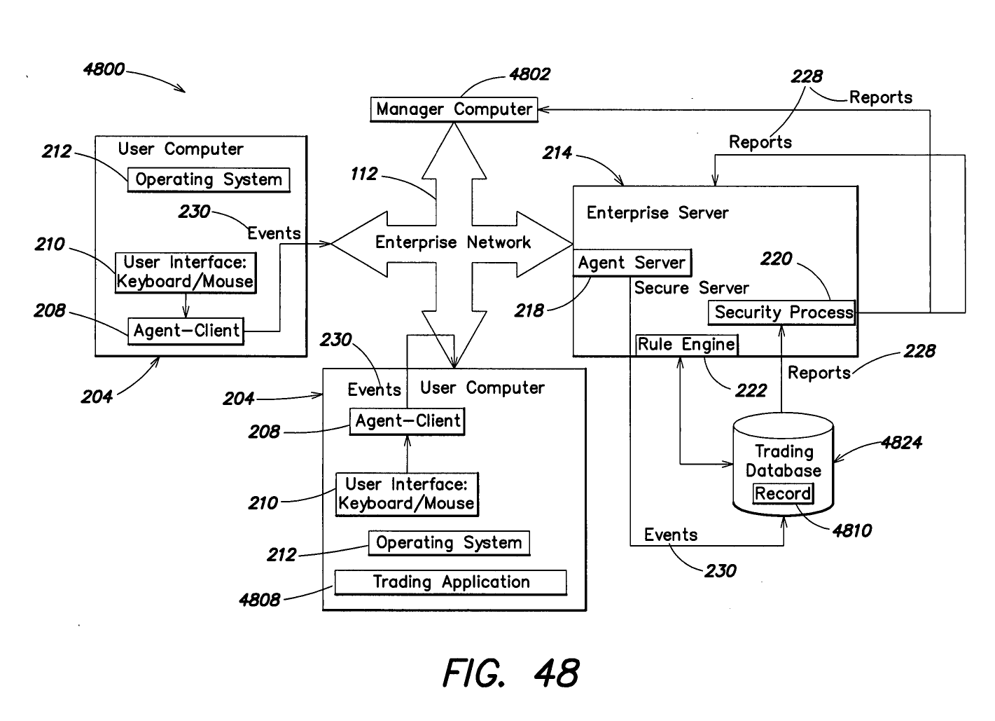

Referring to FIG. 48, in certain embodiments of the present invention, a system 4800 can be deployed in a trading or securities sale/trade environment. In embodiments, a trading environment may include the computer system 4800 with conventional elements, such as a network (or multiple networks) 112, one or more servers 214, and various client devices or user machines 204. The system 4800 may support one or more trading applications 4808, including conventional applications such as e-mail, instant messaging or word processing applications, as well as applications specific to trading such as web-enabled trading tools, risk management solutions, transaction software, customer relationship management software, customer account tracking software, financial modeling software, trade execution software, rules-based trading software, call management software, and other trading applications. The system 4800 may also include various databases 4824 that include records 4810 that are relevant to trading, such as data on trades, customer account data, pricing data, data relating to commodities, securities, options, futures, puts, calls, precious metals and other trading-related data. An agent 208 such as described herein can be deployed in the trading computer system 4800 to monitor security events and policy events by user, by computer, and by application at selected times. The agent 208 may be dynamically adjusted, such as to collect more data (sample more frequently) if suspect behavior is noted. The agent 208 can enable rules that trigger alerts if a policy event or security event takes place. The agent 208 can facilitate collection and binning of keystroke data by user and computer, so that a forensic analysis can be made of any suspect user behavior.

In monitoring security in a trading environment, besides the protection of core financial information and client confidential information, which would be accomplished in similar manner to the methods and systems described elsewhere herein, the trading environment is also vulnerable to non-compliant user behavior intended to utilize sensitive market data for illegal trading and market manipulation. In such cases, a security event or breach may be defined, for example, to involve simultaneous use of trade specific applications (which provide access to confidential and/or sensitive data) concurrently with more generic applications such as e-mail, instant messaging, etc, or web-browsers that enable anonymous, less traceable communication pathways for dissemination or transmission of such confidential or sensitive information. Use of the trading application in close proximity in time to an email or instant messaging application may be defined as a suspect event, in which case the system 4800 can be prompted to track the detailed keystroke data (with no space between sampling intervals), to ensure that keystrokes entered into the email are captured. Because the system 4800 can capture keystroke data across regular intervals and can collect such data at the kernel level, the system can track actual behavior deep into the operating system, utilizing either a behavior analysis as described in previous use cases or a forensic analysis focusing on specific incident(s). In this manner, the system 4800 can report incidents related to unauthorized use of instant messaging and email applications. By analyzing the keystroke data and kernel data associated with transmissions (i.e. activity with related concurrently operating applications), the system 4800 can be used to detect rogue trader behavior aimed at market manipulation, insider trading, or unauthorized transmission of sensitive market data.

As with the banking and health care embodiments described herein, deployment of the system 4800 in the trading environment can also enable regulatory compliance. Complex trading regulations, which mandate particular procedures manifested by predictable keystroke algorithms or application usage patterns, can be embodied in “rules” or policies that the system 4800 uses to track the binned keystroke data. Tracking of such data, and compliance with such rules, can be executed either at the departmental or user level as appropriate.

In embodiments of the invention, the invention may be used to address threats that are suspected to originate from a user of a computer of a computer system of an enterprise or institution, such as a company or school. Using keywords (or even partial words) identified in the threatening email, a user of the methods and systems disclosed herein can search archived user input data stored in the data storage facility 224 for the keyword or partial word. For any matching keystrokes found in the archive, the system can return the user, the application that was being used, the computer on which the keystrokes were entered and the data and time that the keystrokes were entered. That data can be used to further investigate the origination of the threat.

In embodiments of the invention, the environment may be a federal agency or similar institution that needs to be alerted if certain keywords are typed into a computer application. However, in certain instances keystroke storing may be illegal, such as in federal government agencies. By setting user input data archiving to zero, keystroke events may be monitored, such as to trigger events, but discarded, thereby avoiding prohibitions on keystroke storage.

In embodiments of the invention a banking institution can allow employees to access personal or financial information from work computers. The user can type in a password for stock trading, banking, or a website, such as Amazon.com. In some cases an employee may be suspected of improper or illegal action, such as embezzlement, so that investigators want to review the employee's computer usage. In such a case an authorized employee of the bank may issue a password with an expiration time that allows the investigators to search the archive in the data storage facility 224 for keystrokes that show improper or illegal activity. However, in certain embodiments other employees, such as system administrators, may be prevented from having access to the archived data.

In embodiments of the invention a non-technical security officer may be concerned that the IT staff has been bypassing a computer policy. The non-technical officer can log into the server 214 and review a user interface, such as an administration action log. The officer can then review all users' access and modifications that they may have made to the server 214. Likewise the officer can check to make sure administrators are not using the system to gain access to employees' personal use of the computer network.

Although the present invention has been described in some detail by way of illustration and example for purposes of clarity and understanding, it will, of course, be understood that various changes and modifications may be made in the form, details, and arrangement of the parts without departing from the scope of the invention set forth in the following claims. The foregoing are intended to be encompassed herein, as limited only by the claims.

1. A method of managing security in an enterprise, comprising:
detecting at periodic intervals events that correspond to user interactions with computers connected to a network of the enterprise;
storing such events in a data facility;
organizing the events by user, by computer and by event type; and
presenting a summary of the events in a report, wherein a viewer of the report may select the organization of the report by user, by computer and by event type.

2. A method of claim 1, wherein the report is in a graphical format.

3. A method of claim 1, further comprising limiting access to the report based on a predetermined level of authority of the party seeking access.

4. A method of claim 1, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

5. A method of claim 1, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

6. A method of claim 1, wherein the report relates to compliance with a policy of the enterprise.

7. A method of claim 1, wherein the report relates to security of the enterprise.

8. A method of claim 1, wherein the report relates to performance of an objective of the enterprise.

9. A method of claim 1, wherein the report relates to content viewed by the user, the content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

10. A method of managing compliance with policies of an enterprise, comprising:
detecting at periodic intervals events that correspond to user interactions with computers connected to a network of the enterprise;
storing such events in a data facility;
organizing the events by user, by computer and by event type; and
presenting a summary of the events in a graphical-format report, wherein a viewer of the report may select the organization of the report.

11. A method of claim 10, further comprising limiting access to the report based on a predetermined level of authority of the party seeking access.

12. A method of claim 10, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

13. A method of claim 10, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

14. A method of claim 10, wherein the report relates to compliance with a policy of the enterprise.

15. A method of claim 10, further comprising sending an alert if a user is suspected of committing a security violation based on the user interactions with the computer.

16. A method of claim 10, further comprising increasing the rate of capture of user interactions if a user is suspected of committing a security violation.

17. A method of claim 10, wherein the report relates to content viewed by the user, the content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

18. A method of managing productivity of individuals operating within a business enterprise, comprising:
detecting at periodic intervals events that correspond to user interactions with computers connected to a network of the enterprise;
storing such events in a data facility;
organizing the events by user, by computer and by event type; and
presenting a summary of the events in a graphical-format report, wherein a viewer of the report may select the organization of the report.

19. A method of claim 18, further comprising limiting access to the report based on a predetermined level of authority of the party seeking access.

20. A method of claim 18, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

21. A method of claim 18, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

22. A method of claim 18, wherein the event relates to an employee's usage of the Internet.

23. A method of claim 22, further comprising providing an alert if an employee's usage of the Internet exceeds a predetermined amount during a predetermined period of time.

24. A method of claim 18, wherein the report relates to content viewed by the user, the content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

25. A system for managing security in an enterprise, coman agent for detecting at periodic intervals events that correspond to user interactions with computers connected to a network of the enterprise;
a data facility for storing the events detected by the agent; and
a reporting facility for organizing and reporting the events by user, by computer and by event type.

26. A system of claim 25, wherein the reporting facility generates a report in a graphical format.

27. A system of claim 25, further comprising a security facility for limiting access to the report based on a predetermined level of authority of the party seeking access.

28. A system of claim 27, wherein the security facility comprises an encryption facility.

29. A system of claim 27, wherein the security facility comprises a password.

30. A system of claim 25, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

31. A system of claim 25, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

32. A system of claim 25, wherein the reporting facility reports compliance with a policy of the enterprise.

33. A system of claim 25, wherein the reporting facility reports security events.

34. A system of claim 25, wherein the reporting facility reports on performance of an objective of the enterprise.

35. A system of claim 25, wherein the report facility reports on interaction by the user with content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

36. A system for managing compliance with policies of an enterprise, comprising:
an agent for detecting at periodic intervals events that correspond to user interactions with computers connected to a network of the enterprise;
a data facility for storing such events by user, by computer and by event type; and
a reporting facility for presenting a summary of the events in a graphical-format report, wherein a viewer of the report may select the organization of the report.

37. A system of claim 36, further comprising a security facility for limiting access to the report based on a predetermined level of authority of the party seeking access.

38. A system of claim 37, wherein the security facility comprises an encryption facility.

39. A system of claim 37, wherein the security facility comprises a password.

40. A system of claim 36, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

41. A system of claim 36, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

42. A system of claim 36, wherein the reporting facility reports events relating to compliance with a policy of the enterprise.

43. A system of claim 36, further comprising a communication facility for sending an alert if a user is suspected of committing a security violation based on the user interactions with the computer.

44. A system of claim 36, further comprising a dynamic facility of the agent for increasing the rate of capture of user interactions if a user is suspected of committing a security violation.

45. A system of claim 36, wherein the report reporting facility reports content viewed by the user, the content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

46. A system for managing productivity of individuals operating within a business enterprise, comprising:
an agent for detecting at periodic intervals events that correspond to user interactions with computers connected to a network of the enterprise;
a data facility for storing such events by user, by computer and by event type; and
a reporting facility for presenting a summary of the events in a graphical-format report, wherein a viewer of the report may select the organization of a report generated by the reporting facility.

47. A system of claim 46, further comprising limiting access to the report based on a predetermined level of authority of the party seeking access.

48. A system of claim 46, wherein the events are selected from the group consisting of keyboard event, a mouse event, an intellipoint event, a trackball event, a cursor event, a screen event, sensor event, a touchpad event, a tablet event, a touchscreen event, a joystick event, a pen event, a voice recognition event, and biometric event.

49. A system of claim 46, wherein the user is selected from the group consisting of an employee, a consultant, a teacher, a student, a government official, a patient, a volunteer, an attendant, a team member, a system administrator, a contractor, a vendor, a clerk, a cashier, a teller, a comptroller, an accountant, an attorney, a financial officer, a principal, an administrator, a human resources employee, a broker, a gaming employee, a guard, a banker, a government official, a trustee, a guardian, a steward, an authorized user and a non-authorized user.

50. A system of claim 46, wherein the event relates to an employee's usage of the Internet.

51. A system of claim 50, further comprising an alarm facility for providing an alert if an employee's usage of the Internet exceeds a predetermined amount during a predetermined period of time.

52. A system of claim 46, wherein the report relates to content viewed by the user, the content selected from the group consisting of chat room content, content relating to securities, insider trading information, content relating to gaming, pornographic content, illegal content, vulgar content, prurient content, gambling content, entertainment content, video game content, trade secret content, proprietary content, engineering content, drug-related content, health-related content, a medical record, a patient record, a financial record, account information, educational information, indication of harassment, indication of a crime, indication of policy or regulatory non-compliance, identification of a competitive entity, identification of an adverse entity, identification of a specific individual, transcript information, access to an employment-oriented website, content designated prohibited by policy, and trading information.

53. A method of managing security in an enterprise, comprising:
detecting at periodic intervals events that correspond to user interactions with computers connected to a network of the enterprise;
storing such events in a data facility;
organizing the events by user, by computer and by event type;
permitting access by an individual to the stored events; and
logging events that indicate the nature of the access by the individual to the stored events.
